(19) United States
(12) Patent Application Publication
(10) Pub. No.: US 2025/0199744 A1
(43) Pub. Date: Jun. 19, 2025

(54) INFORMATION PROCESSING APPARATUS AND INFORMATION DISPLAY METHOD

(71) Applicants: Michika Yamada, Kanagawa (JP); Susumu Fujioka, Kanagawa (JP)

(72) Inventors: Michika Yamada, Kanagawa (JP); Susumu Fujioka, Kanagawa (JP)

(73) Assignee: Ricoh Company, Ltd., Tokyo (JP)

(21) Appl. No.: 18/917,122

(22) Filed: Oct. 16, 2024

(30) Foreign Application Priority Data
Dec. 18, 2023 (JP) 2023-212713

(51) Int. Cl. G06F 3/14; G06F 3/0485; G06F 3/04883; G06T 3/20; G06T 3/40

(52) U.S. Cl. CPC G06F 3/1454; G06T 3/20; G06T 3/40; G06F 3/0485; G06F 3/04883

(57) ABSTRACT

An information processing apparatus includes circuitry that receives a plurality of rendering data items rendered in respective display areas displayed on a plurality of apparatuses, and writes the received plurality of rendering data items in a renderable area. The renderable area includes the display areas of the plurality of apparatuses. The circuitry further moves at least part of the plurality of rendering data items written in the renderable area into an area corresponding to the display area of a particular apparatus of the plurality of apparatuses to arrange the plurality of rendering data items of the plurality of apparatuses in the area. The circuitry further transmits, to the particular apparatus, the plurality of rendering data items of the plurality of apparatuses arranged in the area.

### CROSS-REFERENCE TO RELATED APPLICATIONS

This patent application is based on and claims priority pursuant to 35 U.S.C. § 119 (a) to Japanese Patent Application No. 2023-212713, filed on Dec. 18, 2023, in the Japan Patent Office, the entire disclosure of which is hereby incorporated by reference herein.

### BACKGROUND

### Technical Field

The present disclosure relates to an information processing apparatus and an information display method.

### Related Art

There is an apparatus used in a remote meeting between multiple sites, such as an interactive whiteboard that receives handwriting input by a user. There is also a method used in a remote meeting between different sites, for example, to enable input of handwriting to the same screen from the sites while different apparatuses at the sites are sharing rendering data such as handwriting data displayed at the sites.

### SUMMARY

In one embodiment, there is provided an information processing apparatus that includes, for example, circuitry that receives a plurality of rendering data items rendered in respective display areas displayed on a plurality of apparatuses, and writes the received plurality of rendering data items in a renderable area. The renderable area includes the display areas of the plurality of apparatuses. The circuitry further moves at least part of the plurality of rendering data items written in the renderable area into an area corresponding to the display area of a particular apparatus of the plurality of apparatuses to arrange the plurality of rendering data items of the plurality of apparatuses in the area. The circuitry further transmits, to the particular apparatus, the plurality of rendering data items of the plurality of apparatuses arranged in the area.

In one embodiment, there is provided an information processing apparatus that includes, for example, circuitry that receives a plurality of rendering data items rendered in respective display areas displayed on a plurality of apparatuses. Each of the display areas of the plurality of apparatuses is switchable between a plurality of pages. The circuitry further writes the received plurality of rendering data items in the plurality of pages. Each page of the plurality of pages corresponds to one of display areas of the plurality of apparatuses. The circuitry further arranges the plurality of rendering data items of the plurality of pages in an area corresponding to the display area of a particular apparatus of the plurality of apparatuses, and transmits, to the particular apparatus, the plurality of rendering data items of the plurality of apparatuses arranged in the area.

In one embodiment, there is provided an information display method that includes, for example, receiving a plurality of rendering data items rendered in respective display areas displayed on a plurality of apparatuses, and writing the received plurality of rendering data items in a renderable area. The renderable area includes the display areas of the plurality of apparatuses. The information display method further includes moving at least part of the plurality of rendering data items written in the renderable area into an area corresponding to the display area of a particular apparatus of the plurality of apparatuses to arrange the plurality of rendering data items of the plurality of apparatuses in the area, and transmitting, to the particular apparatus, the plurality of rendering data items of the plurality of apparatuses arranged in the area.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIGS. 1A, 1B, 1C, and 1D are diagrams illustrating an overview of a process in which a meeting server of a first embodiment displays, in one screen, rendering data of a plurality of apparatuses at a plurality of sites;

FIG. 2 is a diagram illustrating an exemplary system configuration of a remote meeting system of the first embodiment;

FIG. 3 is a diagram illustrating an exemplary hardware configuration of an interactive whiteboard included in the remote meeting system of the first embodiment;

FIG. 4A is a diagram illustrating an exemplary hardware configuration of a meeting server included in the remote meeting system of the first embodiment;

FIG. 4B is a diagram illustrating an exemplary hardware configuration of a tablet personal computer (PC) included in the remote meeting system of the first embodiment;

FIG. 5 is a functional block diagram illustrating exemplary functional blocks of the meeting server, the interactive whiteboard, and the tablet PC in the remote meeting system of the first embodiment;

FIG. 6 is a diagram illustrating an example of a shape list of the first embodiment displayed when a shape icon is pressed;

FIG. 7A is a diagram illustrating an example of rendering data of a renderable area in a memory of the meeting server of the first embodiment;

FIG. 7B is a diagram illustrating an example of the rendering data of the renderable area in the memory of the meeting server of the first embodiment after the transmission of rendering from the tablet PC;

FIG. 8 is a diagram illustrating an example of a display area of the interactive whiteboard of the first embodiment located at a first site;

FIG. 9 is a diagram illustrating an example of a first group of rendering data of the interactive whiteboard and a second group of rendering data of the tablet PC in the first embodiment;

FIG. 10 is a diagram illustrating the movement of one of the first and second groups in the first embodiment;

FIG. 11 is a diagram illustrating an example of the rendering data displayed by the interactive whiteboard of the first embodiment after the movement;

FIG. 12 is a sequence diagram illustrating an exemplary process in which the meeting server of the first embodiment moves the rendering data of the tablet PC to display the rendering data in the display area of the interactive whiteboard;

FIG. 13 is a functional block diagram illustrating exemplary functional blocks of the meeting server of a second embodiment;

FIG. 14 is a diagram illustrating an example of the display area of the interactive whiteboard of the second embodiment;

FIGS. 15A-1 to 15A-9 are diagrams illustrating a method of the second embodiment to detect handwritten characters;

FIGS. 15B-1 to 15B-4 are diagrams illustrating a method of the second embodiment to determine whether a segment has been confirmed;

FIG. 16A is a diagram illustrating exemplary combinations of segments of handwritten characters in the second embodiment;

FIG. 16B is a diagram illustrating possible combinations of links of handwritten characters in the second embodiment, with the links indicated by arrows;

FIG. 17 is a diagram illustrating an example of the rendering data of the second embodiment with one of the first and second groups reduced in size and the other one of the first and second groups increased in size;

FIG. 18 is a sequence diagram illustrating an exemplary process in which the meeting server of the second embodiment moves the rendering data of the tablet PC to display the rendering data in the display area of the interactive whiteboard;

FIG. 19 is a diagram illustrating an example of handwriting data rendered on the interactive whiteboard at the first site in a third embodiment;

FIG. 20 is a diagram illustrating an example of a display area rendered by the tablet PC at a second site in the third embodiment;

FIG. 21 is a diagram illustrating an example of handwriting data of the tablet PC at the second site displayed by the interactive whiteboard at the first site in the third embodiment;

FIG. 22 is a diagram illustrating a method performed by the meeting server of the third embodiment to adjust the position of the handwriting data of the tablet PC at the second site;

FIG. 23 is a diagram illustrating an example of a circumscribed rectangle of the third embodiment circumscribed around the first and second groups to include the first and second groups;

FIG. 24 is a diagram illustrating an example of the renderable area of the third embodiment, in which the rendering data of the second group is moved to the right of the rendering data of the first group;

FIG. 25A is a diagram illustrating an exemplary relationship between pre-adjustment rendering data and the display area in the third embodiment;

FIG. 25B is a diagram illustrating an exemplary relationship between post-adjustment rendering data and the display area in the third embodiment;

FIG. 26 is a sequence diagram illustrating an exemplary process in which the meeting server of the third embodiment moves the rendering data of the tablet PC to display the rendering data in the display area of the interactive whiteboard;

FIGS. 27A, 27B, 27C, and 27D are diagrams illustrating an example of rendering data displayed by apparatuses at four sites in a fourth embodiment;

FIG. 28 is a diagram illustrating an example of the rendering data of the four sites of the fourth embodiment grouped with circumscribed rectangles in the renderable area;

FIG. 29 is a schematic diagram illustrating an example of characters clipped from first to fourth groups in the fourth embodiment;

FIG. 30 is a diagram illustrating an example of the rendering data of the fourth embodiment after the increase and reduction in size of the first to fourth groups;

FIG. 31 is a diagram illustrating an example of the renderable area of the fourth embodiment, in which the display area of the interactive whiteboard at the first site is divided into four equal areas;

FIG. 32 is a diagram illustrating an example of the rendering data of the first to fourth groups moved in the fourth embodiment;

FIG. 33 is a diagram illustrating an example of the renderable area of the fourth embodiment, in which the second group is moved leftward by a particular distance to be adjacent to the first group;

FIG. 34 is a diagram illustrating an example of entire rendering data displayed in one screen by the interactive whiteboard in the fourth embodiment;

FIG. 35 is a sequence diagram illustrating an exemplary process in which the meeting server of the fourth embodiment displays the rendering data of the four sites in one screen;

FIG. 36 is a diagram illustrating an exemplary system configuration of a virtual meeting system of a fifth embodiment;

FIG. 37 is a diagram illustrating an exemplary hardware configuration of virtual reality (VR) goggles included in the virtual meeting system of the fifth embodiment;

FIG. 38 is a diagram illustrating an exemplary hardware configuration of a VR operation controller included in the virtual meeting system of the fifth embodiment;

FIG. 39 is a functional block diagram illustrating exemplary functional blocks of a meeting server and an interactive whiteboard included in the virtual meeting system of the fifth embodiment;

FIG. 40 is a functional block diagram illustrating exemplary functional blocks of a virtual meeting server, a laptop PC, the VR googles, and the VR operation controller included in the virtual meeting system of the fifth embodiment;

FIG. 41 is a diagram illustrating an example of a meeting reservation screen of the fifth embodiment displayed by a given terminal apparatus;

FIG. 42 is a diagram illustrating an example of a virtual whiteboard in a virtual room provided by a virtual meeting service of the fifth embodiment;

FIG. 43 is a diagram illustrating a display example of a virtual meeting space displayed on the VR googles worn by a user at the second site in the fifth embodiment;

FIG. 44 is a diagram illustrating an example of the virtual whiteboard of the fifth embodiment displaying the rendering data with the VR operation controller;

FIG. 45 is a diagram illustrating an example of the rendering data in the renderable area of the meeting server of the fifth embodiment, including the rendering data rendered by the interactive whiteboard;

FIG. 46 is a diagram illustrating an example of the first group of rendering data rendered with the VR operation controller and the second group of rendering data rendered on the interactive whiteboard in the fifth embodiment;

FIGS. 47 and 48 are sequence diagrams illustrating an exemplary process of the fifth embodiment to render the rendering data with the VR operation controller and render the rendering data on the interactive whiteboard;

FIG. 49 is a diagram illustrating an exemplary system configuration of a remote meeting system of a sixth embodiment;

FIG. 50 is a functional block diagram illustrating exemplary functional blocks of a meeting server included in the remote meeting system of the sixth embodiment;

FIGS. 51A, 51B, 51C, and 51D are diagrams illustrating an example of rendering data rendered on first to fourth pages of a whiteboard area in a memory of the meeting server of the sixth embodiment;

FIG. 52 is a diagram illustrating an example of a menu bar of the sixth embodiment;

FIGS. 53A, 53B, 53C, and 53D are diagrams illustrating an example of the rendering data of the first to fourth pages grouped in the sixth embodiment;

FIGS. 54A, 54B, 54C, and 54D are diagrams illustrating characters clipped from the first to fourth groups in the sixth embodiment;

FIGS. 55A, 55B, 55C, and 55D are diagrams illustrating an example of the rendering data of the sixth embodiment after the increase and reduction in size of the first to fourth groups;

FIG. 56 is a diagram illustrating an example of the rendering data of the first to fourth pages written in an integrated area in the sixth embodiment;

FIG. 57 is a diagram illustrating an example of the integrated area of the sixth embodiment divided into four areas;

FIG. 58 is a diagram illustrating an example of the integrated area of the sixth embodiment with the third group moved downward; and

FIGS. 59, 60, and 61 are sequence diagrams each illustrating an exemplary process in which the meeting server of the sixth embodiment causes two interactive whiteboards to display the rendering data of a plurality of pages in one screen.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, a remote meeting system and an information display method performed by the remote meeting system are described below as embodiment examples of the present disclosure. As used herein, the singular forms “a,” “an,” and “the” are intended to include the plural forms as well, unless the context clearly indicates otherwise.

A first embodiment will be described.

In an apparatus used at each of a plurality of sites, such as an interactive whiteboard, a display area of the apparatus corresponding to the size of a screen may be set as one page, and when the display area runs out of open space, a user may switch to a new page to input handwriting on the new page. In this case, as a method to display the first page and the added page simultaneously, the two pages may be displayed side by side in reduced size to fit in one screen. An operation of thus displaying the pages, however, may be stressful for the user.

There is also an apparatus that, instead of displaying the display area in pages, allows a user to input handwriting in a vast space (at least larger than the display area) by scrolling the display area in a desired direction. This type of apparatus allows each of users at different sites to input handwriting in a desired place by scrolling the display area of the apparatus.

In both the above cases, however, it is difficult to display, in a single screen, all handwriting data input at the respective sites. If one of the users wants to check the handwriting data of the respective sites, therefore, the user manually moves and displays a plurality of pages or scrolls up and down the display area to check the handwriting data, which is time-consuming work.

According to one of the above-described techniques, the pages are displayed in reduced size to make the entire handwriting data viewable. If handwriting data items input by the users are distant from each other, however, an open space between the handwriting data items is increased. In this case, displaying the entire handwriting data in reduced size makes characters in the handwriting data substantially small and illegible.

To address this issue, part of the handwriting data input at the sites may be clipped by an apparatus and moved into an area corresponding to the display area of a particular apparatus to display all handwriting data in the display area.

However, if the handwriting data input by the users includes many characters, or if the handwriting data includes many large characters depending on the type of apparatus (e.g., an interactive whiteboard, a tablet personal computer (PC), or a whiteboard in a virtual reality (VR) space), simply combining a plurality of handwriting data item may fail to fit all handwriting data in a display screen.

To address the above-described issues, the first embodiment displays the handwriting data as follows. If the handwriting data input from the plurality of apparatuses is displayed extending outside the display area of a particular apparatus of the apparatuses in a renderable area, or if the handwriting data is displayed on a plurality of pages, all handwriting data is moved to and displayed in an area corresponding to the display area of the particular apparatus. The display area corresponds to the screen size, and the renderable area is included in a memory shared by the apparatuses.

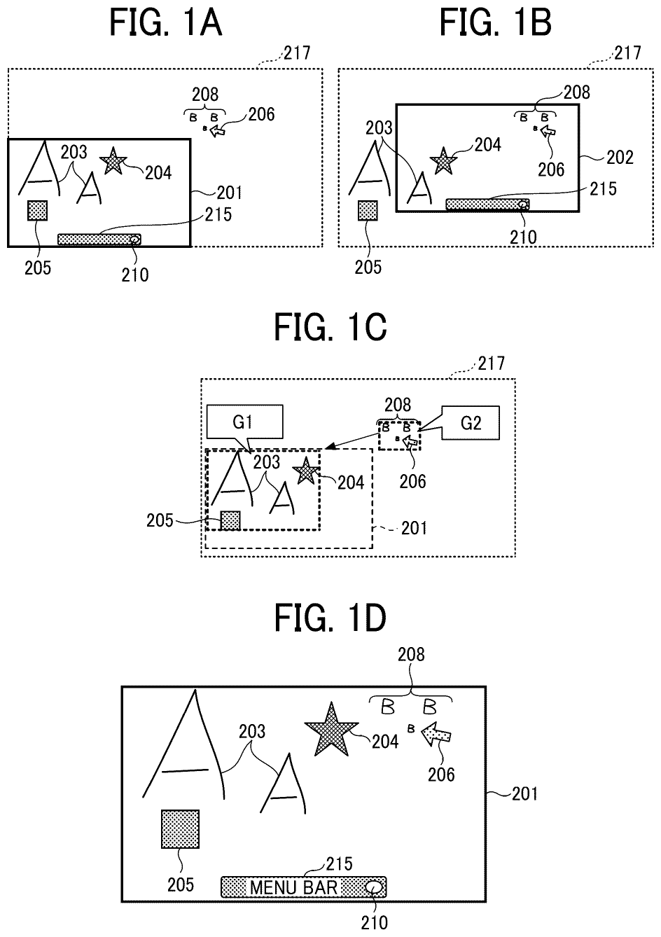

FIGS. 1A, 1B, 1C, and 1D are diagrams illustrating an overview of a process in which a meeting server of the first embodiment displays, in one screen, rendering data of a plurality of apparatuses located at a plurality of sites. FIG. 1A illustrates a display area 201 in a renderable area 217. The display area 201 is rendered on the apparatus at a site ST1. At the site ST1, two handwriting data items 203 of a character “A,” a star 204, and a square 205 are rendered. With the display area 201, a user specifies which part of the renderable area 217 to display. The renderable area 217 is larger than the display areas of the apparatuses, and has the possible maximum size that the memory allows. The renderable area 217 is included in a memory of the meeting server. A user is able to display a desired part of the renderable area 217 on the corresponding apparatus or add rendering data to the display area of the apparatus.

FIG. 1B illustrates a display area 202 in the renderable area 217. The display area 202 is displayed on the apparatus at a site ST2. At the site ST2, a user scrolls the display area 201 of the site ST1 slightly toward upper right to input handwriting. At the site ST2, three handwriting data items 208 of a character “B” and an arrow 206 (graphic) are rendered.

To display the rendering data of the sites ST1 and ST2 in one screen, the user at the site ST1 or ST2 presses (e.g., clicks, taps, or touches with the head of a pen) a display all button 210. In this case, the meeting server groups the rendering data of the sites ST1 and ST2. FIG. 1C illustrates the rendering data grouped into groups G1 and G2. In the grouping, all rendering data of one site is specified with a circumscribed rectangle, for example.

Then, the meeting server moves the groups G1 and G2 toward each other. The meeting server may move the group G1 toward the group G2 or vice versa. In this example, the meeting server fixes the position of the leftmost group G1 and moves the group G2 toward the group G1. For example, the meeting server moves the upper-left corner of the group G2 toward the upper-right corner of the group G1.

FIG. 1D illustrates the rendering data of the groups G1 and G2 after the movement. FIG. 1D illustrates the display area 201 of the apparatus at the site ST1, for example. With the group G2 thus moved close to the group G1, the apparatus (e.g., an interactive whiteboard) displays all rendering data in one screen in the display area 201 of the apparatus.

A description will be given of some terms used in this disclosure.

The term “rendering data” refers to data rendered in the display area of an apparatus. The term “rendering” refers to, as well as rendering handwriting, displaying an image acquired from an external source, for example. The rendering data, which includes handwriting data, text data (e.g., fonts), graphics (e.g., shapes), screen data, and images, for example, may be any displayable data.

The term “apparatus” refers to any apparatus or device that connects to the meeting server to participate in a remote meeting and display the rendering data. In the embodiment, the apparatus is, but not limited to, an interactive whiteboard, a tablet PC, a laptop PC, a smartphone, or a projector, for example.

The term “interactive whiteboard” refers to an apparatus that causes a device such as a display to display, in real time, a handwritten character or graphic, for example, input with a touch panel. The interactive whiteboard may have a function of connecting to a network and a function of converting the handwritten character into font data with an optical character recognition (OCR) technology, for example.

The term “display area” refers to the possible maximum area for the apparatus to display the rendering data. The display area is specified by the vertical pixel count and the horizontal pixel count, for example. The term “renderable area” refers to an area in a memory to hold the rendering data. The renderable area is larger than the display area, and is held by both the apparatus and the meeting server.

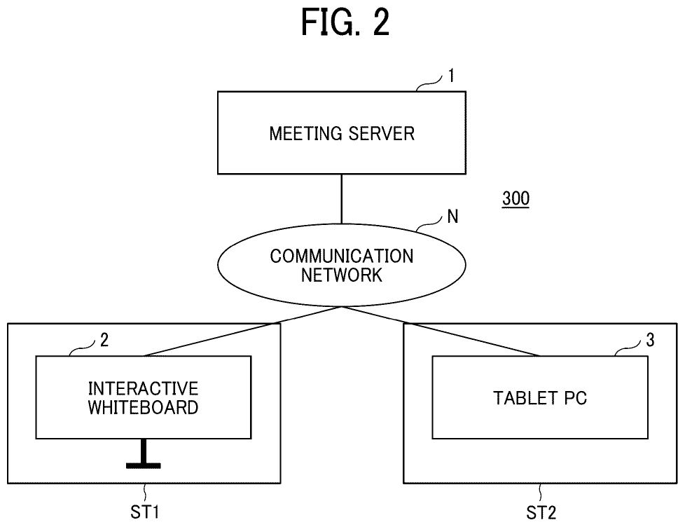

A system configuration of a remote meeting system 300 of the first embodiment will be described with reference to FIG. 2.

FIG. 2 is a diagram illustrating an exemplary system configuration of the remote meeting system 300. In the remote meeting system 300, a plurality of apparatuses at a plurality of sites (the sites ST1 and ST2 in this example) are communicably connected to each other via a meeting server 1 and a communication network N. For example, the apparatuses are an interactive whiteboard 2 and a tablet PC 3, which are illustrative, not limiting.

The communication network N is the Internet, for example, but may be an on-premise network such as an in-house network. The number of apparatuses or sites illustrated here is illustrative. For instance, the remote meeting system 300 may include two or more apparatuses. Further, a plurality of apparatuses may be used at one site.

The meeting server 1 is an information processing system including one or more information processing apparatuses. The meeting server 1 manages information such as meeting information, and controls the start and end of a meeting and the login of participants, for example. A service provided by a meeting application executed on the meeting server 1 will be hereinafter referred to as the meeting service.

The interactive whiteboard 2 and the tablet PC 3 are examples of an apparatus operated by a participant of the meeting (i.e., a user). The apparatus is not limited to the interactive whiteboard 2 or the tablet PC 3, and may be any information processing terminal that has a communication function and runs the meeting application, such as a PC, a smartphone, or a personal digital assistant (PDA).

The apparatus is preferably equipped with a touch panel to allow the user to input handwriting with an electronic pen (stylus) or fingertip. If the apparatus is not equipped with a touch panel, the user may input handwriting with a pointing device such as a mouse. The apparatus displays the rendering data such as text converted from the handwriting data, voice-input text, graphics, and PC screen data, as well as the handwriting data. These types of rendering data are shareable between the sites.

In the configuration as illustrated in FIG. 2, the interactive whiteboard 2 and the tablet PC 3 connect to the same uniform resource locator (URL) for the meeting. The URL and a password are previously distributed to the participants by electronic mail (email), for example. The rendering data displayed on the interactive whiteboard 2, image data of surroundings input from a camera, and audio data input from a microphone are transmitted to the meeting server 1, and the meeting server 1 transmits the data to the tablet PC 3. The tablet PC 3 receives the data, displays the rendering data and the image data, and outputs the audio data. Similarly, the rendering data displayed on the tablet PC 3, image data input from a camera, and audio data input from a microphone are transmitted to the meeting server 1, and the meeting server 1 transmits the data to the interactive whiteboard 2. The interactive whiteboard 2 receives the data, displays the rendering data and image data, and outputs the audio data. The interactive whiteboard 2 and the tablet PC 3 repeat the above-described process to proceed with the online meeting.

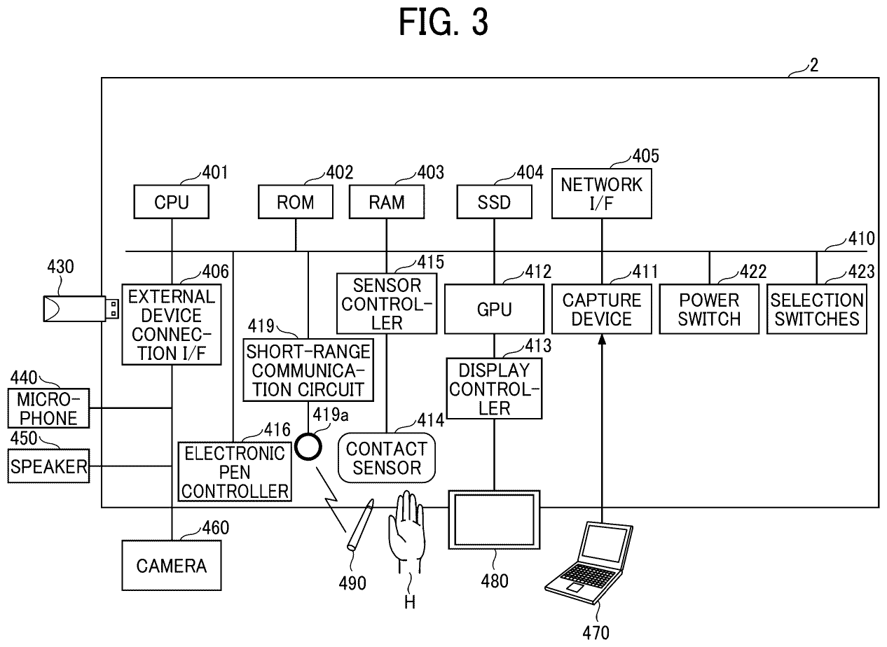

FIG. 3 is a diagram illustrating an exemplary hardware configuration of the interactive whiteboard 2. As illustrated in FIG. 3, the interactive whiteboard 2 includes a central processing unit (CPU) 401, a read only memory (ROM) 402, a random access memory (RAM) 403, a solid state drive (SSD) 404, a network interface (I/F) 405, and an external device connection I/F 406.

The CPU 401 controls overall operation of the interactive whiteboard 2. The ROM 402 stores a program used to start an operating system (OS), such as an initial program loader (IPL). The RAM 403 is used as a work area of the CPU 401. The SSD 404 stores various data such as programs for the interactive whiteboard 2. The network I/F 405 controls the communication with the communication network N. The external device connection I/F 406 is an interface for connecting various external devices to the interactive whiteboard 2. The external devices in this case include a universal serial bus (USB) memory 430 and external devices such as a microphone 440, a speaker 450, and a camera 460, for example.

The interactive whiteboard 2 further includes a capture device 411, a graphics processing unit (GPU) 412, a display controller 413, a connection sensor 414, a sensor controller 415, an electronic pen controller 416, a short-range communication circuit 419, an antenna 419a for the short-range communication circuit 419, a power switch 422, and selection switches 423.

The capture device 411 displays display information of a display of an external PC 470 as a still or video image. The GPU 412 is a semiconductor chip specifically for graphics processing. The display controller 413 controls and manages screen display to output an image from the GPU 412 to a display 480, for example. The contact sensor 414 detects the contact on the display 480 by an electronic pen 490 or a hand H of a user, for example. The sensor controller 415 controls the processing of the contact sensor 414. The contact sensor 414 detects input coordinates with an infrared blocking method. According to this method, the input coordinates are detected with two light emitting and receiving devices disposed on opposite end portions of an upper part of the display 480. In each of the light emitting and receiving devices, a light emitting device (e.g., a laser) performs 90-degree rotational scanning by emitting an infrared beam parallel to the display 480. The infrared beam is reflected by a reflecting member disposed around the display 480. A light receiving device of the light emitting and receiving device receives the reflected infrared beam returning on the optical path of the emitted infrared beam. The light emitting and receiving devices forming the contact sensor 414 output to the sensor controller 415 the information of infrared blocking positions representing the positions on the two light receiving devices at which the infrared beam is blocked by an object. Based on the information of the infrared blocking positions on the light receiving devices, the sensor controller 415 identifies the coordinate position corresponding to the contact position of the object. The electronic pen controller 416 communicates with the electronic pen 490 in accordance with a standard such as Bluetooth® (hereinafter simply referred to as Bluetooth) to determine whether the touch on the display 480 is by the head or end of the electronic pen 490. The electronic pen 490 is equipped with a switch for switching between pen-head mode for operating with the head of the electronic pen 490 and pen-end mode for operating with the end of the electronic pen 490. The electronic pen 490 transmits the information of the currently set mode in Bluetooth communication. In the pen-head mode, the interactive whiteboard 2 renders a line at the position of a sequence of coordinates along the trajectory of the touch. In the pen-end mode, the electronic pen 490 functions as an eraser to erase the line rendered at the position of the sequence of coordinates along the trajectory of the touch. The short-range communication circuit 419 is a communication circuit conforming to a standard such as near field communication (NFC) or Bluetooth. The power switch 422 is a switch for turning on or off the power supply of the interactive whiteboard 2. The selection switches 423 are a set of switches for adjusting the brightness and color tone of the display 480, for example.

The interactive whiteboard 2 further includes a bus line 410. The bus line 410 includes address buses and data buses for electrically connecting the CPU 401 and the other components in FIG. 3 to each other.

The contact sensor 414 is not limited to the infrared blocking method, and may be a capacitive touch panel that identifies the contact position by detecting a change in electrostatic capacitance. The contact sensor 414 may also be a resistance-film touch panel that identifies the contact position based on a change in voltage of two facing resistance films, or may be an electromagnetic induction touch panel that identifies the contact position by detecting electromagnetic induction caused by the contact of an object to a display unit. The contact sensor 414 may use various other detection means. The electronic pen controller 416 may further determine whether the touch on the display 480 is by a portion of the electronic pen 490 held by the user or any other portion of the electronic pen 490, as well as the head or end of the electronic pen 490.

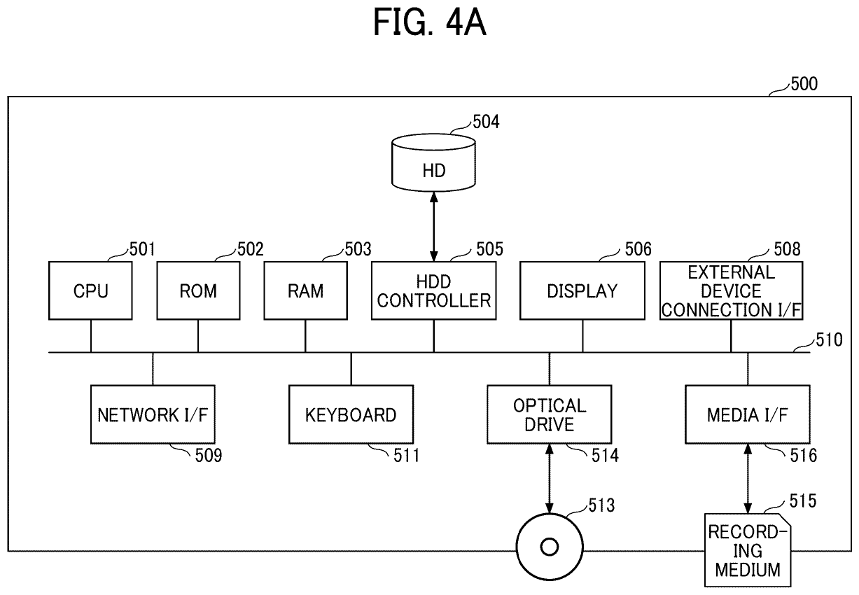

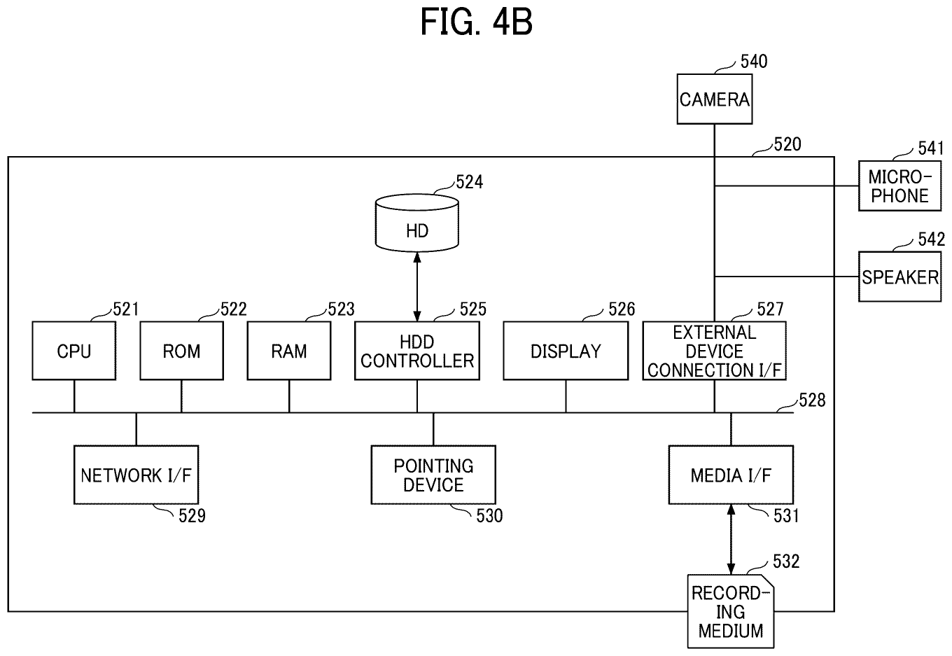

FIG. 4A is a diagram illustrating an exemplary hardware configuration of the meeting server 1. As illustrated in FIG. 4A, the meeting server 1 is implemented by a computer 500 including a CPU 501, a ROM 502, a RAM 503, a hard disk (HD) 504, a hard disk drive (HDD) controller 505, a display 506, an external device connection I/F 508, a network I/F 509, a bus line 510, a keyboard 511, an optical drive 514, and a media I/F 516.

The CPU 501 controls overall operation of the meeting server 1. The ROM 502 stores a program used to drive the CPU 501 such as an IPL. The RAM 503 is used as a work area of the CPU 501. The HD 504 stores various data such as programs. The HDD controller 505 controls the writing and reading of various data to and from the HD 504 under the control of the CPU 501. The display 506 displays various information such as a cursor, menus, windows, text, and images. The external device connection I/F 508 is an interface for connecting various external devices to the meeting server 1. The external devices in this case include a USB memory and a printer, for example. The network I/F 509 is an interface for performing data communication via a network. The bus line 510 includes address buses and data buses for electrically connecting the CPU 501 and the other components in FIG. 4A to each other.

The keyboard 511 is a type of input means including a plurality of keys used to input characters, numerical values, and various instructions, for example. The optical drive 514 controls the writing and reading of various data to and from an optical storage medium 513 as an example of a removal be recording medium. The optical storage medium 513 may be a compact disc (CD), a digital versatile disc (DVD), or a Blue-ray® disc, for example. The media I/F 516 controls the writing (i.e., storage) and reading of data to and from a recording medium 515 such as a flash memory.

FIG. 4B is a diagram illustrating an exemplary hardware configuration of the tablet PC 3. As illustrated in FIG. 4B, the tablet PC 3 is implemented by a computer 520 including a CPU 521, a ROM 522, a RAM 523, an HD 524, an HDD controller 525, a display 526, an external device connection I/F 527, a bus line 528, a network I/F 529, a pointing device 530, and a media I/F 531. The pointing device 530 is a touch panel.

The CPU 521 controls overall operation of the tablet PC 3. The ROM 522 stores a program used to drive the CPU 521 such as an IPL. The RAM 523 is used as a work area of the CPU 521. The HD 524 stores various data such as programs. The HDD controller 525 controls the writing and reading of various data to and from the HD 524 under the control of the CPU 521. The display 526 displays various information such as a cursor, menus, windows, text, and images. The external device connection I/F 527 is an interface for connecting various external devices to the tablet PC 3. The external devices in this case include a camera 540, a microphone 541, a speaker 542, a USB memory, and a printer, for example. The network I/F 529 is an interface for performing data communication via a network. The bus line 528 includes address buses and data buses for electrically connecting the CPU 521 and the other components in FIG. 4B to each other. The pointing device 530 is a type of input means for selecting and executing various instructions, selecting a processing target, and moving the cursor, for example. The media I/F 531 controls the writing (i.e., storage) and reading of data to and from a recording medium 532 such as a flash memory.

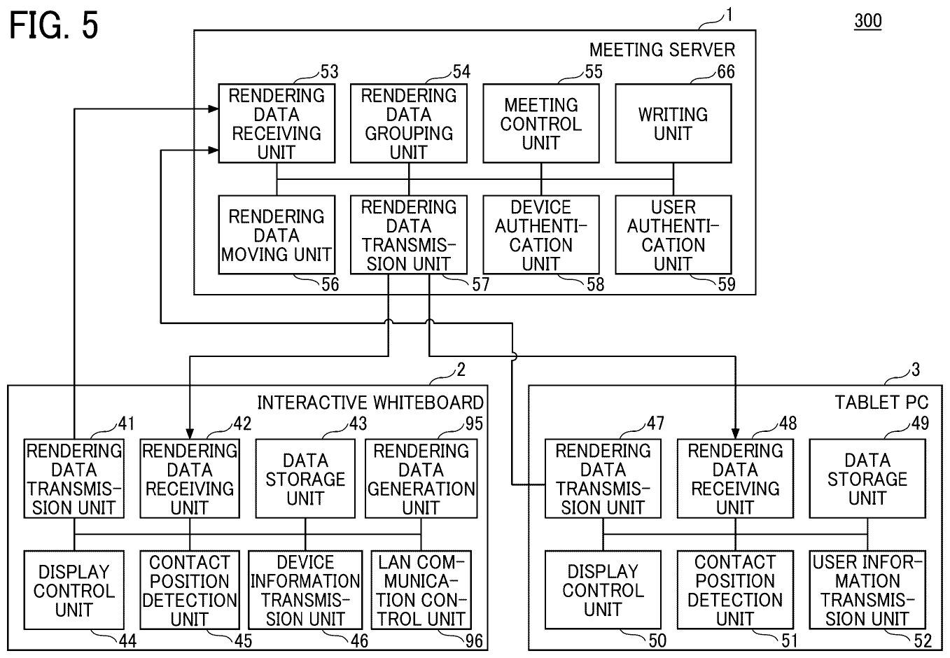

A functional configuration of the remote meeting system 300 will be described with reference to FIG. 5.

FIG. 5 is a functional block diagram illustrating exemplary functional blocks of the meeting server 1, the interactive whiteboard 2, and the tablet PC 3 in the remote meeting system 300.

The meeting server 1 includes a rendering data receiving unit 53, a rendering data grouping unit 54, a meeting control unit 55, a rendering data moving unit 56, a rendering data transmission unit 57, a device authentication unit 58, a user authentication unit 59, and a writing unit 66. Each of these units of the meeting server 1 is a function or functioning means implemented when at least one of the components illustrated in FIG. 4A operates based on a command from the CPU 501 in accordance with a program deployed in the RAM 503 from the HD 504.

The rendering data receiving unit 53 is means for receiving, from the plurality of apparatuses, the rendering data rendered in the display areas of the apparatuses. Specifically, the rendering data receiving unit 53 receives the rendering data such as the handwriting data and graphics transmitted from the interactive whiteboard 2 and the tablet PC 3.

The rendering data grouping unit 54 is means for grouping the rendering data written in the renderable area into groups corresponding to the apparatuses. Specifically, the rendering data grouping unit 54 specifies groups of rendering data with circumscribed rectangles, for example, to group the rendering data into groups corresponding to the interactive whiteboard 2 and the tablet PC 3.

The rendering data moving unit 56 is means for moving at least part of the rendering data written in the renderable area to arrange the rendering data of the plurality of sites in an area corresponding to the display area of a particular apparatus of the apparatuses. Alternatively, the rendering data moving unit 56 is means for arranging the rendering data of a plurality of pages in the area corresponding to the display area of the particular apparatus. Specifically, the rendering data moving unit 56 moves the grouped rendering data to fit in the area corresponding to the display area of the particular apparatus.

The rendering data transmission unit 57 is means for transmitting to the particular apparatus the rendering data of the plurality of sites arranged in the area corresponding to the display area of the particular apparatus by the rendering data moving unit 56. Specifically, the rendering data transmission unit 57 transmits the rendering data transmitted from one of the sites to the apparatus at other site. If the display all button 210 of the apparatus is pressed, the rendering data transmission unit 57 transmits to the apparatus the entire rendering data including the moved rendering data of one of the sites.

The meeting control unit 55 generates and registers a meeting, i.e., a meeting identifier (ID), in response to a request from one of the apparatuses that participate in the meeting. The meeting control unit 55 distributes the audio data and image data (including video image data) received from one of the apparatuses that participate in the meeting to the other apparatus. That is, the meeting control unit 55 distributes other data than the rendering data.

The device authentication unit 58 performs an authentication process on the interactive whiteboard 2 based on device information transmitted from the interactive whiteboard 2. The user authentication unit 59 performs an authentication process on the user based on user information (e.g., a user ID and a password) transmitted from the tablet PC 3.

The writing unit 66 is means for writing a plurality of rendering data items received from the interactive whiteboard 2 and the tablet PC 3 in one renderable area or on the same page as the page of the display area 201 of the interactive whiteboard 2. Specifically, the writing unit 66 writes the rendering data transmitted from the plurality of apparatuses in the renderable area 217 managed by the meeting server 1. The renderable area 217 is shared by the plurality of apparatuses.

The interactive whiteboard 2 includes a rendering data transmission unit 41, a rendering data receiving unit 42, a data storage unit 43, a display control unit 44, a contact position detection unit 45, a device information transmission unit 46, a rendering data generation unit 95, and a local area network (LAN) communication control unit 96. Each of these units of the interactive whiteboard 2 is a function or functioning means implemented when at least one of the components illustrated in FIG. 3 operates based on a command from the CPU 401 in accordance with a program deployed in the RAM 403 from the SSD 404. The data storage unit 43 is formed in the SSD 404 and the RAM 403, for example.

The rendering data transmission unit 41 transmits the rendering data such as handwriting data and graphics to the meeting server 1.

The rendering data receiving unit 42 receives the rendering data such as handwriting data and graphics transmitted from the meeting server 1.

The display control unit 44 displays the rendering data such as handwriting data and graphics, meeting materials, and the rendering data received from the meeting server 1. The display control unit 44 further updates the display area 201 in accordance with the scrolling operation.

The contact position detection unit 45 detects the contact position of the electronic pen 490 or a finger (the hand H) of the user. The device information transmission unit 46 transmits the device information to the meeting server 1. The data storage unit 43 stores the device information and setting data of the interactive whiteboard 2.

The rendering data generation unit 95 generates the rendering data based on a sequence of coordinate points input from the contact position detection unit 45 when the user inputs handwriting. The rendering data generation unit 95 further generates graphics such as circle and rectangle. The LAN communication control unit 96 is means for transmitting and receiving the other data than the rendering data to and from the meeting server 1. Specifically, the LAN communication control unit 96 connects to the communication network N in accordance with a standard such as Ethernet (hereinafter simply referred to as Ethernet) to transmit and receive data to and from another apparatus via the communication network N.

The tablet PC 3 includes a rendering data transmission unit 47, a rendering data receiving unit 48, a data storage unit 49, a display control unit 50, a contact position detection unit 51, and a user information transmission unit 52. Each of these units of the tablet PC 3 is a function or functioning means implemented when at least one of the components illustrated in FIG. 4B operates based on a command from the CPU 521 in accordance with a program deployed in the RAM 523 from the HD 524. The data storage unit 49 is formed in the HD 524 and the RAM 523, for example.

The rendering data transmission unit 47 transmits the rendering data such as handwriting data and graphics to the meeting server 1.

The rendering data receiving unit 48 receives the rendering data such as handwriting data and graphics transmitted from the meeting server 1.

The display control unit 50 displays the rendering data such as handwriting data and graphics, the meeting materials, and the rendering data received from the meeting server 1. The display control unit 50 further updates the screen in accordance with the scrolling operation.

The contact position detection unit 51 detects the contact position of a pen or a finger of the user. The user information transmission unit 52 transmits the user information to the meeting server 1. The data storage unit 49 stores data such as setting data of the tablet PC 3 and the data of applications used by the user.

The interactive whiteboard 2 and the tablet PC 3 connect to the meeting server 1 to start the meeting.

When the interactive whiteboard 2 at the site ST1 powers on, the interactive whiteboard 2 connects to the meeting server 1 automatically or in response to an operation performed by the user. The interactive whiteboard 2 participates in the meeting if the interactive whiteboard 2 is previously registered in a meeting schedule, for example. The interactive whiteboard 2 transmits the device information to the meeting server 1. The meeting server 1 performs the authentication process on the interactive whiteboard 2 based on the device information. If the authentication succeeds, the meeting server 1 allows the interactive whiteboard 2 to participate in the meeting.

The tablet PC 3 connects to the meeting server 1 in response to an operation performed by the user at the site ST2. The tablet PC 3 specifies the meeting with the URL, for example, to connect to the meeting. The tablet PC 3 further transmits the user information to the meeting server 1. If the authentication of the tablet PC 3 succeeds, the meeting server 1 allows the user of the tablet PC 3 to participate in the meeting.

Then, the user at the site ST1 starts a whiteboard application on the interactive whiteboard 2, and the interactive whiteboard 2 displays the screen of the whiteboard application on the display 480 of the interactive whiteboard 2. The display area in the screen of the whiteboard application is the display area 201. The interactive whiteboard 2 transmits a start whiteboard command to the meeting server 1 and switches to share mode to share the rendering data with the apparatus at the other site. The start whiteboard command includes display pixel counts (i.e., a vertical pixel count and a horizontal pixel count) of the display area 201. In response to receipt of the start whiteboard command, the meeting server 1 stores the display pixel counts transmitted with the start whiteboard command in a memory in association with the device information of the interactive whiteboard 2. The meeting server 1 generates the renderable area 217 of any size greater than the size based on the display pixel counts. Herein, generating the renderable area 217 means allocating a large area of the memory to write the rendering data.

The user at the site ST2 also starts the whiteboard application on the tablet PC 3, and the tablet PC 3 displays the screen of the whiteboard application on the display 526 of the tablet PC 3. The size of the display area 202 of the tablet PC 3 corresponds to the possible maximum size of the screen of the whiteboard application. The tablet PC 3 transmits a start whiteboard command to the meeting server 1 and switches to share mode to share the rendering data with the apparatus at the other site. The start whiteboard command includes display pixel counts of the display area 202. In response to receipt of the start whiteboard command, the meeting server 1 stores the display pixel counts transmitted with the start whiteboard command in the memory in association with the device information of the tablet PC 3.

The display area of the whiteboard application displayed by the interactive whiteboard 2 and the display area of the whiteboard application displayed by the tablet PC 3 are managed in association with the respective positions thereof in the memory of the meeting server 1. When the display area is scrolled on the interactive whiteboard 2 or the tablet PC 3, the display area is moved. The position of the display area 201 of the interactive whiteboard 2 or the display area 202 of the tablet PC 3 is changeable by the user.

When the user inputs handwriting to the interactive whiteboard 2 at the site ST1, the contact position detection unit 45 detects the contact position corresponding to the handwriting, and the display control unit 44 generates and displays handwriting data at the contact position. Further, if the user selects a shape (graphic) from a shape list, which is displayed when a shape icon of a menu bar is pressed, as described below, the display control unit 44 generates and displays the shape.

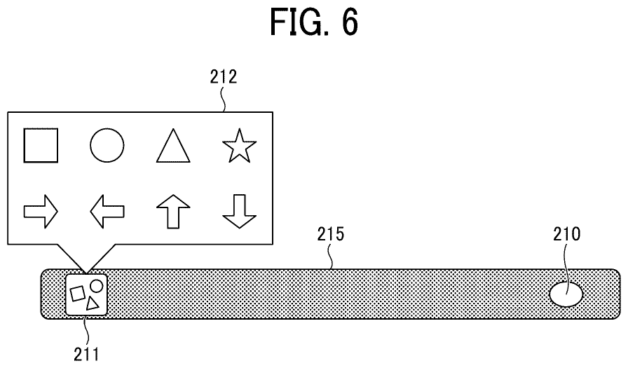

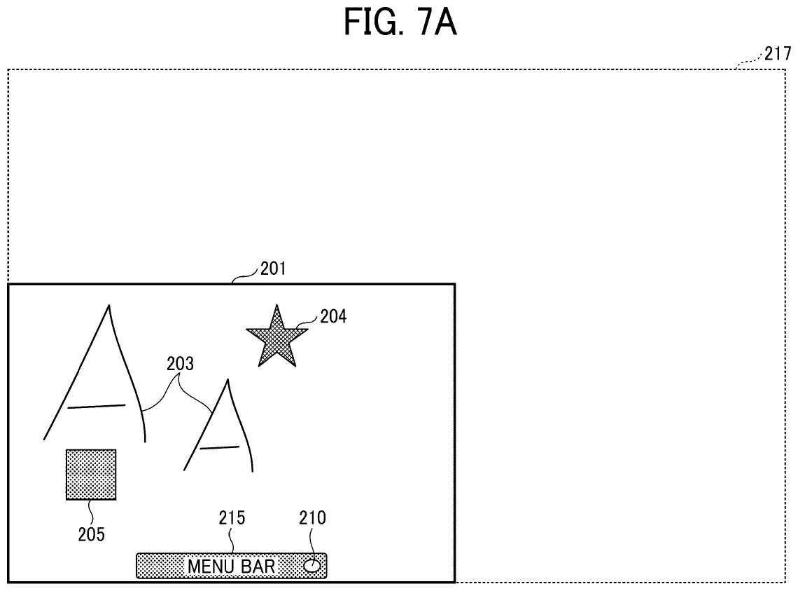

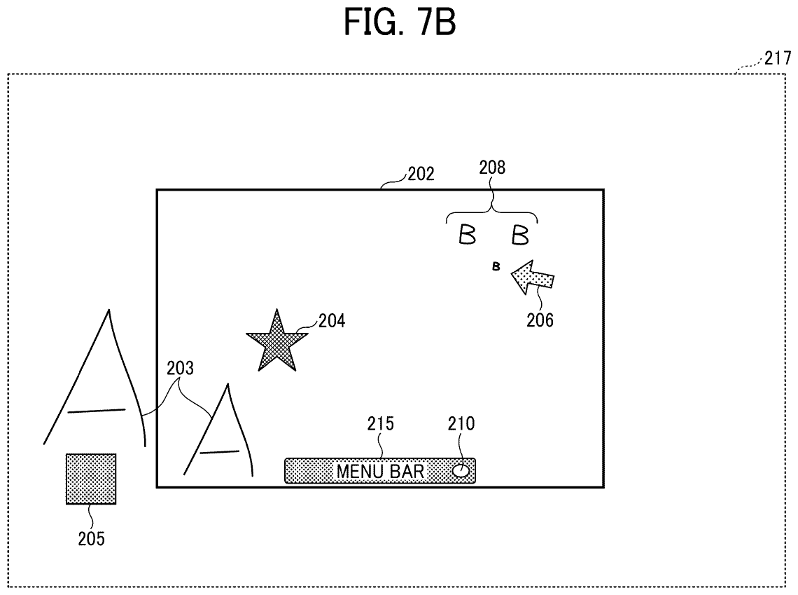

FIG. 6 illustrates an example of a shape list 212 displayed when a shape icon 211 is pressed. The shape icon 211 and the display all button 210 are included in a menu bar 215. The user selects a desired shape from the shape list 212, and the interactive whiteboard 2 displays the selected shape. The rendering data transmission unit 41 of the interactive whiteboard 2 or the rendering data transmission unit 47 of the tablet PC 3 sequentially transmits the rendering data such as handwriting data and graphics to the meeting server 1. The meeting server 1 writes the received rendering data in the renderable area 217 of a whiteboard in the memory. FIG. 7A illustrates the rendering data of the renderable area 217 in the memory of the meeting server 1, in which a character “A,” a square, and a star are rendered.

The rendering data of the renderable area 217 in the memory of the meeting server 1 illustrated in FIG. 7A includes the two handwriting data items 203 of the character “A,” the star 204, and the square 205. FIG. 7A further illustrates the display area 201 of the interactive whiteboard 2. The display area 201 may be displayed differently depending on the apparatus. The meeting server 1 holds the current display areas of the respective apparatuses.

The meeting server 1 further transmits the received rendering data to the tablet PC 3 at the site ST2, which is participating in the same meeting. The tablet PC 3 at the site ST2 receives and displays the rendering data.

The user at the site ST2 wants to handwrite information related to the rendering data input at the site ST1 in an open space to the right of the star 204, but the open space is not large enough. The user at the site ST2 therefore scrolls the renderable area 217 leftward to expand the open space, and handwrites the information in the expanded open space. Herein, the scrolling is performed on the renderable area 217 of the whiteboard, not on the display area. That is, the display area is fixed in position, and the scrolling direction corresponds to the direction of moving the renderable area 217.

In the tablet PC 3, the contact position detection unit 51 detects the leftward scrolling performed by the user with the pen, and the display control unit 50 moves the display area. If the user inputs handwriting or displays a graphic on the tablet PC 3 at the site ST2 with the pen, the contact position detection unit 51 detects the contact position of the pen, and the display control unit 50 generates and displays the handwriting data or graphic. The rendering data transmission unit 47 sequentially transmits the rendering data to the meeting server 1. The meeting server 1 writes the rendering data received from the tablet PC 3 in the renderable area 217 of the whiteboard in the memory.

FIG. 7B illustrates the rendering data of the renderable area 217 in the memory of the meeting server 1 after the user handwrites the handwriting data items 208 of the character “B” and displays the arrow 206 on the tablet PC 3 and the tablet PC 3 transmits the rendering data of the handwriting data items 208 and the arrow 206 to the meeting server 1.

FIG. 7B further illustrates the display area 202 of the tablet PC 3. In response to receipt of the rendering data from the site ST2, the meeting server 1 writes the rendering data in the renderable area 217 of the whiteboard in the memory. The meeting server 1 further transmits the received rendering data to the interactive whiteboard 2 at the site ST1.

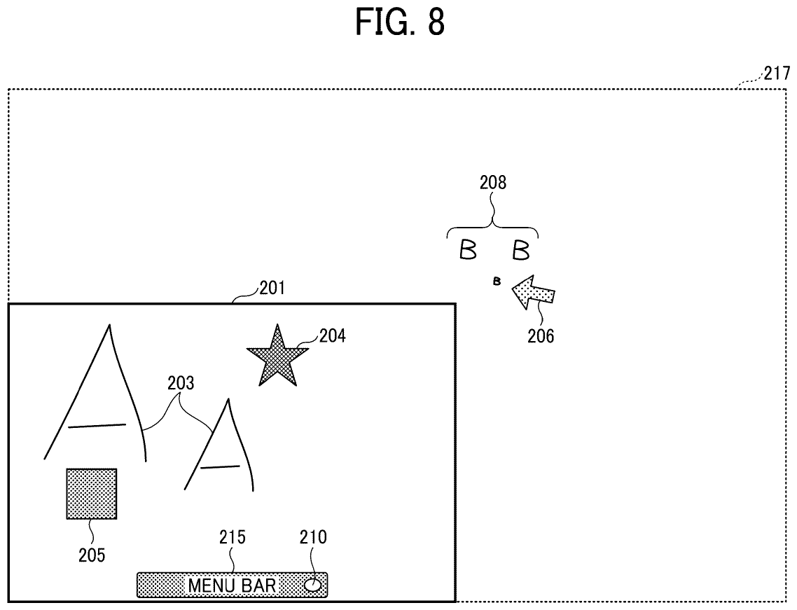

FIG. 8 illustrates the display area 201 of the interactive whiteboard 2 at the site ST1. The interactive whiteboard 2 at the site ST1 receives the rendering data. Since the handwriting data items 208 and the arrow 206 rendered on the tablet PC 3 are outside the display area 201 of the interactive whiteboard 2, the handwriting data items 208 and the arrow 206 displayed on the tablet PC 3 are not displayed in the display area 201 of the interactive whiteboard 2 at the site ST1.

To view all rendering data of the whiteboard on the interactive whiteboard 2, the user at the site ST1 presses the display all button 210. The display all button 210 is included in the menu bar 215, which is displayed at a fixed position in the display area 201 of the interactive whiteboard 2. When the user at the site ST1 presses the display all button 210, the contact position detection unit 45 the interactive whiteboard 2 detects the pressing of the display all button 210. The interactive whiteboard 2 then transmits a display all command (i.e., a request to display the rendering data in one screen) to the meeting server 1.

The meeting server 1 receives the display all command, and the rendering data grouping unit 54 of the meeting server 1 groups the rendering data rendered on the interactive whiteboard 2 and the rendering data rendered on the tablet PC 3 into groups.

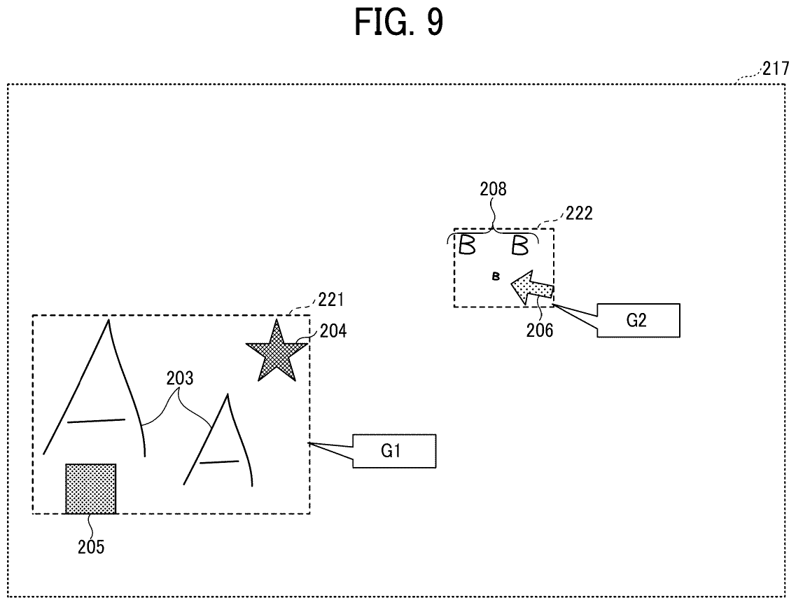

FIG. 9 illustrates the group G1 of the rendering data rendered on the interactive whiteboard 2 and the group G2 of the rendering data rendered on the tablet PC 3. Herein, grouping means defining circumscribed rectangles 221 and 222 each circumscribed around all rendering data of the corresponding apparatus, for example. The groups G1 and G2 may overlap. The circumscribed rectangles 221 and 222 in FIG. 9 are presented for explanatory purposes; it should be noted that the circumscribed rectangles 221 and 222 are not actually rendered in the memory of the meeting server 1.

In response to the pressing of the display all button 210 of the interactive whiteboard 2, the rendering data moving unit 56 of the meeting server 1 fixes the position of the group G1 of the interactive whiteboard 2 and moves the other group G2 close to the group G1. If the display all button 210 of the tablet PC 3 is pressed, for example, the rendering data moving unit 56 may fix the position of the group G2 of the tablet PC 3 and move the other group G1 close to the group G2. Alternatively, regardless of which one of the apparatuses has the display all button 210 pressed, the leftmost group G1 may be consistently fixed in position, and the other group G2 may be moved close to the group G1. Similarly, the rightmost group G2 may be fixed in position, and the other group G1 may be moved close to the group G2. Still alternatively, the centroid of all rendering data in the renderable area 217 may be calculated. Then, the group of rendering data of an apparatus rendered closest to the centroid may be fixed in position, and the other group may be moved close to the group of the apparatus.

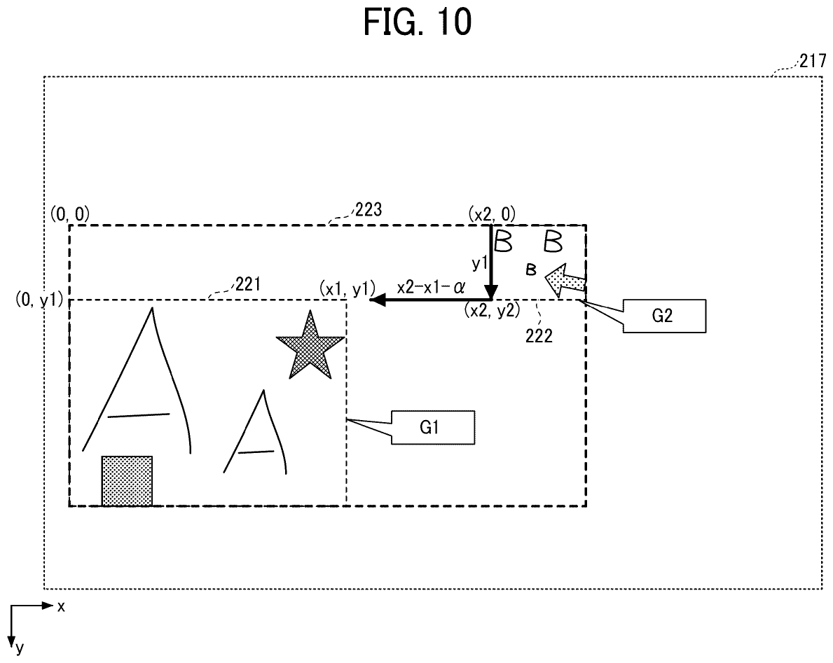

FIG. 10 is a diagram illustrating the movement of the groups. FIG. 10 illustrates a rectangular area 223 circumscribed around the groups G1 and G2 to include the groups G1 and G2. In FIG. 10, the width direction of the display area 201 corresponds to the x-axis, and the height direction of the display area 201 corresponds to the y-axis (the same applies to subsequent diagrams). The coordinates of the upper-left corner of the rectangular area 223 are set as the origin (0, 0). With reference to the origin (0, 0), the coordinates of the upper-left corner of the group G1 and the coordinates of the upper-right corner of the group G1 are represented as (0, y1) and (x1, y1), respectively. Further, the coordinates of the upper-left corner of the group G2 and the coordinates of the lower-left corner of the group G2 are represented as (x2, 0) and (x2, y2), respectively.

The rendering data moving unit 56 of the meeting server 1 calculates a horizontal distance (x2-x1) from the coordinates (x2, 0) of the upper-left corner of the group G2 to the coordinates (x1, y1) of the upper-right corner of the group G1. Herein, the distance is expressed in absolute value. To avoid the right end of the group G1 and the left end of the group G2 overlapping and becoming visually unclear, the rendering data moving unit 56 subtracts a margin α from the distance. The rendering data moving unit 56 further calculates a vertical distance y1 from the coordinates (x2, 0) of the upper-left corner of the group G2 to the coordinates (x1, y1) of the upper-right corner of the group G1.

In the renderable area 217, the rendering data moving unit 56 moves the rendering data of the group G2 leftward by a distance (x2−x1−α), and moves the rendering data of the group G2 downward by the distance y1. Alternatively, in the renderable area 217, the rendering data moving unit 56 moves the rendering data of the group G1 rightward by the distance (x2−x1−α), and moves the rendering data of the group G1 upward by the distance y1. The rendering data moving unit 56 holds the pre-movement rendering data of the groups G1 and G2 or at least the coordinates of the pre-movement rendering data. This is in consideration that the rendering data of the site ST2 has been moved without consent of the user at the site ST2, and that the user at the site ST1 may also want to bring the moved rendering data back to the original state.

A circumscribed rectangle circumscribed around the entire groups G1 and G2 after movement is an example of the area corresponding to the display area 201. The rendering data transmission unit 57 of the meeting server 1 transmits the post-movement rendering data to the interactive whiteboard 2. The rendering data receiving unit 42 of the interactive whiteboard 2 at the site ST1 receives the rendering data, and the display control unit 44 of the interactive whiteboard 2 displays the rendering data.

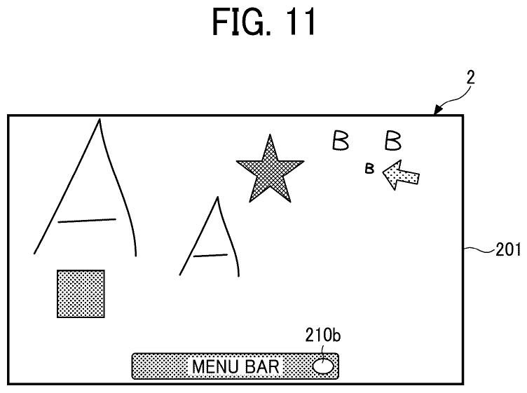

FIG. 11 illustrates the post-movement rendering data displayed by the interactive whiteboard 2. The rendering data rendered on the tablet PC 3 (i.e., the handwriting data items 208 and the arrow 206) is displayed in the display area 201 of the interactive whiteboard 2. With the group G2 thus moved close to the group G1 by the meeting server 1, all rendering data of the sites is displayed in one screen in the display area 201 of the interactive whiteboard 2 without reduction in the size of the rendering data. In FIG. 11, the display all button 210 has been changed to a cancel button 210b for cancelling the display all command. If the user presses the cancel button 210b for cancelling the display all command, the original display area 201 is displayed. In this case, the interactive whiteboard 2 may receive the rendering data of the display area 201 from the meeting server 1, or may acquire the rendering data of the display area 201 stored in the data storage unit 43 of the interactive whiteboard 2.

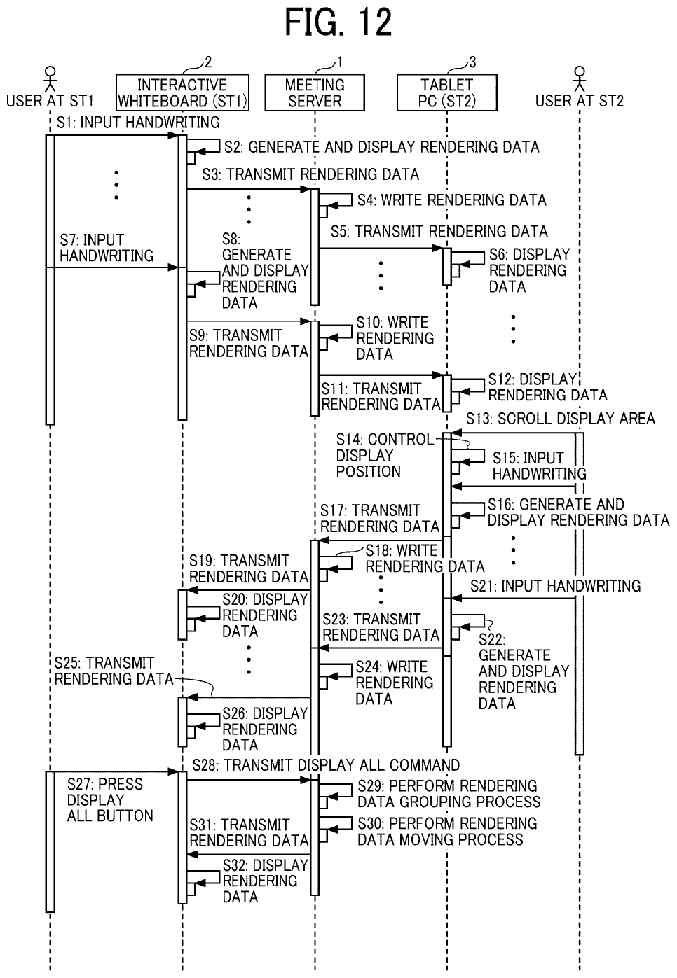

FIG. 12 is a sequence diagram illustrating a process in which the meeting server 1 moves the rendering data of the tablet PC 3 to display the rendering data in the display area 201 of the interactive whiteboard 2. Herein, the interactive whiteboard 2 and the tablet PC 3 are connected to the same meeting (session). The meeting server 1 has authenticated the interactive whiteboard 2 and the user of the tablet PC 3 based on the device information of the interactive whiteboard 2 and the user ID of the user operating the tablet PC 3, for example. The meeting server 1 transmits the rendering data to the internet protocol (IP) address of the interactive whiteboard 2 associated with the device information of the interactive whiteboard 2 and the IP address of the tablet PC 3 associated with the user ID.

At step S1, the user of the interactive whiteboard 2 inputs handwriting to the interactive whiteboard 2 with the electronic pen 490.

At step S2, the contact position detection unit 45 of the interactive whiteboard 2 detects the contact position of the electronic pen 490. If the contact position corresponds to the shape icon 211 of the menu bar 215 (see FIG. 6), a shape may be selected. The display control unit 50 of the interactive whiteboard 2 displays the rendering data such as handwriting data or graphic in the display area 201 of the interactive whiteboard 2.

At step S3, the rendering data transmission unit 41 of the interactive whiteboard 2 sequentially transmits the rendering data to the meeting server 1. Herein, the term “sequentially” is to be understood as in a sequence of rendered lines each corresponding to a stroke from pen-down to pen-up, for example.

At step S4, the rendering data receiving unit 53 of the meeting server 1 receives the rendering data, and the writing unit 66 of the meeting server 1 writes the rendering data in the renderable area 217 of the whiteboard in the memory. The rendering data is associated with the coordinates thereof in the renderable area 217. The information of which of the apparatuses has transmitted the rendering data is also recorded in the meeting server 1.

At step S5, the rendering data transmission unit 57 of the meeting server 1 transmits the rendering data received from the interactive whiteboard 2 to the tablet PC 3 preferably immediately after the receipt of the rendering data.

At step S6, the rendering data receiving unit 48 of the tablet PC 3 receives the rendering data. If the received rendering data is included in the current display area 202 of the tablet PC 3, the display control unit 50 of the tablet PC 3 renders the rendering data. If the received rendering data has a part not included in the current display area 202, the display control unit 50 does not render the part of the rendering data. The part of the rendering data not rendered, however, is still held in the data storage unit 49 of the tablet PC 3.

At steps S7 to S12, the user of the interactive whiteboard 2, the interactive whiteboard 2, the meeting server 1, and the tablet PC 3 repeat steps S1 to S6 each time the user of the interactive whiteboard 2 renders the rendering data.

At step S13, the user of the tablet PC 3, who wants to input handwriting to add rendering data near the rendering data rendered on the interactive whiteboard 2, finds that there is no sufficient open space. Therefore, the user of the tablet PC 3 scrolls the display area 202 of the tablet PC 3.

At step S14, the contact position detection unit 51 of the tablet PC 3 detects the direction and distance of the scroll with the pen. The display control unit 50 moves the display area 202 of the tablet PC 3 in accordance with the detected direction and distance of the scroll.

At step S15, the user of the tablet PC 3 inputs handwriting to the tablet PC 3 with the pen.

At step S16, the contact position detection unit 51 of the tablet PC 3 detects the contact position of the pen. If the contact position corresponds to the shape icon 211 of the menu bar 215, a shape may be selected. The display control unit 50 displays the rendering data such as the handwriting data or graphic in the display area 202 of the tablet PC 3.

At step S17, the rendering data transmission unit 47 of the tablet PC 3 sequentially transmits the rendering data to the meeting server 1.

At step S18, the rendering data receiving unit 53 of the meeting server 1 receives the rendering data, and the writing unit 66 of the meeting server 1 writes the rendering data in the renderable area 217 of the whiteboard in the memory. The rendering data is associated with the coordinates thereof in the renderable area 217. The information of which of the apparatuses has transmitted the rendering data is also recorded in the meeting server 1.

At step S19, the rendering data transmission unit 57 of the meeting server 1 transmits the rendering data received from the tablet PC 3 to the interactive whiteboard 2 preferably immediately after the receipt of the rendering data.

At step S20, the rendering data receiving unit 42 of the interactive whiteboard 2 receives the rendering data. If the received rendering data is included in the current display area 201 of the interactive whiteboard 2, the display control unit 44 of the interactive whiteboard 2 renders the rendering data. If the received rendering data has a part not included in the current display area 201, the display control unit 44 does not render the part of the rendering data. The part of the rendering data not rendered, however, is still held in the data storage unit 43 of the interactive whiteboard 2.

At steps S21 to S26, the user of the tablet PC 3, the tablet PC 3, the meeting server 1, and the interactive whiteboard 2 repeat steps S15 to S20 each time the user of the tablet PC 3 renders the rendering data. The user may scroll the display area 202.

At step S27, wanting the rendering data rendered on the tablet PC 3 to be displayed on the interactive whiteboard 2, the user of the interactive whiteboard 2 presses the display all button 210 with the electronic pen 490. If there are three or more sites, the user may specify a desired one of the sites and press the display all button 210. If the user does not specify any site, the rendering data of all sites is displayed in one screen.

At step S28, the contact position detection unit 45 of the interactive whiteboard 2 detects that the contact position of the electronic pen 490 corresponds to the display all button 210. Then, the rendering data transmission unit 41 of the interactive whiteboard 2 transmits a display all command to the meeting server 1.

At step S29, the rendering data receiving unit 53 of the meeting server 1 receives the display all command. In response to receipt of the display all command, the rendering data grouping unit 54 of the meeting server 1 groups rendering data of the apparatuses.

At step S30, the rendering data moving unit 56 of the meeting server 1 fixes the position of the left group or the group corresponding to the apparatus that has transmitted the display all command, for example. The rendering data moving unit 56 further moves the other group unfixed in position to fill the open space between the unfixed group and the fixed group. As described above, the rendering data moving unit 56 calculates the distances to move the right group so as to make the upper-right corner of the left group substantially match the upper-left corner of the right group, and moves the right group horizontally and vertically. Thereby, the gap between the rendering data groups is reduced, allowing the rendering data of the tablet PC 3 to be displayed in the display area 201 of the interactive whiteboard 2.

At step S31, the rendering data transmission unit 57 of the meeting server 1 transmits to the interactive whiteboard 2 the moved rendering data of the tablet PC 3 and the rendering data of the interactive whiteboard 2. The rendering data rendered on the interactive whiteboard 2 is not moved, and thus may not be transmitted to the interactive whiteboard 2.

At step S32, the rendering data receiving unit 42 of the interactive whiteboard 2 receives at least the moved rendering data of the tablet PC 3, and the display control unit 44 of the interactive whiteboard 2 displays the rendering data. After the display all button 210 is pressed, the rendering data displayable in the display area 201 of the interactive whiteboard 2 is expected to increase, increasing the possibility of all rendering data being displayed in the display area 201.

In the above-described example of the first embodiment, the user of the interactive whiteboard 2 presses the display all button 210. If the user of the tablet PC 3 presses the display all button 210, all rendering data is similarly expected to be displayed in the display area 202 of the tablet PC 3.

The meeting server 1 of the first embodiment thus moves one group close to the other group to reduce the gap between the groups of rendering data, thereby increasing the possibility of all rendering data being displayed in one screen in the display area of an apparatus.

A second embodiment will be described in which the meeting server 1 reduces or increases the size of the rendering data in accordance with the character size in the rendering data of the apparatuses.

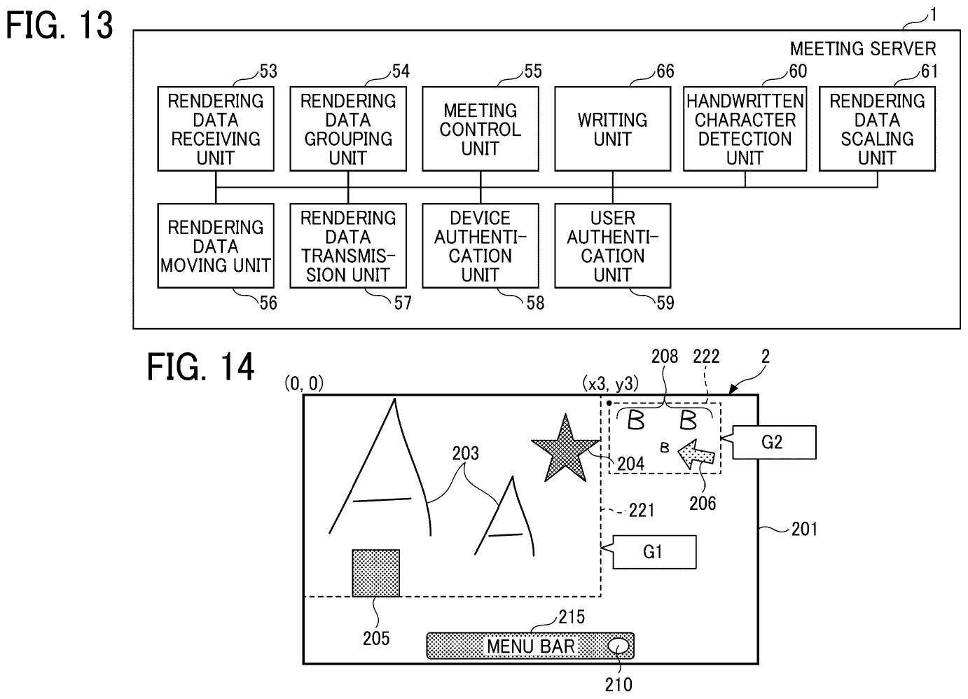

FIG. 13 is a functional block diagram of the meeting server 1 of the second embodiment. Since functional blocks of the interactive whiteboard 2 and the tablet PC 3 of the second embodiment are similar to those of FIG. 5, the functional blocks illustrated in FIG. 13 are limited to those of the meeting server 1 of the second embodiment. The meeting server 1 of FIG. 13 additionally includes a handwritten character detection unit 60 and a rendering data scaling unit 61.

The handwritten character detection unit 60 is means for detecting a character from the grouped rendering data. Specifically, the handwritten character detection unit 60 detects a handwritten character from the rendering data. The handwritten character may be a number. The handwritten character detection unit 60 detects the handwritten character by analyzing the rendering data formed with a sequence of coordinate points.

The rendering data scaling unit 61 is means for calculating the ratio between the mean of the sizes of characters detected from a first group and the mean of the sizes of characters detected from a second group, and if the ratio exceeds a threshold value, adjusting the respective rendering data sizes of the first and second groups to make the ratio equal to the threshold value. Specifically, the rendering data scaling unit 61 increases or reduces the size of the grouped rendering data such as handwriting data and graphics to reduce the difference in character size between the groups.

A process of increasing or reducing the size of the rendering data will be described.

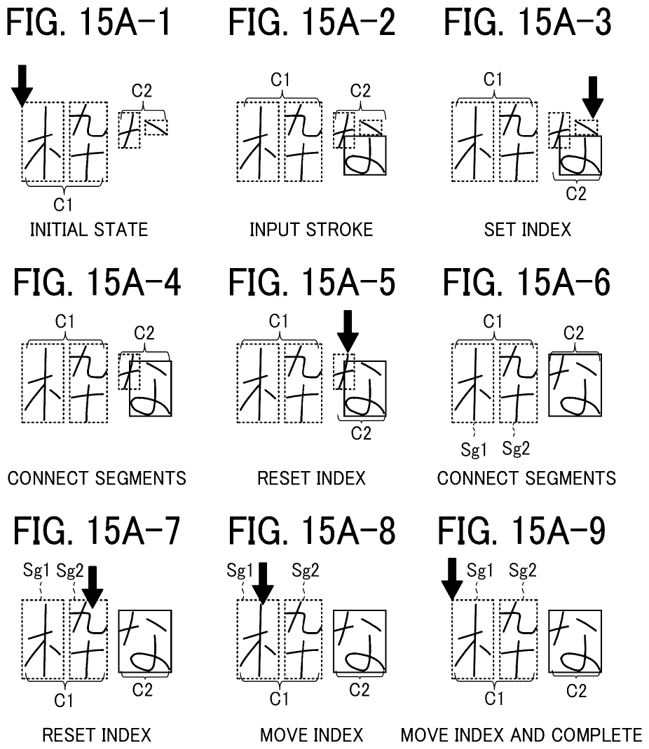

FIG. 14 illustrates the display area 201 of the interactive whiteboard 2. As described above in the first embodiment, the group G2 is moved close to the group G1. After the group G2 is thus moved, the handwritten character detection unit 60 detects handwritten characters from the groups G1 and G2.

FIGS. 15A-1 to 15A-9 are diagrams illustrating a method of detecting handwritten characters. In FIGS. 15A-1 to 15A-9, a broken-line box indicates an unconfirmed segment, and a solid-line box indicates a new segment. Further, an arrow represents an index indicating an unconfirmed segment immediately preceding the new segment. A segment is a component of a character, and is formed with one or more strokes each corresponding to a rendered line from pen-down to pen-up. One character is formed with one or more segments.

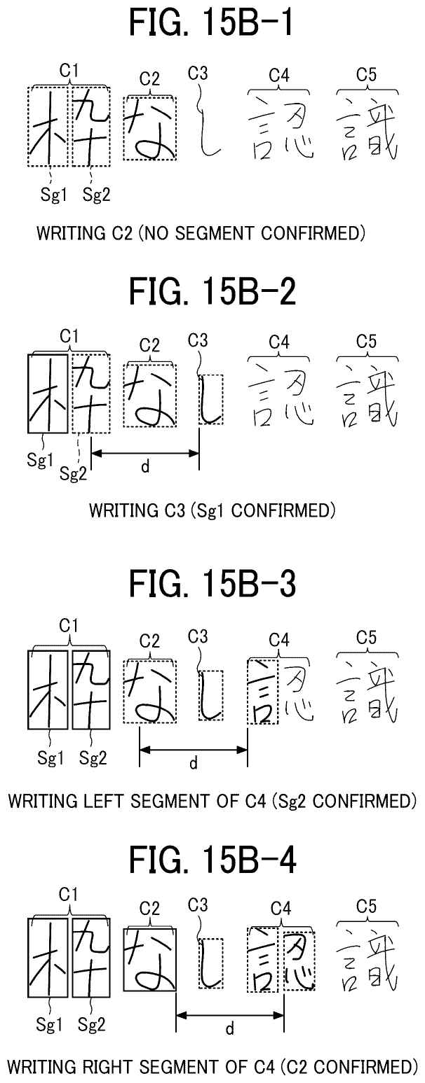

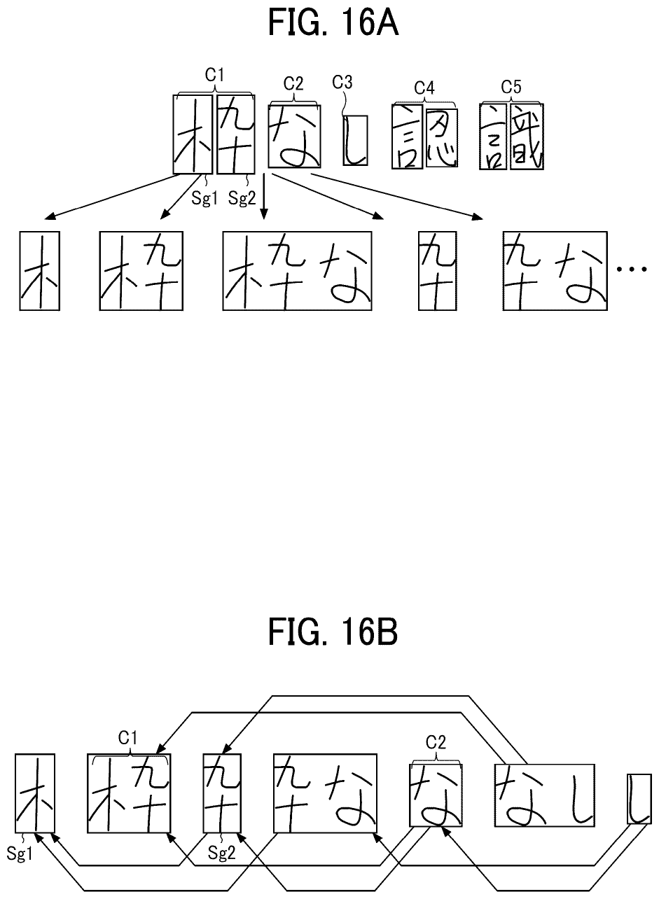

In FIGS. 15A-1 to 15A-9, a confirmed segment is positioned left of and apart from the current input position by at least two characters. The handwritten characters are represented as C1, C2, C3, C4 and C5, as illustrated in FIGS. 15B1 to 15B-4. FIG. 15A-1 illustrates segments of the characters C1 and C2 with strokes up to the third stroke of the character C2 written. The characters C1 and C2 are divided into four unconfirmed segments with gaps therebetween in the x-axis direction.

When the next stroke (i.e., the fourth stroke of the character C2) is input in the initial state of FIG. 15A-1, the fourth stroke of the character C2 becomes a new segment, as illustrated in FIG. 15A-2. The index is set to the latest unconfirmed segment (corresponding to the third stroke of the character C2 in this example), as illustrated in FIG. 15A-3. Then, X-coordinate data of the unconfirmed segment at the position of the index is compared with x-coordinate data of the new segment. If the two segments are located at respective positions meeting a particular criterion, the segments are combined to newly form a new segment, as illustrated in FIG. 15A-4. Then, the index is reset to the unconfirmed segment immediately preceding the new segment, as illustrated in FIG. 15A-5. The combining of segments and the resetting of the index take place in a similar fashion, as illustrated in FIGS. 15A-6 and 15A-7. In the state of FIG. 15A-6, there is a distinct gap between the new segment (i.e., the character C2) and an unconfirmed segment Sg2 (i.e., the second segment of the character C1) preceding the new segment. Therefore, the two segments are left uncombined, and the index is moved back to the previous segment, as illustrated in FIG. 15A-7. Since there is also a distinct gap between the segment Sg2 indicated by the index and a segment Sg1 immediately preceding the segment Sg2, the two segments Sg1 and Sg2 are left uncombined, and the index is reset to the immediately preceding the segment Sg1, as illustrated in FIG. 15A-8. Since there is no unconfirmed segment preceding the segment Sg1, the index is moved back to the left of the initial segment, not indicating any segment (i.e., there is no segment corresponding to the position of the index), as illustrated in FIG. 15A-9, and the new segment is registered as a new unconfirmed segment. If there is an unconfirmed segment preceding the index and following the confirmed segment, the above-described determination is performed on the unconfirmed segment (i.e., the unconfirmed segment apart from the latest segment by two characters or less in this example).

FIGS. 15B-1 to 15B-4 are diagrams illustrating a method of determining whether a segment has been confirmed. In FIG. 15B-1, the characters C1 and C2 in thick lines have been written, and the following characters C3 to C5 in thin lines have yet to be written. Herein, broken-line boxes indicate that the segments therein are all unconfirmed segments. Further, FIG. 15B-2 illustrates a state in which the next character C3 is written. In this state, the segment Sg1 positioned left of and apart from the left end of the segment of the character C3 by at least a threshold value d is confirmed. Similarly, when a stroke corresponding to the first segment of the character C4 is input, as illustrated in FIG. 15B-3, the segment Sg2 is apart from the left end of the first segment of the character C4 by at least the threshold value d, and thus is confirmed. The segment of the character C2, on the other hand, is not apart from the left end of the first segment of the character C4 by at least the threshold value d, and thus is not confirmed. When a stroke corresponding to the second segment of the character C4 is input, as illustrated in FIG. 15B-4, the segment of the character C2 is apart from the left end of the second segment of the character C4 by at least the threshold value d, and thus is confirmed.

As the writing proceeds, the segments positioned left of and apart from the latest stroke by at least the threshold value d are thus confirmed. When an unconfirmed segment becomes a new confirmed segment, the information of the unconfirmed segment is copied and added to a list of confirmed segments, and the old information of the unconfirmed segment is deleted. Herein, the threshold value d may be previously set to an appropriate value such as a maximum character width w or a particular character size, for example. If the handwritten characters are input in a row, the threshold value d may be set to the height of the row. The threshold value d is not limited to a particular value. Further, the threshold value d may be calculated as the maximum character width w×n, for example, instead of being set to the maximum character width w, the character size, or the row height per se. Herein, n typically ranges from 1.0 to 2.0, but is not limited to the range.

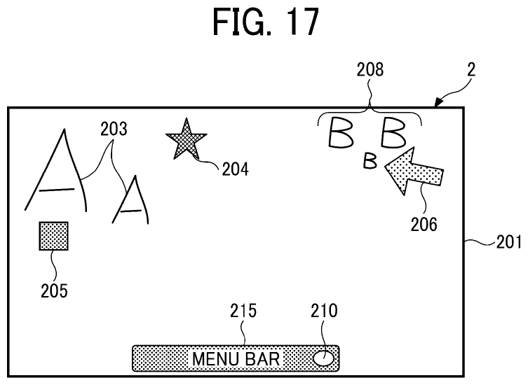

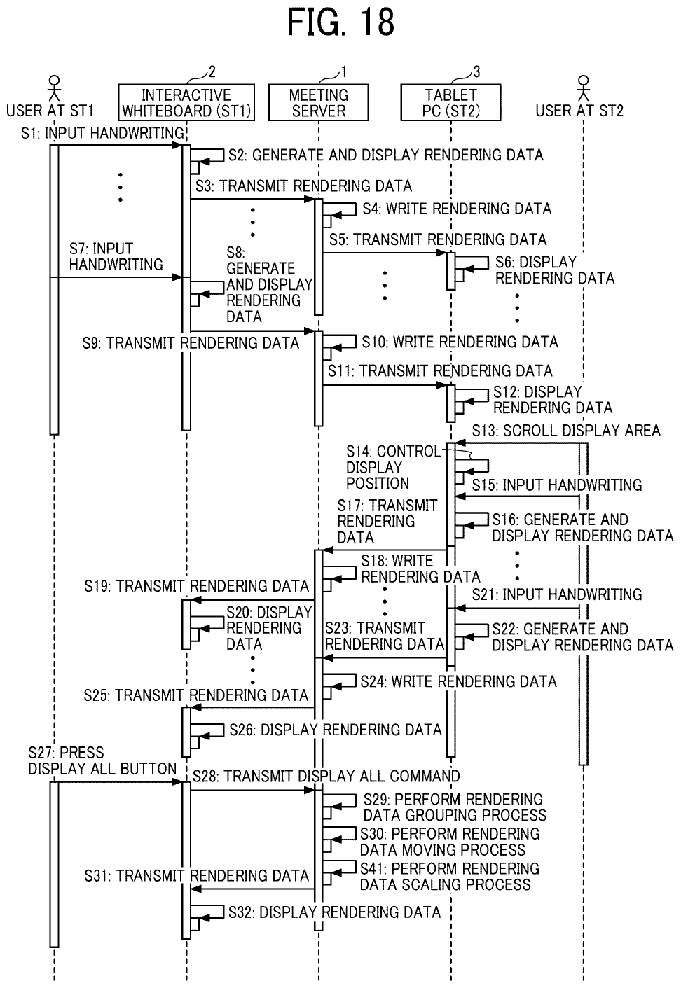

From a sequence of confirmed segments, the handwritten character detection unit 60 creates character area candidates, which are sets of confirmed segments that may form characters. The handwritten character detection unit 60 further creates a network of character areas connected by links. The handwritten character detection unit 60 then combines adjacent segments of the confirmed segments to determine the character areas. FIG. 16A illustrates exemplary combinations of segments of the characters C1 and C2 in the handwritten characters C1 to C5. Herein, character areas that may be adjacent to each other are linked together. FIG. 16B illustrates possible combinations of links between the handwritten characters C1 to C3, with the links indicated by arrows. For example, the first segment Sg1 and the segment Sg2 are connectable, and thus the segment Sg2 is linked to the segment Sg1. The segment Sg1 and the character C2, on the other hand, have the segment Sg2 therebetween; the character area of the segment Sg1 and the character area of the character C2 are not adjacent to each other. Therefore, the segment Sg1 and the character C2 are not connectable, and thus are not linked together.

Simply combining adjacent segments may result in numerous combinations. However, the segments should be combined to form appropriate characters, which limits the number of possible combinations. The example of FIG. 16B adopts a criterion that a segment is combinable if the width in the x-axis direction of the character area of the segment is within 1.5 times of the standard character size. The width, however, is not limited thereto.

As a method of detecting the characters, the characters may be detected with a machine learning model that detects characters from the rendering data.

Referring back to FIG. 14, the handwritten character detection unit 60 calculates the mean character size of clipped characters. The character size is represented by the point count corresponding to the size of the clipped character. Alternatively, the character size may be expressed in millimeters, for example.

The rendering data scaling unit 61 calculates the ratio between the mean of the sizes of the characters in the group G1 (an example of the first group) and the mean of the sizes of the characters in the group G2 (an example of the second group). Then, if the ratio exceeds a threshold value (e.g., 1.5), the rendering data scaling unit 61 adjusts the size of the rendering data of the group G1 and the size of the rendering data of the group G2 to make the ratio between the two means equal to the threshold value.

If the mean of the sizes of the two characters in the group G1 is 120 points (pts) and the mean of the sizes of the three characters in the group G2 is 30 pts, the ratio between the two means is made equal to the threshold value with the following equation.

$$( 120 \times x ) / ( 30 \times 1 / x ) = 1.5 , x \approx 0.612$$

Herein, x represents the reduction ratio of the group G1, and 1/x represents the enlargement ratio of the group G2. The rendering data scaling unit 61 of the meeting server 1 therefore scales the rendering data of the group G1 by a factor of 0.612 and scales the rendering data of the group G2 by a factor of 1/0.612 to make the ratio between the mean character size of the group G1 and the mean character size of group G2 equal to the threshold value. Thereby, the difference in character size between the groups G1 and G2 is reduced.

The rendering data scaling unit 61 further scales the star 204 and the square 205 of the group G1 by the factor of 0.612, and scales the arrow 206 of the group G2 by the factor of 1/0.612.

Consequently, the group G1 is scaled by the factor of 0.612 with the coordinates (0, 0) thereof fixed, and the group G2 is scaled by the factor of 1/0.612 with the coordinates (x3, y3) thereof fixed.

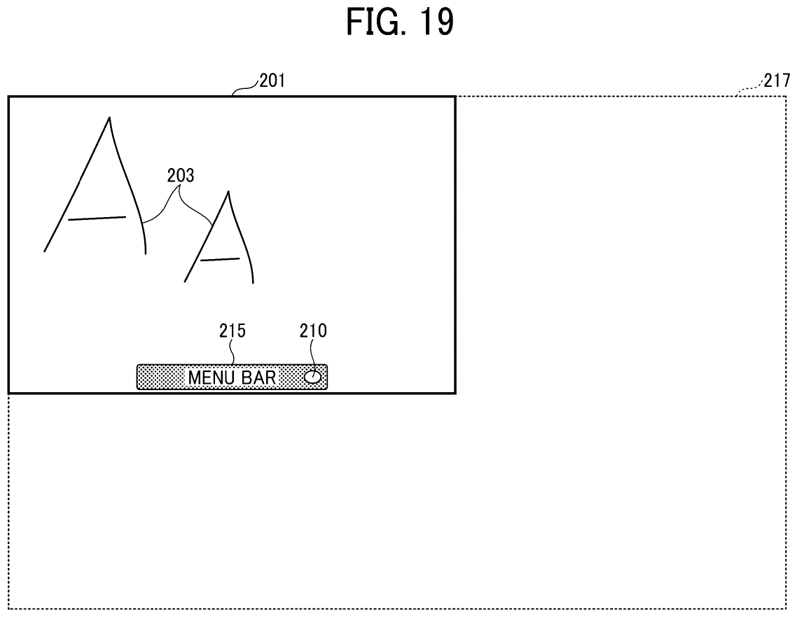

FIG. 17 illustrates the rendering data with the group G1 reduced and the group G2 enlarged. In this rendering data, the two handwriting data items 203 of the character “A,” the star 204, and the square 205 are reduced in size, and the three handwriting data items 208 of the character “B” and the arrow 206 are increased in size, reducing the difference in size between the groups G1 and G2.

The rendering data transmission unit 57 of the meeting server 1 transmits to the interactive whiteboard 2 the rendering data subjected to the increase and reduction in size. In the interactive whiteboard 2 at the site ST1, the rendering data receiving unit 42 receives the rendering data subjected to the increase and reduction in size, and the display control unit 44 displays the rendering data in the display area 201 of the interactive whiteboard 2. Consequently, the rendering data of all apparatuses is recognizably displayed in the display area 201.

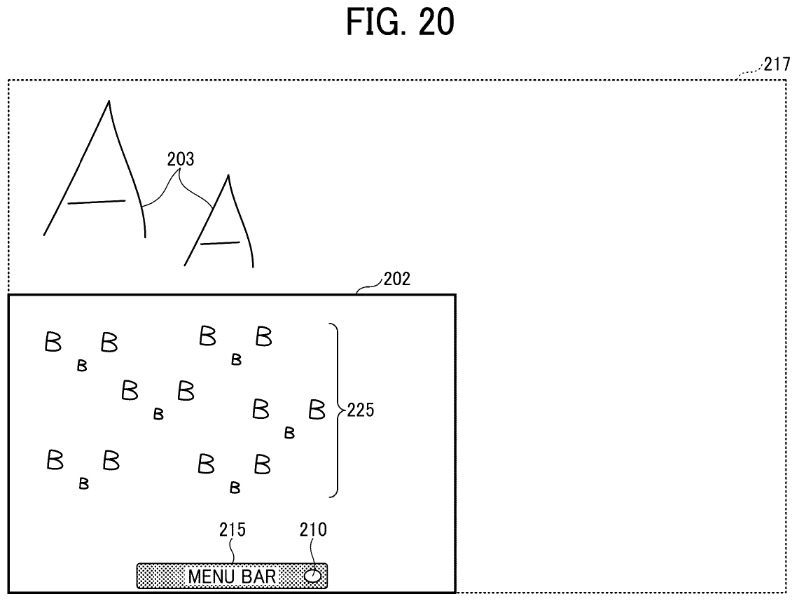

FIG. 18 is a sequence diagram illustrating a process in which the meeting server 1 moves the rendering data of the tablet PC 3 to display the rendering data in the display area 201 of the interactive whiteboard 2. The following description of FIG. 18 will focus on differences from FIG. 12.

The sequence diagram of FIG. 18 additionally includes step S41.

At step S41, after the rendering data of the group G2 is moved, the handwritten character detection unit 60 of the meeting server 1 detects the handwritten characters from the groups G1 and G2, and calculates the mean size of the clipped characters for each of the groups G1 and G2. The rendering data scaling unit 61 calculates the ratio between the mean of the sizes of the characters in the group G1 and the mean of the sizes of the characters in the group G2. Then, if the ratio exceeds the threshold value (e.g., 1.5), the rendering data scaling unit 61 adjusts the respective rendering data sizes of the groups G1 and G2 to make the ratio equal to the threshold value.

According to the second embodiment, the rendering data is reduced in size to increase the possibility of the rendering data of all sites being displayed in one screen. Consequently, the user does not have to scroll the screen to check the rendering data of all sites, which leads to a reduction in meeting time.

A third embodiment will be described.

In the third embodiment described below, the meeting server 1 moves the rendering data of one of two groups to an open space in the renderable area 217, instead of simply moving the two groups toward each other.

The following description of the third embodiment cites the functional block diagram of FIG. 13 described above in the second embodiment.

A procedure of a process performed by the meeting server 1 of the third embodiment will be described.

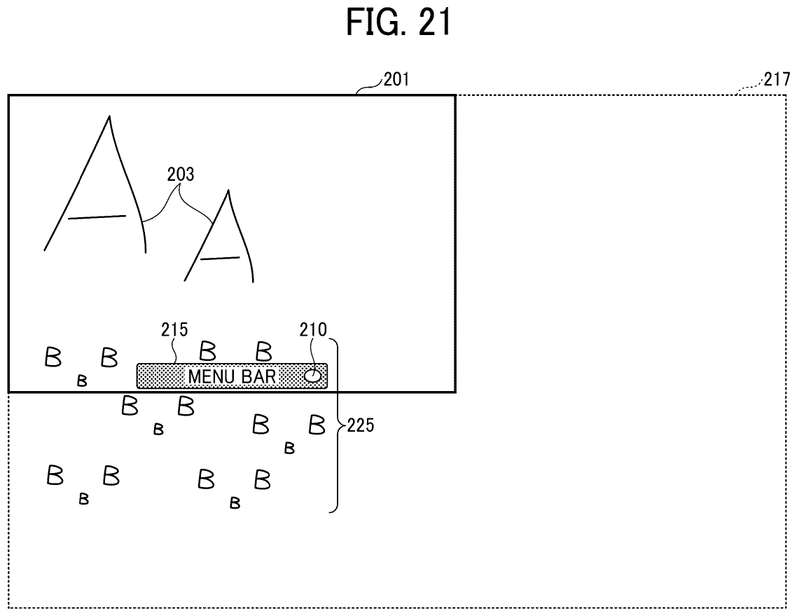

FIG. 19 illustrates the handwriting data items 203 rendered on the interactive whiteboard 2 at the site ST1. When the user inputs handwriting to the interactive whiteboard 2 at the site ST1, the contact position detection unit 45 of the interactive whiteboard 2 detects the contact position corresponding to the handwriting, and the display control unit 44 of the interactive whiteboard 2 generates and displays handwriting data at the contact position. The rendering data transmission unit 41 of the interactive whiteboard 2 transmits the rendering data related to the handwriting data to the meeting server 1. The meeting server 1 receives and transmits the rendering data from the site ST1 to the tablet PC 3 at the site ST2. The tablet PC 3 at the site ST2 receives and displays the rendering data.

The user at the site ST2 wants to add handwriting in an open space below the handwriting data items 203 of the site ST1, but the open space is not large enough. The user at the site ST2 therefore scrolls the renderable area 217 upward (i.e., scrolls the display area 201 downward) to expand the open space. In the tablet PC 3, the contact position detection unit 51 detects the upward scrolling, and the display control unit 50 moves the display area 201.

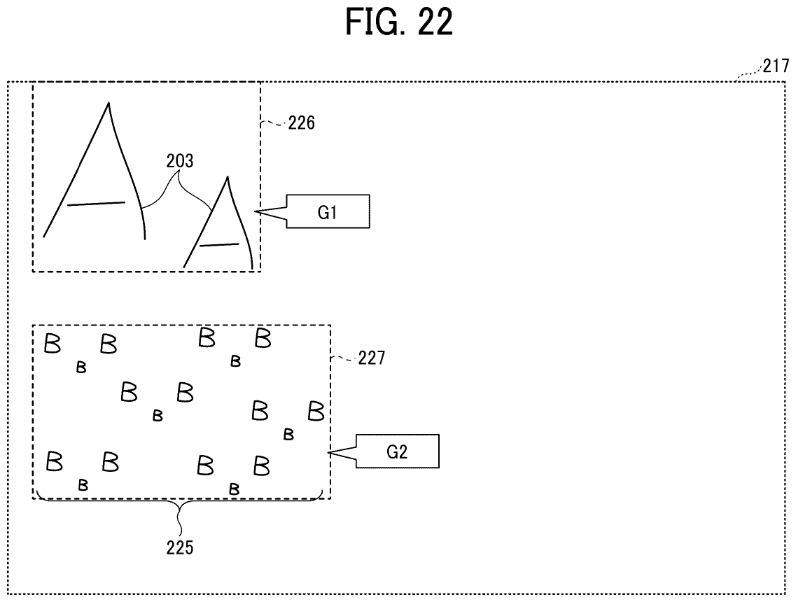

FIG. 20 illustrates the display area 202 rendered by the tablet PC 3 at the site ST2. The user at the site ST2 handwrites eighteen handwriting data items 225 of the character “B.” When the user inputs handwriting to the tablet PC 3 at the site ST2 with the pen, the contact position detection unit 51 detects the contact position corresponding to the handwriting, and the display control unit 50 generates and displays handwriting data at the contact position. The rendering data transmission unit 47 of the tablet PC 3 transmits the rendering data related to the handwriting data to the meeting server 1.

With the handwriting data items 225 rendered as in FIG. 20, however, the area of the handwriting data of the site ST2 increases, extending outside the display area 201 of the site ST1. The interactive whiteboard 2 may display the handwriting data of the site ST2 in reduced size, but the characters in the handwriting data will also be reduced in size.

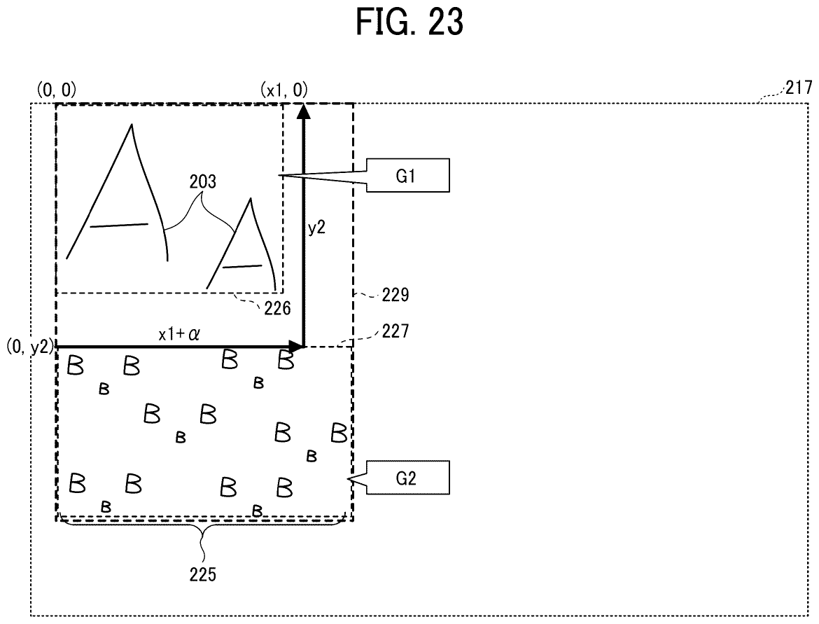

FIG. 21 illustrates the handwriting data of the interactive whiteboard 2 and the handwriting data of the tablet PC 3 rendered in the renderable area 217 of the meeting server 1. When displaying the handwriting data of the interactive whiteboard 2 and the handwriting data of the tablet PC 3 on the interactive whiteboard 2, the handwriting data of the tablet PC 3 input by the user at the site ST2 extends outside the display area 201 of the interactive whiteboard 2. In this case, simply moving the rendering data of the group G2 toward the rendering data of the group G1, as in the first embodiment, may not succeed in making the handwriting data input by the user at the site ST2 fit in the display area 201 of the interactive whiteboard 2.

In the third embodiment, therefore, the meeting server 1 adjusts the position of the handwriting data of the site ST2. The meeting server 1 holds the display pixel counts of the display areas of the apparatuses at the respective sites. According to the aspect ratio of the interactive whiteboard 2, the horizontal display pixel count of the interactive whiteboard 2 is greater than the vertical display pixel count thereof. If the rendering data of the tablet PC 3 is moved to the right of the handwriting data items 203, therefore, a substantial reduction in character size is prevented even if the rendering data is reduced in size with the aspect ratio maintained.

Specifically, a case is assumed here in which a first apparatus having requested to display the rendering data in one screen has a horizontally long display area, the rendering data of a second apparatus is written below the rendering data rendered in the display area of the first apparatus, and the rendering data of the first apparatus and the rendering data of the second apparatus do not fit in the display area of the first apparatus. In this case, the rendering data moving unit 56 moves the second group, which includes the rendering data rendered on the second apparatus, to be horizontally next to the first group, which includes the rendering data rendered on the first apparatus.

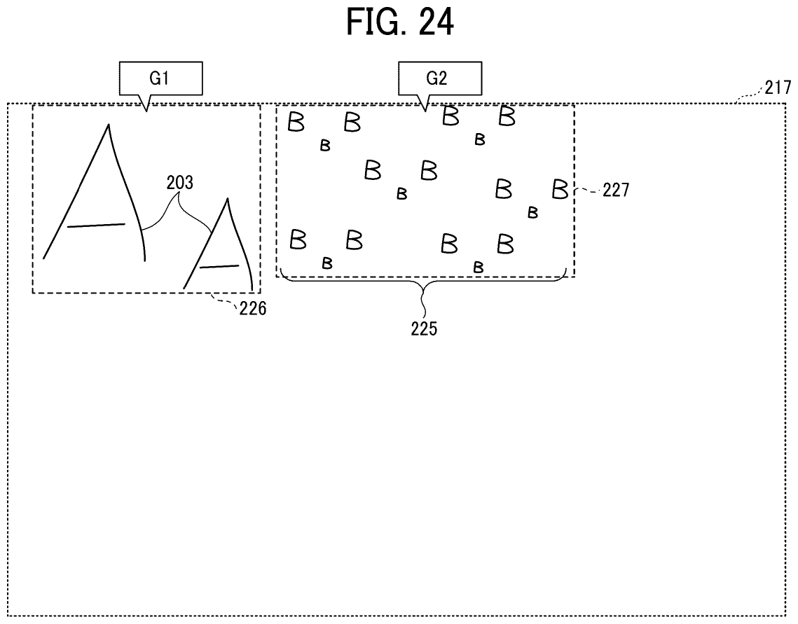

FIG. 22 is a diagram illustrating a method performed by the meeting server 1 to adjust the position of the handwriting data of the site ST2. If the user at the site ST1 presses the display all button 210 to view, on the interactive whiteboard 2, all rendering data rendered on the whiteboard in the memory of the meeting server 1, the interactive whiteboard 2 transmits a display all command to the meeting server 1.

Then, the meeting server 1 receives the display all command, and the rendering data grouping unit 54 of the meeting server 1 groups the rendering data of the respective sites. A method used here to group the rendering data may be specifying the groups with circumscribed rectangles 226 and 227 similarly as in the first embodiment. Then, the rendering data moving unit 56 and the rendering data scaling unit 61 of the meeting server 1 adjust the position and size of the rendering data of the tablet PC 3 at the site ST2 (an example of the second apparatus) such that the rendering data fits in the display area 201 of the interactive whiteboard 2 at the site ST1 (an example of the first apparatus). The rendering data moving unit 56 compares the reduction ratio in the case of moving the group G2 toward the group G1 as in the first embodiment and then reducing the size of the rendering data to make the rendering data fit in the display area 201 with the reduction ratio in the case of moving the group G2 to the right of the group G1 and then reducing the size of the rendering data to make the rendering data fit in the display area 201. It is assumed here that the latter reduction ratio is less than the former reduction ratio, i.e., the character size is less reduced with the latter reduction ratio.

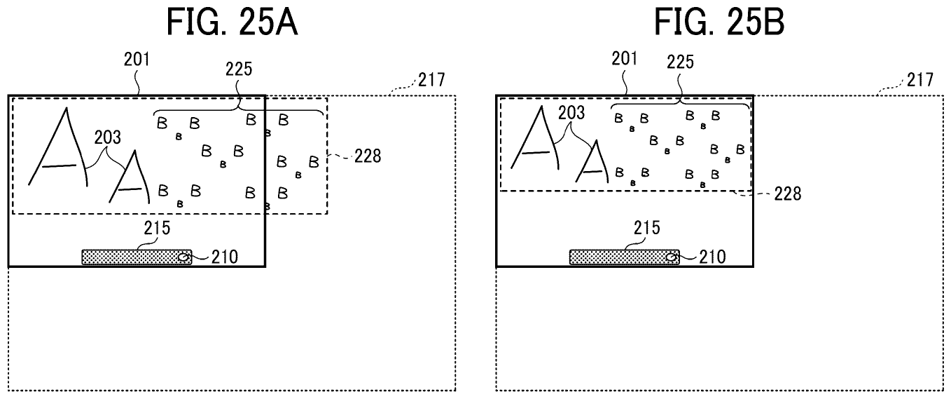

FIG. 23 illustrates a circumscribed rectangle 229 circumscribed around the groups G1 and G2 to include the groups G1 and G2. The two groups G1 and G2 are specified with a rectangular area enclosed by the circumscribed rectangle 229. The coordinates of the upper-left corner of the circumscribed rectangle 229 are represented as (0, 0). Further, the coordinates of the upper-right corner of the group G1 are represented as (x1, 0), and the coordinates of the upper-left corner of the group G2 are represented as (0, y2). The rendering data moving unit 56 moves the rendering data of the group G2 to the right of the group G1. Specifically, the rendering data moving unit 56 moves the group G2 to the right horizontally by a distance x1+α and moves the group G2 upward by a distance y2 such that the upper-left corner of the group G2 is located at a position to the right of and apart from the coordinates (x1, 0) of the upper-right corner of the group G1 by the margin α.

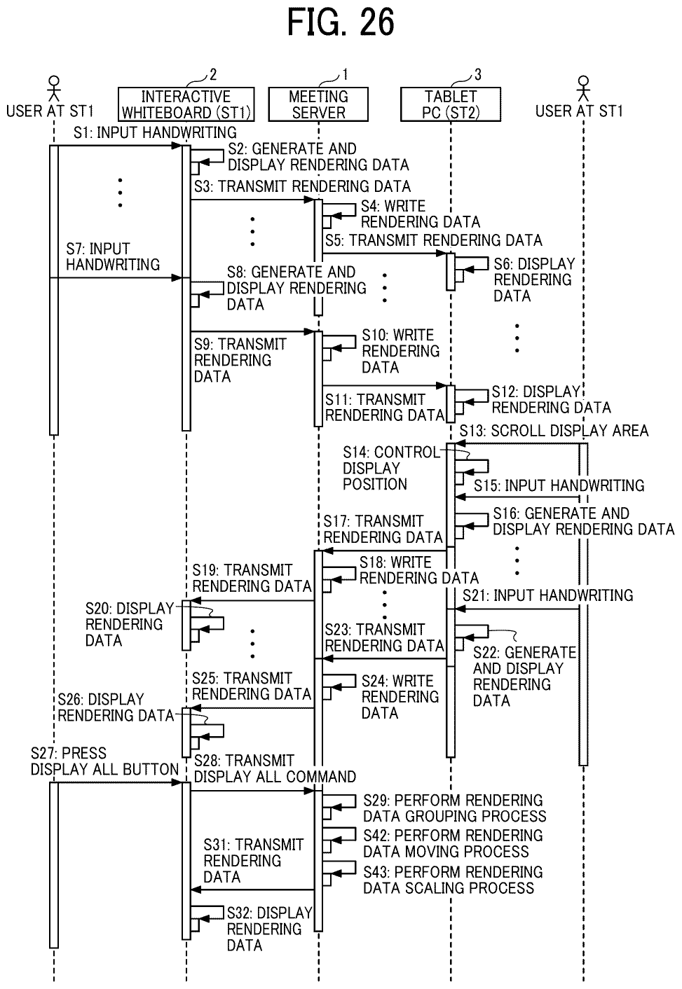

FIG. 24 illustrates the renderable area 217 with the rendering data of the group G2 moved to the right of the rendering data of the group G1. The rendering data scaling unit 61 then determines whether the size of the entire groups G1 and G2 as illustrated in FIG. 24 is within the size of the display area 201 of the interactive whiteboard 2. If the size of the entire groups G1 and G2 exceeds the size of the display area 201 of the interactive whiteboard 2, the rendering data scaling unit 61 adjusts the size of the entire groups G1 and G2 to make the entire groups G1 and G2 fit in the display area 201 of the interactive whiteboard 2.

That is, if the entire rendering data combining the first group G1 and the moved second group G2 does not fit in the display area of the first apparatus (i.e., the display area 201 of the interactive whiteboard 2), the rendering data scaling unit 61 reduces the size of the entire rendering data to make the entire rendering data fit in the display area 201 of the interactive whiteboard 2, which has requested to display the rendering data in one screen.

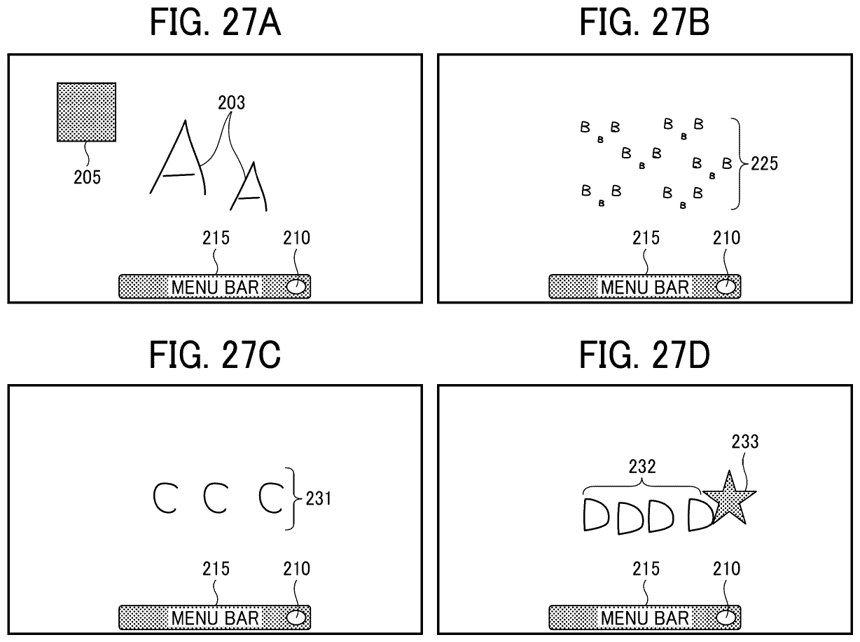

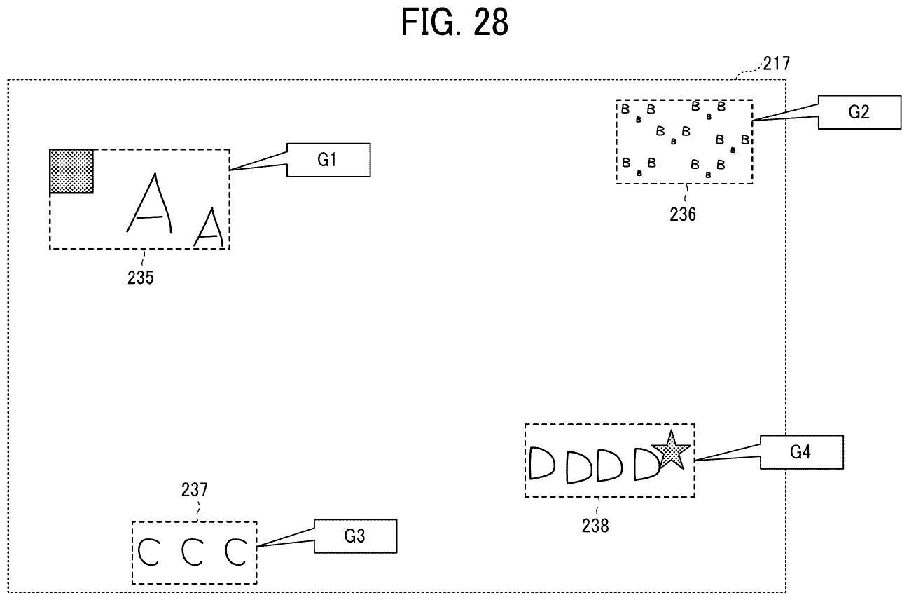

FIG. 25A is a diagram illustrating an exemplary relationship between the display area 201 and the rendering data before being reduced in size. FIG. 25B is a diagram illustrating an exemplary relationship between the display area 201 and the rendering data after being reduced in size. As illustrated in FIG. 25A, the rendering data of the site ST1 and the moved rendering data of the site ST2 are specified with a circumscribed rectangle 228. In FIG. 25A, which illustrates the rendering data before being reduced in size, the size of the entire groups G1 and G2 is greater than the size of the display area 201 of the interactive whiteboard 2. It is assumed here that the size of the entire groups G1 and G2 is 2500×800, and that the size of the display area 201 of the interactive whiteboard 2 at the site ST1 is 1920×1080. In this case, a reduction ratio x′ for reducing the entire groups G1 and G2 to fit the entire groups G1 and G2 in the display area 201 of the interactive whiteboard 2 is calculated with an equation x′=Min (1920/2500, 1080/800)≈Min (0.768, 1.35)=0.768. That is, the width ratio between the display area 201 and the entire groups G1 and G2 and the height ratio between the display area 201 and the entire groups G1 and G2 are calculated, and the smaller one of the width ratio and the height ratio is used as the reduction ratio x′. Therefore, the rendering data scaling unit 61 of the meeting server 1 scales the size of the entire groups G1 and G2 by a factor of 0.768 while maintaining the aspect ratio of the entire groups G1 and G2.

In FIG. 25B, which illustrates the rendering data of the groups G1 and G2 after the adjustment (i.e., reduction in size), the entire rendering data of the groups G1 and G2 fits in the display area 201 of the interactive whiteboard 2. FIGS. 25A and 25B illustrate an example in which the rendering data is reduced in size. The rendering data may also be increased in size if the reduction ratio x′ obtained from the above equation is greater than 1. That is, the interactive whiteboard 2 may use the entire space of the display area 201 to display the rendering data of the groups G1 and G2.

The rendering data transmission unit 57 of the meeting server 1 transmits to the interactive whiteboard 2 the entire rendering data of the groups G1 and G2 increased or reduced in size. In the interactive whiteboard 2 at the site ST1, the rendering data receiving unit 42 receives the rendering data, and the display control unit 44 displays the rendering data.

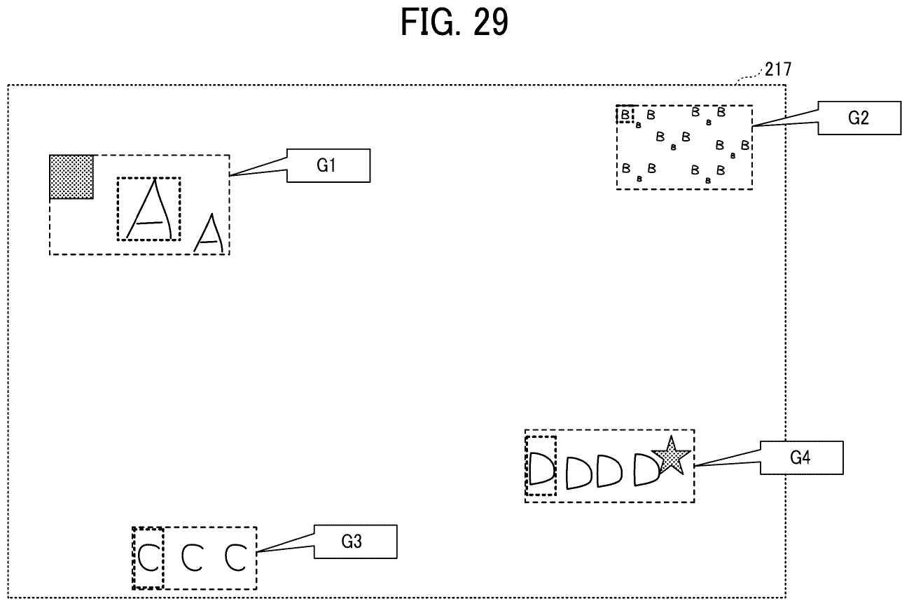

FIG. 26 is a sequence diagram illustrating a process in which the meeting server 1 moves the rendering data of the tablet PC 3 to display the rendering data in the display area 201 of the interactive whiteboard 2. The following description of FIG. 26 will focus on differences from FIG. 12.

The sequence diagram of FIG. 26 additionally includes steps S42 and S43.

At step S42, the rendering data moving unit 56 compares the reduction ratio in the case of simply moving the rendering data of the tablet PC 3 toward the rendering data of the interactive whiteboard 2 with the reduction ratio in the case of moving the rendering data of the tablet PC 3 to be horizontally level with the rendering data of the interactive whiteboard 2. The rendering data moving unit 56 then selects a rendering data moving method for obtaining the smaller one of the reduction ratios. For example, the rendering data moving unit 56 fixes the position of the group G1 of the rendering data of the interactive whiteboard 2, and moves the group G2 of the rendering data of the tablet PC 3 to the right of the group G1. As described above, the rendering data moving unit 56 calculates the distances to move the group G2 so as to make the upper-right corner of the group G1 substantially match the upper-left corner of the group G2, and moves the group G2 horizontally and vertically.

At step S43, the rendering data scaling unit 61 calculates the reduction ratio x′ for fitting the entire rendering data of the groups G1 and G2 in the display area 201 of the interactive whiteboard 2, and reduces the size of the entire rendering data with the reduction ratio x′ while maintaining the aspect ratio of the entire rendering data. Instead of reducing the size of the entire rendering data, the rendering data scaling unit 61 may reduce or increase the rendering data size for each of the rendering data groups of the respective sites, as in the first embodiment.

According to the third embodiment, the rendering data is moved in groups and reduced in size with the minimum reduction ratio to fit in the display area of a particular apparatus, increasing the possibility of the rendering data of all sites being displayed in one screen. Consequently, the user does not have to scroll the screen to check the rendering data of all apparatuses, which leads to a reduction in meeting time.

A fourth embodiment will be described.

At each of the sites, a user may scroll the display area to input handwriting in an open space. When a user at one of the sites displays the entire rendering data in one screen, the meeting server 1 adjusts the positions and sizes of the rendering data groups of the respective sites to display the rendering data groups in a balanced manner. In the fourth embodiment described below, the meeting server 1 adjusts the positions and sizes of rendering data groups of four sites to prevent the rendering data groups from overlapping with each other.

Functional blocks of the meeting server 1 of the fourth embodiment are similar to those of the second embodiment illustrated in FIG. 13, and functional blocks of the interactive whiteboard 2 and the tablet PC 3 of the fourth embodiment are similar to those of the first embodiment illustrated in FIG. 5.

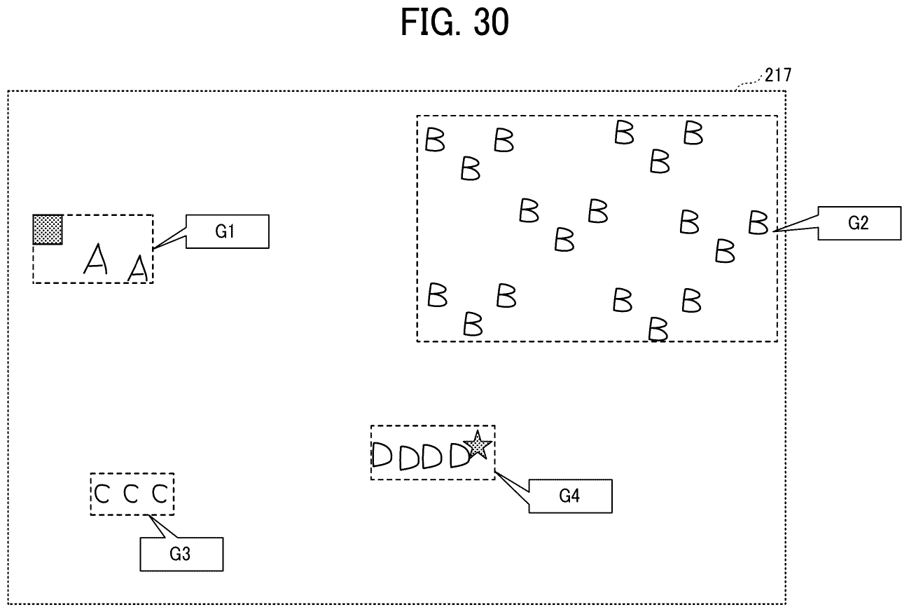

An overview of a process procedure of the fourth embodiment will be described with FIG. 27A to FIG. 34.

The rendering data receiving unit 53 of the meeting server 1 receives the rendering data from N apparatuses. In the illustrated example, N is 4, which is illustrative, not limiting. The rendering data grouping unit 54 groups the rendering data received from the four apparatuses and written in the renderable area 217 to create groups corresponding to the respective apparatuses. The handwritten character detection unit 60 detects characters from the rendering data of the groups. The rendering data scaling unit 61 of the fourth embodiment calculates a first mean, which is the mean of the sizes of the characters in each of the groups. Further, based on the first mean, the rendering data scaling unit 61 calculates a second mean, which is the mean of the sizes of the characters between the groups. Then, the rendering data scaling unit 61 increases or reduces the size of the rendering data of each of the groups with the ratio of the second mean to the first mean. When a request to display the rendering data in one screen is received from the interactive whiteboard 2 as one of the four apparatuses, the rendering data moving unit 56 divides the display area 201 of the interactive whiteboard 2 into four equal areas. The rendering data moving unit 56 then arranges the rendering data of each of the groups increased or reduced in size in one of the four equal areas.

FIGS. 27A, 27B, 27C, and 27D illustrate the rendering data displayed by the apparatuses at four sites ST1, ST2, ST3, and ST4. It is assumed here that the apparatus used at each of the sites ST1, ST3, and ST4 is the interactive whiteboard 2, and that the apparatus used at the site ST2 is the tablet PC 3. FIG. 27A illustrates the handwriting data items 203 and the square 205 rendered at the site ST1, and FIG. 27B illustrates the handwriting data items 225 rendered at the site ST2. Further, FIG. 27C illustrates handwriting data items 231 rendered at the site ST3, and FIG. 27D illustrates handwriting data items 232 and a star 233 rendered at the site ST4.

For example, the user at the site ST1 presses the display all button 210 to view the entire rendering data of the respective sites. The interactive whiteboard 2 detects the pressing of the display all button 210, and transmits a display all command to the meeting server 1. The meeting server 1 receives the display all command, and the rendering data grouping unit 54 of the meeting server 1 groups the rendering data of the sites into groups.

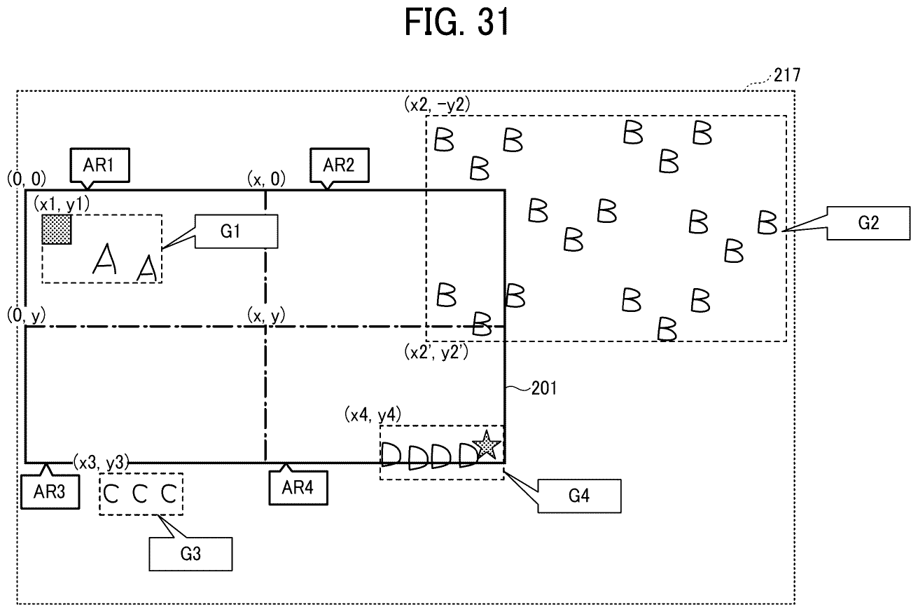

FIG. 28 illustrates the rendering data of the four sites ST1 to ST4 grouped with circumscribed rectangles 235, 236, 237, and 238 in the renderable area 217. Herein, the rendering data of the site ST1, the rendering data of the site ST2, the rendering data of the site ST3, and the rendering data of the site ST4 are represented as groups G1, G2, G3 and G4, respectively. The handwritten character detection unit 60 of the meeting server 1 clips characters from the groups G1 to G4. A method used here to clip the characters may be similar to the method used in the second embodiment.

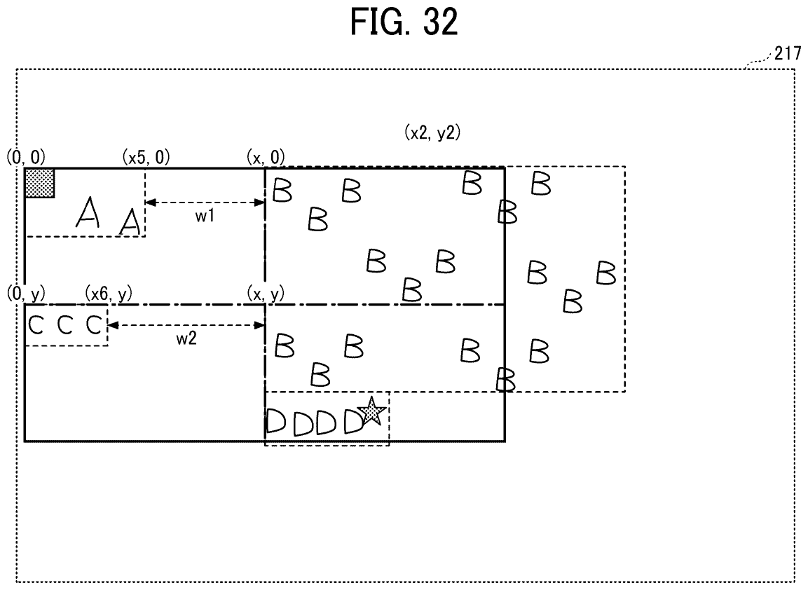

FIG. 29 schematically illustrates the characters clipped from the groups G1 to G4. Herein, characters “A,” “B,” “C,” and “D” are detected from the groups G1 to G4, respectively. The handwritten character detection unit 60 calculates the mean character size for each of the groups G1 to G4. Herein, the character size is represented by the point count corresponding to the size of the clipped character. Alternatively, the character size may be expressed in millimeters.

As illustrated in FIG. 29, the rendering data scaling unit 61 calculates, for each of the groups G1 to G4, the mean of the sizes of the characters clipped from the rendering data of the site ST1, ST2, ST3, or ST4 (an example of the first mean). Specifically, the rendering data scaling unit 61 clips two characters from the rendering data of the site ST1, and calculates the mean of the point counts corresponding to the sizes of the characters. The mean of the sizes of the characters in the rendering data of the site ST1 is represented as a1. The rendering data scaling unit 61 further clips eighteen characters from the rendering data of the site ST2, and calculates the mean of the point counts corresponding to the sizes of the characters. The mean of the sizes of the characters in the rendering data of the site ST2 is represented as a2. Similarly, the rendering data scaling unit 61 clips three characters from the rendering data of the site ST3, and calculates the mean of the point counts corresponding to the sizes of the characters. The mean of the sizes of the characters in the rendering data of the site ST3 is represented as a3. Further, the rendering data scaling unit 61 clips four characters from the rendering data of the site ST4, and calculates the mean of the point counts corresponding to the sizes of the characters. The mean of the sizes of the characters in the rendering data of the site ST4 is represented as a4. A mean W of the means a1 to a4 of the sizes of the characters in the rendering data of the sites ST1 to ST4 (an example of the second mean) is expressed as W=(a1+a2+a3+a4)/4.

The rendering data scaling unit 61 of the meeting server 1 increases or reduces the size of the rendering data of each of the sites ST1 to ST4 with the mean W. Since the mean a1 of the character sizes of the site ST1 is greater than the mean W, the rendering data scaling unit 61 reduces the size of all rendering data of the site ST1 including a graphic with W/a1 (i.e., reduces the size of the rendering data as one group). The mean a2 of the character sizes of the site ST2, on the other hand, is less than the mean W. Therefore, the rendering data scaling unit 61 increases the size of all rendering data of the site ST2 with W/a2 (i.e., increases the size of the rendering data as one group). The mean a3 of the character sizes of the site ST3 is greater than the mean W. The rendering data scaling unit 61 therefore reduces the size of all rendering data of the site ST3 with W/a3 (i.e., reduces the size of the rendering data as one group). Similarly, the mean a4 of the character sizes of the site ST4 is greater than the mean W. Therefore, the rendering data scaling unit 61 reduces the size of all rendering data of the site ST4 including a graphic with W/a4 (i.e., reduces the size of the rendering data as one group).

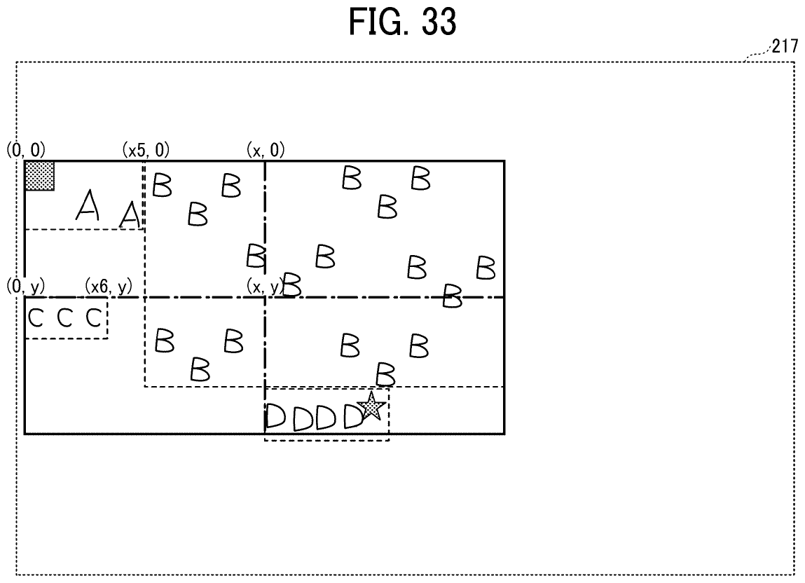

FIG. 30 illustrates the rendering data after the increase and reduction in size. It is observed here that the rendering data of the sites ST1, ST3, and ST4 is reduced in size, and that the rendering data of the site ST2 is increased in size.

Then, in the renderable area 217, the rendering data moving unit 56 of the meeting server 1 divides the display area 201 of the interactive whiteboard 2 at the site ST1 into four equal areas corresponding to the four sites ST1 to ST4. That is, the rendering data moving unit 56 divides the display area 201 into the same number of areas as the sites ST1 to ST4.

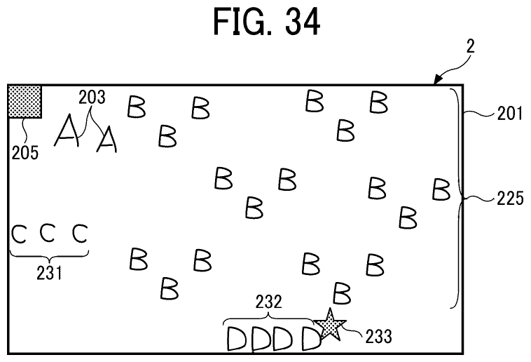

FIG. 31 illustrates the renderable area 217 with the display area 201 of the interactive whiteboard 2 at the site ST1 divided into four equal areas AR1, AR2, AR3, and AR4. As an overview of the process of the rendering data moving unit 56, the rendering data moving unit 56 arranges the enlarged or reduced rendering data of each of the groups G1 to G4 in one of the four areas AR1 to AR4 such that the upper-left corner of the group matches the upper-left corner of the area. Then, if first rendering data of one area of the areas AR1 to AR4 allocated to one of the groups G1 to G4 extends outside the one area into another area of the areas AR1 to AR4, the rendering data moving unit 56 moves second rendering data of the another area in the extending direction of the first rendering data by the distance of extension of the first rendering data.

The correspondence between the areas AR1 to AR4 and the sites ST1 to ST4 may be previously determined. Preferably, the relative positions of rendering data items of handwriting are maintained. Therefore, the rendering data moving unit 56 calculates, for each of the sites ST1 to ST4, the distances from the centroid of the rendering data of the site to the respective centers of the areas AR1 to AR4, and associates the rendering data of the site with the area AR1, AR2, AR3, or AR4 corresponding to the shortest one of the distances. For example, it is assumed in FIG. 31 that the sites ST1, ST2, ST3, and ST4 correspond to the areas AR1, AR2, AR3, and AR4, respectively.

The process of the rendering data moving unit 56 will be described in detail below.

The rendering data moving unit 56 determines whether the rendering data of each of the sites ST1 to ST4 fits in the corresponding one of the areas AR1 to AR4.

The rendering data moving unit 56 moves the rendering data with reference to the origin. If the enlarged or reduced rendering data of a group fits in the corresponding divided area, the rendering data moving unit 56 moves the rendering data of the group such that the upper-left corner of the group matches the upper-left corner of the divided area. If the enlarged or reduced rendering data of the group does not fit in the divided area and extends into another divided area, the rendering data moving unit 56 moves the rendering data of the another divided area in the extending direction of the rendering data by the distance of extension of the rendering data. In FIG. 31, the rendering data of the group G1, the rendering data of the group G3, and the rendering data of the group G4 fit in the areas AR1, AR3, and AR4, respectively, whereas the rendering data of the group G2 does not fit in the area AR2.

Based on the difference between the coordinates of the upper-left corner of each of the areas AR1 to AR4 and the coordinates of the upper-left corner of the corresponding one of the groups G1 to G4, the rendering data moving unit 56 calculates the distance to move the group in the x-axis direction and the distance to move the group in the y-axis direction, and sequentially moves the groups G1 to G4. For example, the rendering data moving unit 56 moves the groups G1, G2, G3, and G4 to the upper-left area AR1, the upper-right area AR2, the lower-left area AR3, and the lower-right area AR4, respectively, in this order. The following moving distances are expressed in absolute value. The group G1 is moved leftward along the x-axis by a distance (0−x), and is moved upward along the y-axis by a distance (0−y1). The group G2 is moved leftward along the x-axis by a distance (x−x2), and is moved downward along the y-axis by a distance (0−y2), consequently extending downward outside the area AR2. The group G3 is moved leftward along the x-axis by a distance (0−x3), and is moved upward along the y-axis by a distance (y−y3). With the group G2 extending into the area AR4, the group G4 is moved to be below the group G2. Consequently, the group G4 is moved leftward along the x-axis by a distance (x−x4), and is moved upward along the y-axis by a distance (y4−(y2+y2′)).

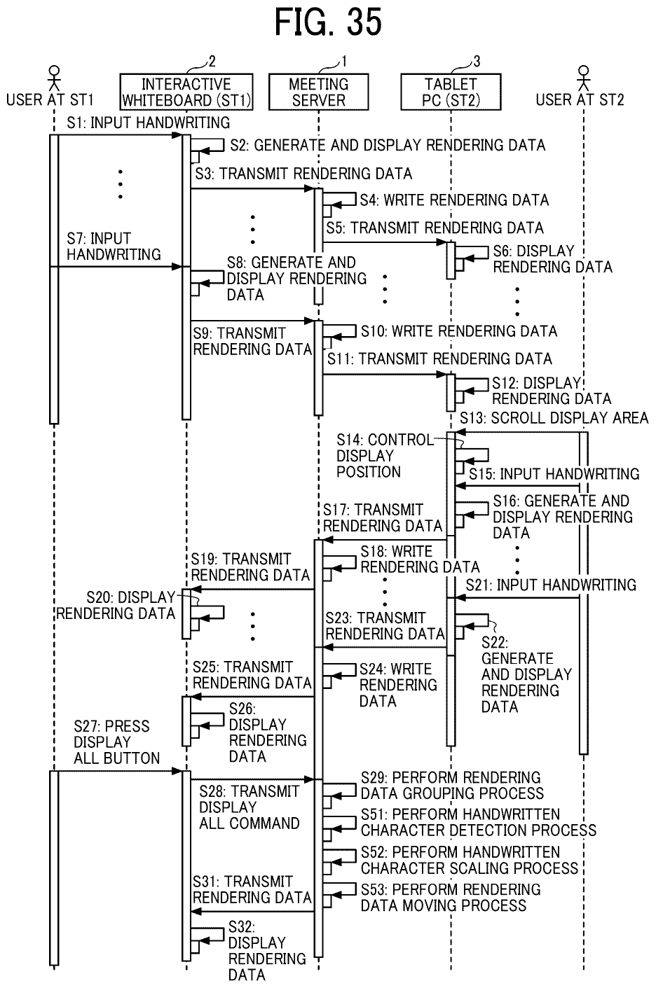

FIG. 32 illustrates the moved rendering data of the groups G1 to G4. The groups G1 and G3, which fit in the areas AR1 and AR3, respectively, are moved such that the upper-left corners of the groups G1 and G3 match the upper-left corners of the areas AR1 and AR3. The group G2, on the other hand, does not fit in the area AR2. Therefore, the group G4 in the area AR4 into which the group G2 extends is moved by the distance of extension of the group G2.

The rendering data moving unit 56 further moves the rendering data horizontally as follows. The groups G1 to G4 are moved vertically to make the upper-left corners thereof match as much as possible the upper-left corners of the areas AR1 to AR4 or to fill the gaps between the groups G1 to G4, as described above. However, the rendering data of the group G2 extends rightward outside the display area 201 of the interactive whiteboard 2. In this case, there is an open space to the right of the groups G1 and G3. The rendering data moving unit 56 therefore determines whether there is an open space between the group G2 and the left groups G1 and G3. As illustrated in FIG. 32, there is an open space with a width w1=x−x5 between the groups G2 and G1. There is also an open space with a width w2=x−x6 between the groups G3 and G4.

Since the open space with the width w1 is smaller than the open space with the width w2, the rendering data moving unit 56 moves the group G2 toward the negative (i.e., left) side of the x-axis by the width w1 to place the group G2 adjacent to the group G1.

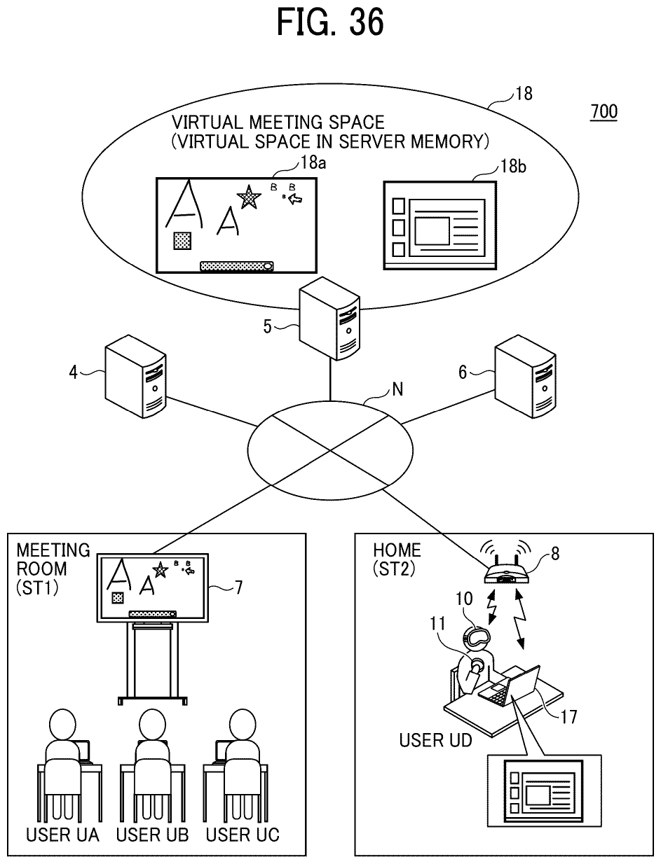

FIG. 33 illustrates the renderable area 217 with the group G2 moved leftward by the width w1 to be adjacent to the group G1. As illustrated in FIG. 33, in the display area 201 of the interactive whiteboard 2 that has requested to display the rendering data in one screen, if one of the groups G1 to G4 allocated to a right area of the four divided areas AR1 to AR4 of the display area 201 does not horizontally fit in the display area 201, and if there is an open space between the group of the right area and the groups of the left areas of the areas AR1 to AR4, the rendering data moving unit 56 moves the group of the right area leftward.

Herein, the rendering data of the group G4 fits in (i.e., does not extend outside) the display area 201 of the interactive whiteboard 2 in the x-axis direction. Therefore, the rendering data moving unit 56 does not move the rendering data of the group G4 in the x-axis direction.

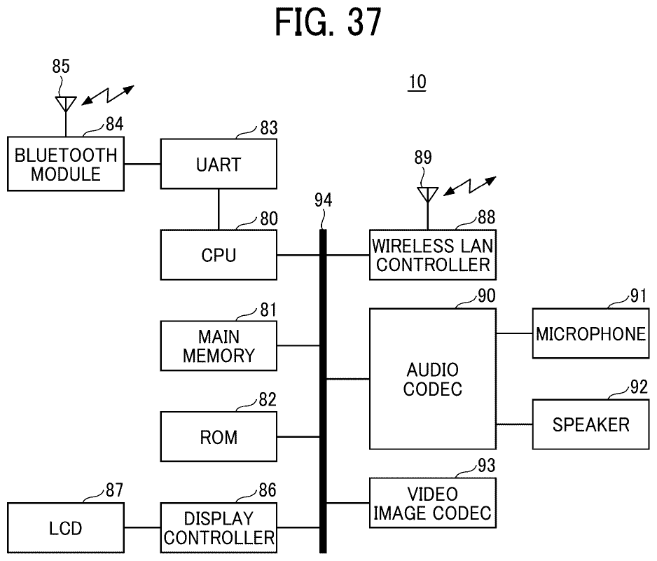

FIG. 34 illustrates the entire rendering data displayed in one screen by the interactive whiteboard 2. It is observed here that the entire rendering data fits in the display area 201 of the interactive whiteboard 2.

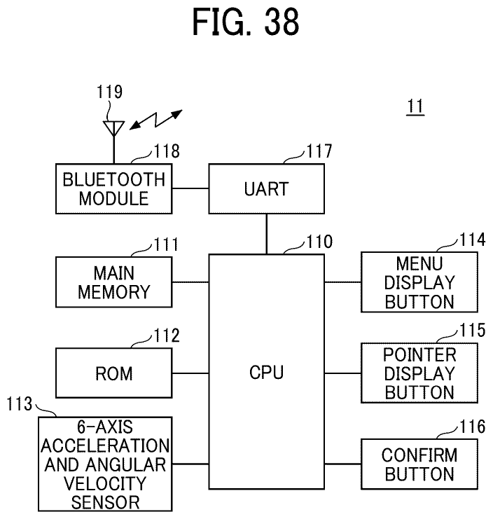

FIG. 35 is a sequence diagram illustrating a process in which the meeting server 1 displays the rendering data of the four sites ST1 to ST4 in one screen. The following description of FIG. 35 will focus on differences from FIG. 12.

The sequence diagram of FIG. 35 additionally includes steps S51, S52, and S53.

At step S51, the handwritten character detection unit 60 of the meeting server 1 clips the characters from the groups G1 to G4 in the renderable area 217. The handwritten character detection unit 60 further calculates the mean character size for each of the groups G1 to G4.

At step S52, the rendering data scaling unit 61 of the meeting server 1 calculates the mean W of the means a1 to a4 of the character sizes of the rendering data of the sites ST1 to ST4. With the mean W, the rendering data scaling unit 61 then increases or reduces the size of the rendering data for each of the sites ST1 to ST4.

At step S53, the rendering data scaling unit 61 divides the display area 201 of the interactive whiteboard 2, the display all button 210 of which has been pressed, into the four equal areas AR1 to AR4. The rendering data moving unit 56 of the meeting server 1 moves the groups G1 to G4 such that the upper-left corners of the groups G1 to G4 match the upper-left corners of the areas AR1 to AR4. In the movement process, if the rendering data extends outside one area of the areas AR1 to AR4 into another area of the areas AR1 to AR4, the rendering data of the another area is moved by the distance of extension of the rendering data of the one area. Further, if a right group of the groups G1 to G4 extends outside the display area 201 in the x-axis direction (i.e., horizontal direction), and if there is an open space in the x-axis direction between the right group and each of the left groups of the groups G1 to G4, the rendering data moving unit 56 moves the right group leftward to fill the smaller one of the open space between the right group and one of the left groups and the open space between the right group and the other left group.

According to the fourth embodiment, if there are four sites, the sizes of the characters are reduced or increased and the groups are moved into the four divided areas of the display area, to thereby display all rendering data of the sites in one screen. The number of sites is not limited to four.

A fifth embodiment will be described.

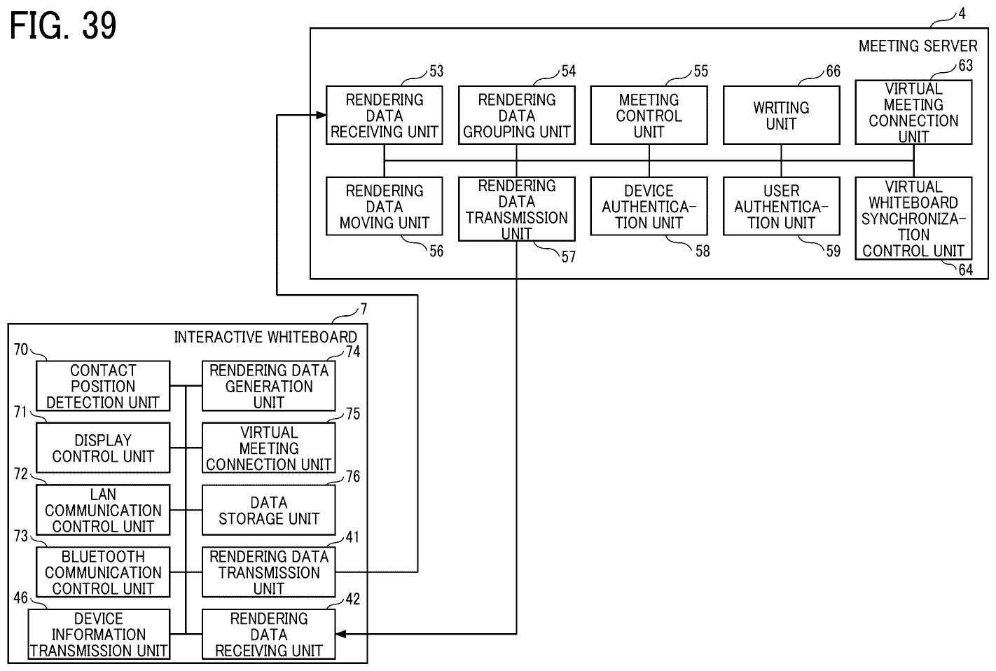

In the fifth embodiment described below, a user UD at the site ST2 (e.g., home) participates in a virtual meeting with VR goggles 10 and a VR operation controller 11, and users UA, UB, and UC at the site ST1 (e.g., a meeting room) participate in the meeting with an interactive whiteboard 7 (see FIG. 36).

In the virtual meeting, the rendering data of the respective sites is displayable in one screen by a meeting server similarly as in the foregoing embodiments. Specifically, with a virtual meeting service executed on the meeting server, the rendering data displayed in a virtual space is transmitted to the interactive whiteboard 7, and the rendering data received from the interactive whiteboard 7 is displayed in the virtual space. The rendering data transmitted from the interactive whiteboard 7 is written in the renderable area 217 or on one of a plurality of pages in a memory of the meeting server. In response to a request from the interactive whiteboard 7 to display the rendering data in one screen, the rendering data moving unit 56 of the meeting server moves at least part of the rendering data of the renderable area 217 into the area corresponding to the display area, to thereby arrange the rendering data of the plurality of sites or pages in the area corresponding to the display area. The rendering data transmission unit 57 of the meeting server transmits to the interactive whiteboard 7 the rendering data of the sites arranged in the area corresponding to the display area by the rendering data moving unit 56, as described in detail below.

FIG. 36 is a diagram illustrating a system configuration of a virtual meeting system 700. The interactive whiteboard 7 is installed in a meeting room (i.e., the site ST1) in which the users UA, UB, and UC are, and the user UD wearing the VR goggles 10 is at home (i.e., the site ST2). A meeting server 4, a virtual meeting server 5, and a meeting reservation server 6 are connected to the communication network N such as the Internet.

The meeting server 4, which corresponds to the meeting server 1 described above in the first to fourth embodiments, is equipped with an additional function of cooperating with the virtual meeting server 5. The virtual meeting server 5 stores the data of a virtual meeting space 18 in a memory and executes a virtual meeting application. The virtual meeting application executed on the virtual meeting server 5 will be hereinafter referred to as the virtual meeting service. The virtual meeting space 18 is a 360-degree three-dimensional virtual space simulating a meeting room, for example.

The data of the virtual meeting space 18 is the screen data of the respective apparatuses. In the data of the virtual meeting space 18, the screen data of the interactive whiteboard 7 will be referred to as the virtual whiteboard 18a, and the screen data of a laptop PC 17 used by the user UD will be referred to as the virtual PC screen data 18b. The virtual whiteboard 18a synchronizes with the display data of the interactive whiteboard 7, and the virtual PC screen data 18b synchronizes with the screen data of the laptop PC 17.

The meeting reservation server 6 holds schedule information of a meeting held with the meeting server 4, the virtual meeting server 5, or the meeting server 4 and the virtual meeting server 5 cooperating with each other, such as the meeting date and time, the participants, and the meeting ID generated for the individual meeting.

The interactive whiteboard 7 is installed in the meeting room in which the users UA, UB, and UC are. The interactive whiteboard 7 connects to the communication network N to communicate with the meeting server 4, the virtual meeting server 5, and the meeting reservation server 6.

The user UD is at home (or in a satellite office, for example), where a wireless fidelity (Wi-Fi® hereinafter simply referred to as Wi-Fi) router 8 is installed. The user UD uses the laptop PC 17, the VR goggles 10, and the VR operation controller 11. The Wi-Fi router 8 in the home of the user UD is connectable to the communication network N. The laptop PC 17 and the VR goggles 10 used by the user UD are wirelessly communicable with the Wi-Fi router 8. The VR goggles 10 and the VR operation controller 11 are wirelessly communicable with each other in accordance with a standard such as Bluetooth. The laptop PC 17 and the VR goggles 10 are also connected to each other in accordance with a standard such as Bluetooth. The laptop PC 17 of the user UD is running the virtual meeting application to communicate with the virtual meeting server 5. The meeting may be participated by a plurality of users wearing the VR goggles 10.

The rendering data of handwriting input to the interactive whiteboard 7 at the site ST1 is transmitted to the meeting server 4. The meeting server 4 writes the rendering data in the renderable area 217 and transmits the rendering data to the virtual meeting server 5. The virtual meeting server 5 writes the rendering data on the virtual whiteboard 18a and transmits the image of the virtual meeting space 18 to the VR goggles 10. Thereby, the rendering data of the interactive whiteboard 7 is synchronized between the sites ST1 and ST2. Similarly, the rendering data of handwriting written on the virtual whiteboard 18a in the virtual meeting space 18 by the user UD at the site ST2 is transmitted to the virtual meeting server 5. The virtual meeting server 5 writes the rendering data on the virtual whiteboard 18a and transmits the rendering data to the interactive whiteboard 7. Thereby, the rendering data of the virtual whiteboard 18a is synchronized between the sites ST1 and ST2.

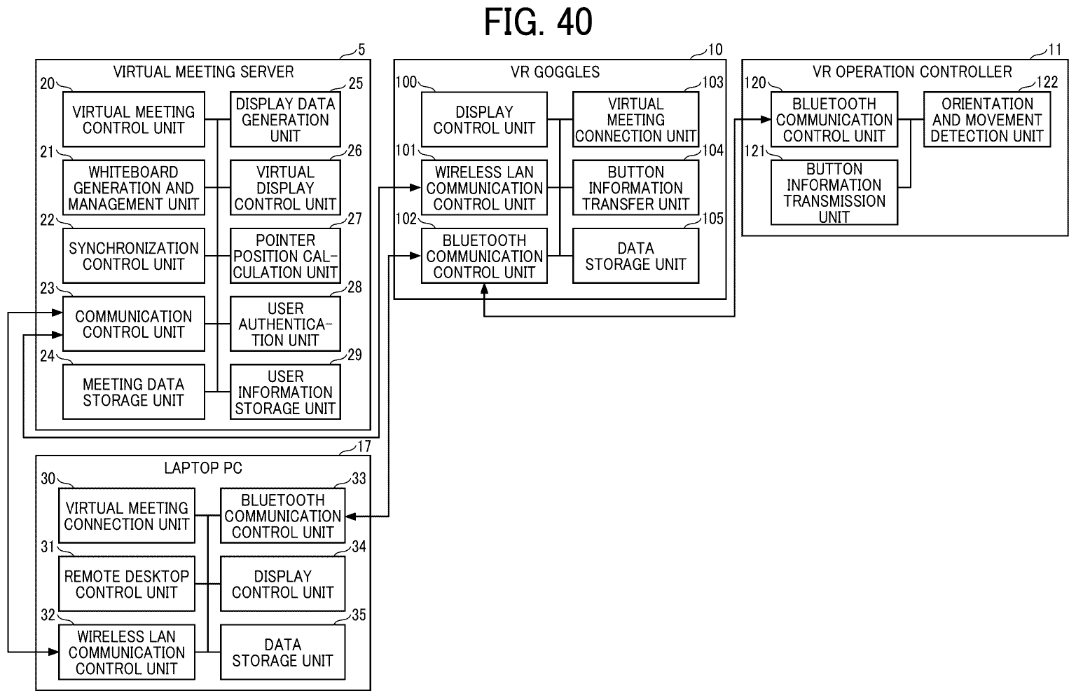

FIG. 37 is a diagram illustrating a hardware configuration of the VR goggles 10. The VR goggles 10 include a CPU 80, a main memory 81, a ROM 82, a display controller 86, a wireless LAN controller 88, an audio codec 90, and a video image codec 93, which are connect to each other via a bus 94.

The CPU 80 executes and processes an operating system (OS) and a control processing program read into the main memory 81 from the ROM 82. The main memory 81, which includes a dynamic random access memory (DRAM), is used as a work area of the CPU 80, for example.

The ROM 82 stores programs previously written thereon, such as an OS, a system program started at power-on, and a program for controlling the VR goggles 10.

The CPU 80 is connected to a universal asynchronous receiver transmitter (UART) 83. The UART 83 is an interface for transmitting and receiving serial data between the CPU 80 and a Bluetooth module 84. The UART 83 includes a first-in, first-out (FIFO) memory and a shift register, for example.

The Bluetooth module 84, which includes a radio frequency (RF) section and a baseband section, is connected to an antenna 85 to perform wireless communication conforming to the Bluetooth standard.

The display controller 86 performs digital-to-analog (D/A) conversion on data such as text data, graphics data, and image data, and controls a liquid crystal display (LCD) 87 to display the data.

The wireless LAN controller 88 executes a communication protocol conforming to the institute of electrical and electronics engineers (IEEE) 802.11ax standard to transmit and receive radio waves via an antenna 89 to control communication with another apparatus.

An audio signal input from a microphone 91 is converted into audio data by an analog-to-digital (A/D) converter circuit. The audio codec 90 encodes the audio data in accordance with the advanced audio coding (AAC) method. The audio codec 90 further decodes AAC-encoded data received from an external device. A speaker 92 outputs sound based on an audio signal converted from digital to analog by a D/A converter circuit. The video image codec 93 decodes compressed video image data (e.g., data conforming to international telecommunication union-telecommunication standardization sector (ITU-T) recommendation H.264) received from an external device. The above-described components of the VR goggles 10 transmit and receive data therebetween via the bus 94.

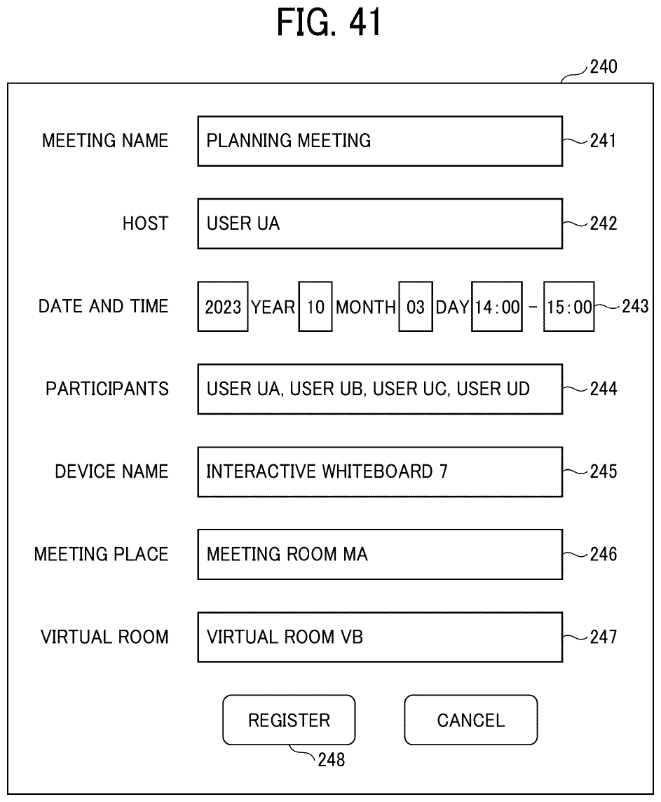

FIG. 38 is a diagram illustrating a hardware configuration of the VR operation controller 11. The VR operation controller 11 includes a UART 117, a main memory 111, a ROM 112, a 6-axis acceleration and angular velocity sensor 113, a menu display button 114, a pointer display button 115, and a confirm button 116, which are connected to a CPU 110.

The CPU 110 executes and processes a control processing program read into the main memory 111 from the ROM 112. The main memory 111, which includes a DRAM, is used as a work area of the CPU 110, for example.

The ROM 112 stores programs previously written thereon, such as a system program started at power-on and a program for transmitting button press information of the menu display button 114, the pointer display button 115, or the confirm button 116 in Bluetooth communication.

The 6-axis acceleration and angular velocity sensor 113 outputs acceleration and angular velocity measurement data. The UART 117 is an interface for transmitting and receiving serial data between the CPU 110 and a Bluetooth module 118. The UART 117 includes a FIFO memory and a shift register, for example. The Bluetooth module 118, which includes an RF section and a baseband section, is connected to an antenna 119 to perform wireless communication conforming to the Bluetooth standard.

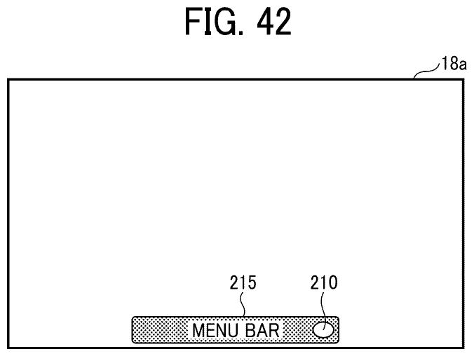

FIG. 39 is a functional block diagram illustrating functional blocks of the meeting server 4 and the interactive whiteboard 7. The following description of FIG. 39 will focus on differences from FIG. 5, which illustrates the first embodiment. The meeting server 4 of FIG. 39 additionally includes a virtual meeting connection unit 63 and a virtual whiteboard synchronization control unit 64.

The virtual meeting connection unit 63 connects to the virtual meeting service of the virtual meeting server 5 to establish a data transfer session between the meeting server 4 and the virtual meeting server 5. That is, if an apparatus registered for a meeting registered on the meeting reservation server 6 is authenticated, the virtual meeting connection unit 63 establishes a data transfer session between the apparatus and a virtual room joined by the user UD and managed by the virtual meeting server 5.

The virtual whiteboard synchronization control unit 64 synchronizes the rendering data of the interactive whiteboard 7 in the memory (i.e., the rendering data of the renderable area 217) with the rendering data of the virtual whiteboard 18a of the virtual meeting server 5. That is, the virtual whiteboard synchronization control unit 64 maintains the rendering data of the interactive whiteboard 7 and the rendering data of the virtual whiteboard 18a to represent the same rendering data.

The interactive whiteboard 7 includes a contact position detection unit 70, a display control unit 71, a LAN communication control unit 72, a Bluetooth communication control unit 73, the device information transmission unit 46, a rendering data generation unit 74, a virtual meeting connection unit 75, a data storage unit 76, the rendering data transmission unit 41, and the rendering data receiving unit 42. Each of these units of the interactive whiteboard 7 is a function or functioning means implemented when at least one of the components illustrated in FIG. 3 operates based on a command from the CPU 401 in accordance with a program deployed in the RAM 403 from the SSD 404 (i.e., the virtual meeting application). The functions of the rendering data transmission unit 41, the rendering data receiving unit 42, and the device information transmission unit 46 may be similar to those of the first embodiment.

The contact position detection unit 70 detects the coordinate data of a part of the display 480 touched by a finger (the hand H) or the electronic pen 490 and detected by the contact sensor 414 (i.e., a part of the display 480 where light is blocked).

The display control unit 71 displays, on the display 480, the data of the virtual whiteboard 18a received by the LAN communication control unit 72. Specifically, the display control unit 71 controls the display 480 to display the screen data of the interactive whiteboard 7.

The LAN communication control unit 72 is means for transmitting and receiving other data than the rendering data to and from the meeting server 4. Specifically, the LAN communication control unit 72 connects to the communication network N in accordance with a standard such as Ethernet to transmit and receive data to and from another apparatus via the communication network N. The LAN communication control unit 72 may also communicate with the virtual meeting server 5.

The Bluetooth communication control unit 73 performs communication conforming to the Bluetooth standard. The rendering data generation unit 74 generates the rendering data based on a sequence of coordinate points input from the contact position detection unit 70 when the user UA, UB, or UC inputs handwriting. The rendering data generation unit 74 further generates graphics such as circle and rectangle.

With a URL of the virtual meeting service and a meeting ID transmitted from the laptop PC 17, the virtual meeting connection unit 75 performs a control process to connect to the virtual meeting service executed on the virtual meeting server 5. In the fifth embodiment, the interactive whiteboard 7 connects to the virtual meeting server 5 via the meeting server 4, and thus the virtual meeting connection unit 75 is not used.

The data storage unit 76 stores data such as the address (e.g., URL) of the virtual meeting service provided by the virtual meeting server 5, the meeting ID, and the screen data displayed on the display 480. The device information transmission unit 46 transmits the device information to the meeting server 4.

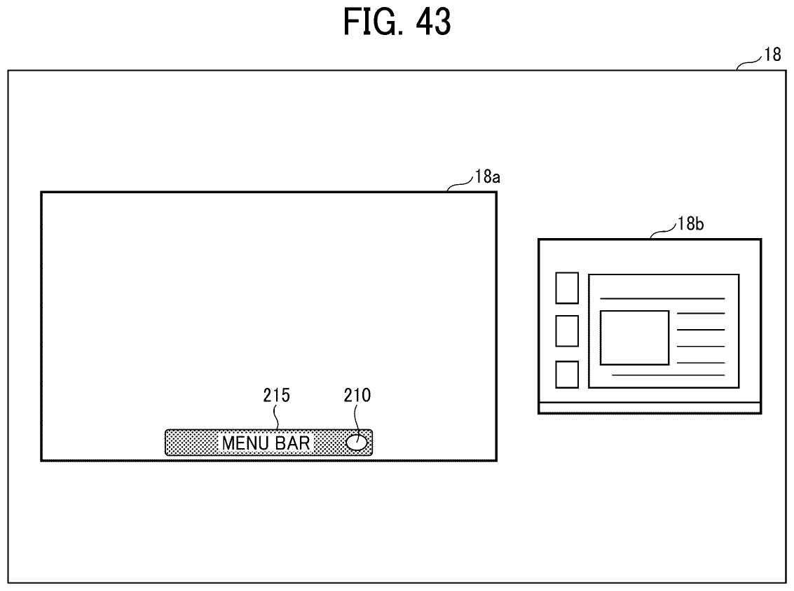

FIG. 40 is a functional block diagram illustrating exemplary functional blocks of the virtual meeting server 5, the laptop PC 17, the VR goggles 10, and the VR operation controller 11.

The virtual meeting server 5 includes a virtual meeting control unit 20, a whiteboard generation and management unit 21, a synchronization control unit 22, a communication control unit 23, a meeting data storage unit 24, a display data generation unit 25, a virtual display control unit 26, a pointer position calculation unit 27, a user authentication unit 28, and a user information storage unit 29. Each of these units of the virtual meeting server 5 is a function or functioning means implemented when at least one of the components illustrated in FIG. 4A operates based on a command from the CPU 501 in accordance with a program deployed in the RAM 503 from the HD 504.

The virtual meeting control unit 20 stores the information of the participants of the meeting and the apparatuses that connect to the meeting (e.g., the laptop PC 17, the VR goggles 10, and the meeting server 4) in the meeting data storage unit 24 in association with identification information of the meeting (i.e., the meeting ID). For each meeting ID, the virtual meeting control unit 20 executes a remote meeting between the apparatuses. The virtual meeting control unit 20 further stores the screen data of the virtual whiteboard 18a and the audio data received from the apparatuses connecting to the virtual meeting, for example, in the meeting data storage unit 24.

The whiteboard generation and management unit 21 generates and manages the virtual whiteboard 18a and the virtual PC screen data 18b in the virtual meeting space 18.

The synchronization control unit 22 is means for synchronizing the virtual whiteboard 18a with the screen data of the interactive whiteboard 7 in the memory of the meeting server 4 such that the virtual whiteboard 18a and the screen data of the interactive whiteboard 7 represent the same data. Specifically, the synchronization control unit 22 has a function of detecting the update in the virtual whiteboard 18a and the screen data of the interactive whiteboard 7 in the memory of the meeting server 4, a function of reflecting the updated screen data of the interactive whiteboard 7 in the memory of the meeting server 4 in the virtual whiteboard 18a, and a function of reflecting the updated virtual whiteboard 18a in the screen data of the interactive whiteboard 7 in the memory of the meeting server 4.

The communication control unit 23 transmits and receives data between the laptop PC 17, the VR goggles 10, and the meeting server 4.

The meeting data storage unit 24 stores data such as the virtual whiteboard 18a, the virtual PC screen data 18b, and the audio data received from the apparatuses connecting to the virtual meeting.

The display data generation unit 25 generates a menu to display in the virtual meeting space 18, and generates a pointer based on an instruction from the VR operation controller 11 to display the pointer, for example.

The virtual display control unit 26 is means for displaying, in the virtual meeting space 18, data such as the rendering data based on operation information transmitted from the VR goggles 10 and the screen data of the laptop PC 17. The virtual display control unit 26 displays various display data in the virtual meeting space 18. Specifically, the virtual display control unit 26 displays, in the virtual meeting space 18, the menu and the pointer generated by the display data generation unit 25 and the virtual whiteboard 18a and the virtual PC screen data 18b of the laptop PC 17 generated by the whiteboard generation and management unit 21, for example. The virtual display control unit 26 transmits the display data of the virtual meeting space 18 to the VR goggles 10 via the communication control unit 23, and the VR goggles 10 display the virtual meeting space 18.

The pointer position calculation unit 27 calculates the position of the pointer in the virtual meeting space 18, which is indicated by the orientation and movement of the VR operation controller 11.

The user authentication unit 28 performs an authentication process on each user participating in the virtual meeting by comparing a user name and a password received via the communication control unit 23 with a user name and a password stored in the user information storage unit 29.

The user information storage unit 29 stores the user name and the password of the user participating in the virtual meeting.

The laptop PC 17 includes a virtual meeting connection unit 30, a remote desktop control unit 31, a wireless LAN communication control unit 32, a Bluetooth communication control unit 33, a display control unit 34, and a data storage unit 35. Each of these units of the laptop PC 17 is a function or functioning means implemented when at least one of the components illustrated in FIG. 4B operates based on a command from the CPU 521 in accordance with a program deployed in the RAM 523 from the HD 524 (i.e., the virtual meeting application).

The virtual meeting connection unit 30 connects to the virtual meeting service of the virtual meeting server 5 to transmit the user name and the password to the virtual meeting service as authentication data. The virtual meeting connection unit 30 further manages the meeting ID and the URL of the virtual meeting space 18 received from the virtual meeting service, and connects to the URL of the virtual meeting space 18 to perform a process of participating in the virtual meeting. Further, the virtual meeting connection unit 30 transmits the meeting ID and the URL of the virtual meeting space 18 to the VR goggles 10 via the Bluetooth communication control unit 33.

The remote desktop control unit 31 transmits the screen data of the laptop PC 17 to the virtual meeting service to display the screen data of the laptop PC 17 in the virtual meeting space 18.

The wireless LAN communication control unit 32 communicates with the virtual meeting server 5 via the Wi-Fi router 8.

The Bluetooth communication control unit 33 communicates with the VR goggles 10 in accordance with the Bluetooth standard. The display control unit 34 controls the display 526 (e.g., an LCD) to display the screen data.

The data storage unit 35 stores data such as the address (e.g., URL) of the virtual meeting service provided by the virtual meeting server 5, the URL of the virtual meeting space 18 and the meeting ID received from the virtual meeting service, and the user name and the password of the user of the laptop PC 17.

The VR goggles 10 include a display control unit 100, a wireless LAN communication control unit 101, a Bluetooth communication control unit 102, a virtual meeting connection unit 103, a button information transfer unit 104, and a data storage unit 105. Each of these units of the VR goggles 10 is a function or functioning means implemented when at least one of the components illustrated in FIG. 37 operates based on a command from the CPU 80 in accordance with a program deployed in the main memory 81 from the ROM 82 (i.e., the virtual meeting application).

The display control unit 100 controls the LCD 87 to display the display data of the virtual whiteboard 18a transmitted from the virtual meeting service. The wireless LAN communication control unit 101 communicates with the virtual meeting server 5 via the Wi-Fi router 8.

The Bluetooth communication control unit 102 communicates with the VR operation controller 11 in accordance with the Bluetooth standard. With the URL of the virtual meeting service and the meeting ID transmitted from the laptop PC 17, the virtual meeting connection unit 103 performs a control process to connect to the virtual meeting service executed on the virtual meeting server 5.

The button information transfer unit 104 receives the button press information related to the pressed button from the VR operation controller 11, and transmits the button press information to the virtual meeting server 5 via the wireless LAN communication control unit 101.

The data storage unit 105 stores data such as the meeting ID and the address (e.g., URL) of the virtual meeting service provided by the virtual meeting server 5 and the user name and the password of the user of the VR goggles 10.

The VR operation controller 11 includes a Bluetooth communication control unit 120, a button information transmission unit 121, and an orientation and movement detection unit 122. Each of these units of the VR operation controller 11 is a function or functioning means implemented when at least one of the components illustrated in FIG. 38 operates based on a command from the CPU 110 in accordance with a program deployed in the main memory 111 from the ROM 112.

The Bluetooth communication control unit 120 communicates with the VR goggles 10 in accordance with the Bluetooth standard. The button information transmission unit 121 transmits the button press information of the menu display button 114, the pointer display button 115, or the confirm button 116 to the Bluetooth communication control unit 120.

The orientation and movement detection unit 122 detects the orientation and movement of the VR operation controller 11 (i.e., the attitude of the VR operation controller 11 in a three-dimensional space) based on acceleration and angular velocity data obtained from the 6-axis acceleration and angular velocity sensor 113, and transmits the information of the detected orientation and movement to the Bluetooth communication control unit 120.

A meeting reservation process will be described.

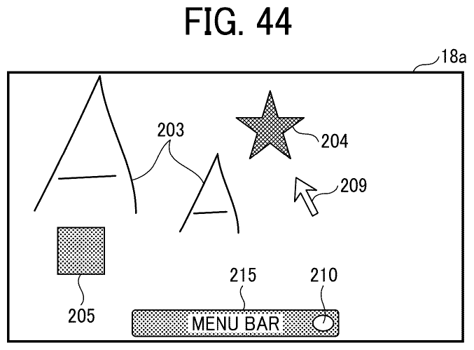

FIG. 41 illustrates a meeting reservation screen 240 displayed by a given terminal apparatus (e.g., a PC or smartphone). The host of a meeting accesses the meeting reservation server 6 from a world wide web (Web) browser on the terminal apparatus. The host then makes a reservation for a meeting using the meeting server 4 and the virtual meeting server 5 cooperating with each other, and registers information related to the meeting.

The meeting reservation screen 240 includes a meeting name field 241, a host name field 242, a date and time field 243, a participants field 244, a device name field 245, a meeting place field 246, and a virtual room field 247. The host inputs appropriate information in the meeting name field 241, the host name field 242, the date and time field 243, and the participants field 244. The device name field 245 is a field in which a device or apparatus to participate in the meeting, such as an interactive whiteboard, is set. At least one of the meeting place field 246 or the virtual room field 247 is to be filled. If the host inputs a meeting room name in the meeting place field 246 but does not input a room name in the virtual room field 247, a meeting not using the virtual meeting server 5 takes place. If the host inputs a room name in the virtual room field 247 but does not input a meeting room name in the meeting place field 246, a meeting not using the meeting server 4 takes place.

If the host inputs and registers a meeting room name (e.g., meeting room MA) and a room name (e.g., virtual room VB) in the meeting place field 246 and the virtual room field 247, respectively, as illustrated in FIG. 41, a participant in the meeting room MA and a participant in the virtual room VB are allowed to participate in the same meeting. A user registered as a participant may participate in the meeting from the meeting room MA or the virtual room VB. Herein, the virtual room refers to a three-dimensional space for the meeting.

The user may also participate in the meeting with an apparatus such as the interactive whiteboard 7. In this case, by using the interactive whiteboard 7, the user is able to skip the user authentication by the meeting server 4, which takes place when using a terminal apparatus such as a PC.

If a register button 248 in the meeting reservation screen 240 is pressed, the meeting reservation server 6 generates a meeting ID and transmits the meeting ID and meeting information (i.e., the content of the meeting reservation screen 240) to the meeting server 4 and the virtual meeting server 5. The meeting server 4 and the virtual meeting server 5 receive and store the meeting information in respective non-volatile memories.

The meeting reservation server 6 further transmits, by email, a URL for participating in the meeting and the URL of the virtual meeting space 18 to respective email addresses of the participants, in addition to the meeting ID and the meeting information. The URL for participating in the meeting is managed by the meeting server 4, and the URL of the virtual meeting space 18 is managed by the virtual meeting server 5. The above-described information may be registered in respective scheduling applications used by the participants.

The meeting server 4 checks the meeting information stored in the non-volatile memory periodically (e.g., every day at 6 a.m.), and schedules a meeting planned for the day. In the example of FIG. 41, the meeting server 4 refers to the meeting information of FIG. 41 at 14:00 on Oct. 3, 2023 and checks that the virtual room VB, which is an example of the virtual meeting space 18 of the virtual meeting server 5, is registered.

Then, the virtual meeting connection unit 63 of the meeting server 4 connects to the virtual room VB provided by the virtual meeting service of the virtual meeting server 5, and establishes a data transfer session between the meeting server 4 and the virtual room VB. Then, the virtual whiteboard synchronization control unit 64 of the meeting server 4 transmits the rendering data of a whiteboard area (i.e., the renderable area 217) in the memory to the virtual room VB.

The virtual meeting service of the virtual meeting server 5 places the received rendering data of the whiteboard area at a given position in the virtual room VB (i.e., a given position in a three-dimensional space) as the rendering data of the virtual whiteboard 18a.

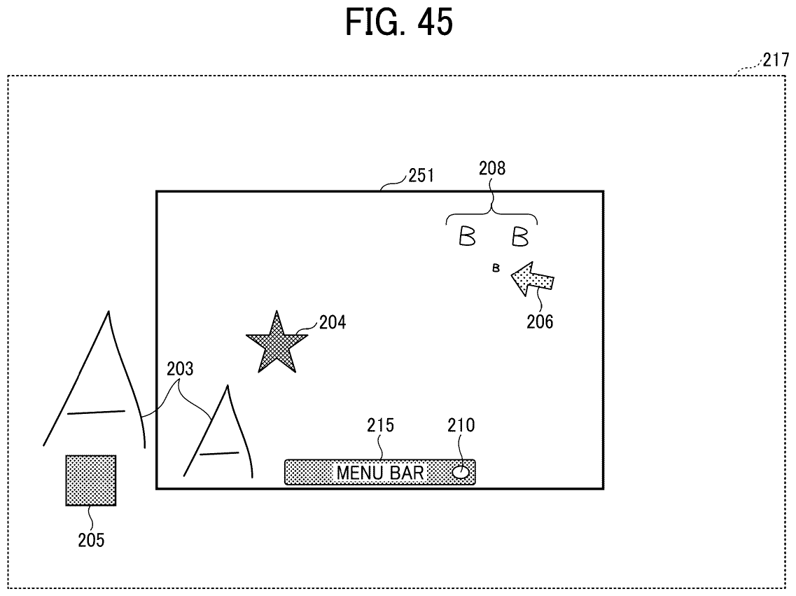

FIG. 42 illustrates the virtual whiteboard 18a in the virtual room VB provided by the virtual meeting service. Since there is no writing on the virtual whiteboard 18a immediately after the start of the meeting, the menu bar 215 alone is displayed on the virtual whiteboard 18a. The size of the virtual whiteboard 18a may be set to the size of one page, and another page may be added by a user. Alternatively, the virtual whiteboard 18a may correspond to the renderable area 217 with the possible maximum size that the memory allows.

A process for the users to participate in the meeting will be described.

The users UA, UB, and UC participate in the meeting from the meeting room MA with the interactive whiteboard 7. If one of the users UA, UB, and UC in the meeting room MA presses a join meeting button displayed on the interactive whiteboard 7, the interactive whiteboard 7 connects to the meeting server 4.

After authenticating the interactive whiteboard 7 successfully, the meeting server 4 refers to the meeting information received from the meeting reservation server 6, and determines whether a meeting in which the interactive whiteboard 7 is allowed to participate is registered in a certain time period from the current time. If a meeting in which the interactive whiteboard 7 is allowed to participate is registered in the time period, the meeting server 4 allows the interactive whiteboard 7 to participate in the meeting. Herein, allowing an apparatus to participate in a meeting means allowing the apparatus to share the rendering data with another apparatus at a different site.

The user UD participates in the meeting from home by wearing the VR goggles 10 (i.e., in a visual state in which the user UD feels as if being in the virtual room VB). The user UD starts the virtual meeting application on the laptop PC 17, and the virtual meeting connection unit 30 of the laptop PC 17 connects to the virtual meeting service of the virtual meeting server 5, and displays a screen for inputting the user name and the password. The URL of the virtual meeting service of the virtual meeting server 5 is previously registered in the laptop PC 17 as the setting data of the virtual meeting application. The user UD inputs the user name and the password on the screen, and the virtual meeting connection unit 30 transmits the data of the user name and the password to the virtual meeting service. The virtual meeting service authenticates the user UD and transmits a response to the laptop PC 17 to notify that the authentication has succeeded. The virtual meeting application running on the laptop PC 17 displays a join button for participating in the virtual meeting. If the user UD selects the join button, the virtual meeting service displays a screen for inputting the URL of the virtual meeting space 18 and the meeting ID. If the user UD inputs the URL of the virtual meeting space 18 and the meeting ID on the screen and presses an OK button, the virtual meeting connection unit 30 transmits a connect command including the meeting ID to the URL of the virtual meeting space 18.

The virtual meeting service of the virtual meeting server 5 compares the meeting ID received from the laptop PC 17 with the previously generated meeting ID. Then, if the two meeting IDs match, the virtual meeting service allows the laptop PC 17 to connect to the virtual meeting space 18.

Then, the virtual meeting application running on the laptop PC 17 transmits the URL of the virtual meeting space 18 and the meeting ID to the VR goggles 10 in Bluetooth communication. The VR goggles 10 receive the data of the URL of the virtual meeting space 18 and the meeting ID, and the virtual meeting connection unit 103 of the VR goggles 10 transmits a connect command including the meeting ID to the URL of the virtual meeting space 18. The virtual meeting service of the virtual meeting server 5 compares the meeting ID received from the VR goggles 10 with the previously generated meeting ID. Then, if the two meeting IDs match, the virtual meeting service allows the VR goggles 10 to connect to the virtual meeting space 18.

After the connection to the virtual meeting space 18 is established, the virtual meeting application running on the laptop PC 17 displays a select button for selecting remote desktop. If the user UD selects the select button, the remote desktop control unit 31 of the laptop PC 17 transmits the screen data of the laptop PC 17 to the virtual meeting service of the virtual meeting server 5 to display the screen data of the laptop PC 17 in the virtual meeting space 18. The virtual display control unit 26 of the virtual meeting server 5 controls the screen data of the laptop PC 17 displayed in the virtual meeting space 18 to be displayed on the VR goggles 10 of the user UD but not on any other apparatus.

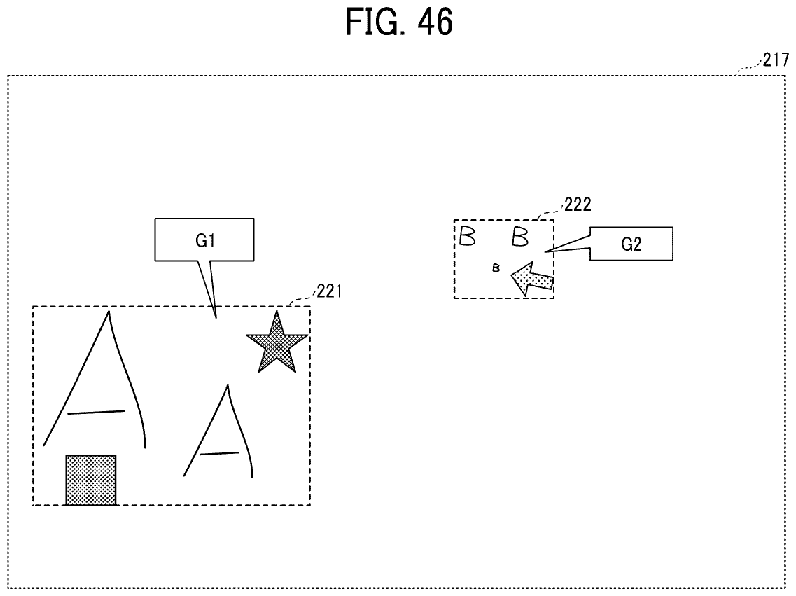

FIG. 43 illustrates a display example of the virtual meeting space 18 displayed on the VR goggles 10 of the user UD. As illustrated in FIG. 43, the virtual whiteboard 18a and the virtual PC screen data 18b are displayed in the virtual meeting space 18.

If the user UD holds the VR operation controller 11 with a grip or handle thereof facing up, the VR operation controller 11 transmits the data output from the 6-axis acceleration and angular velocity sensor 113 (i.e., orientation and movement information) to the virtual meeting server 5 via the VR goggles 10. Based on the output data, the virtual meeting service determines that the VR operation controller 11 is upside down. Then, the virtual display control unit 26 of the virtual meeting server 5 turns on handwriting mode of the virtual whiteboard 18a, and displays a pen icon at an upper-left corner of the virtual whiteboard 18a as the current position of the VR operation controller 11. If the user UD moves the VR operation controller 11 in a vertical plane to the ground in this state, the pen icon moves in the moving direction of the VR operation controller 11. If the user UD then moves the VR operation controller 11 in a horizontal plane to the ground by a particular distance in a distal direction away from the body of the user UD, the virtual display control unit 26 brings the VR operation controller 11 into a pen-down state. Then, if the user UD makes a handwriting motion by moving the VR operation controller 11 in a vertical plane to the ground, the virtual display control unit 26 displays the trajectory of the movement as handwriting data. If the user UD then moves the VR operation controller 11 in a horizontal plane to the ground by a particular distance in a proximal direction toward the body of the user UD, the virtual display control unit 26 brings the VR operation controller 11 into a pen-up state.

The user UD thus handwrites text on the virtual whiteboard 18a with the VR operation controller 11. The synchronization control unit 22 of the virtual meeting server 5 transmits the handwriting data to the meeting server 4, and the meeting server 4 writes the handwriting data in the renderable area 217 of the memory. The meeting server 4 further transmits the handwriting data (i.e., the rendering data) to the interactive whiteboard 7, and the interactive whiteboard 7 displays the rendering data on the display 480 of the interactive whiteboard 7.

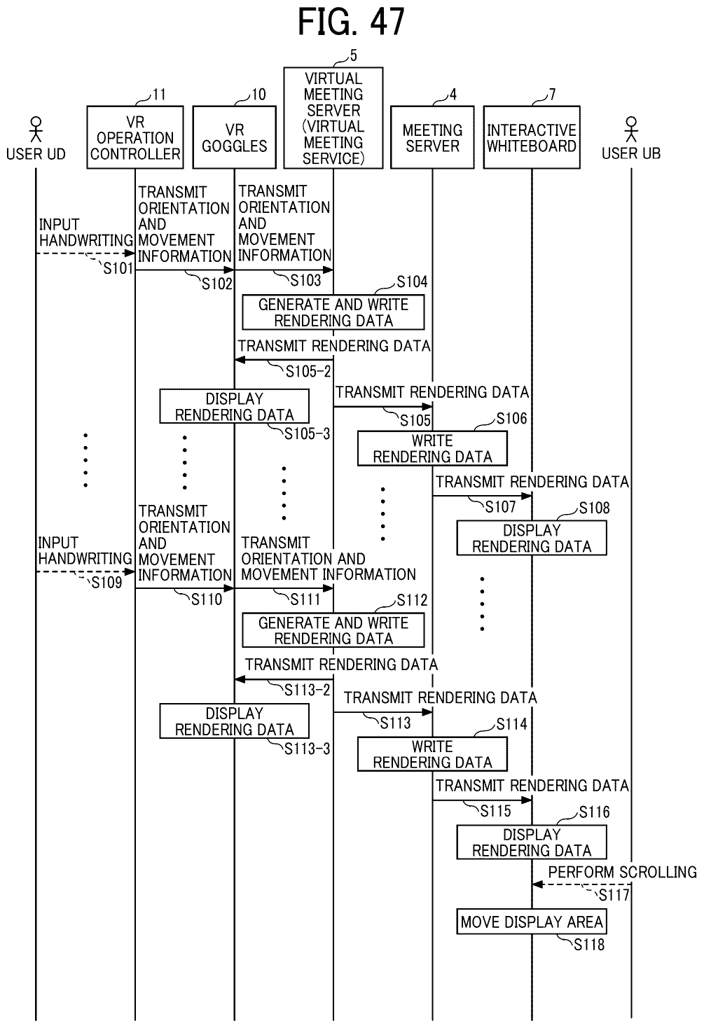

FIG. 44 illustrates the virtual whiteboard 18a displaying the rendering data with the VR operation controller 11. The rendering data of FIG. 44 includes the two handwriting data items 203 of the character “A,” the star 204, and the square 205.

If the user UD presses the pointer display button 115 of the VR operation controller 11, the VR operation controller 11 transmits a display pointer command including the orientation and movement information of the VR operation controller 11 to the VR goggles 10 in Bluetooth communication. The VR goggles 10 transmit the display pointer command to the virtual meeting service of the virtual meeting server 5.

The virtual meeting service receives the display pointer command, and the pointer position calculation unit 27 of the virtual meeting server 5 calculates a pointer display position based on the orientation and movement information of the VR operation controller 11. The pointer position calculation unit 27 then displays a pointer 209 on the virtual whiteboard 18a in the virtual meeting space 18. While the user UD is pressing the pointer display button 115, the VR operation controller 11 transmits the display pointer command, which includes the orientation and movement information of the VR operation controller 11, to the VR goggles 10 periodically (e.g., every 100 milliseconds). The VR goggles 10 then transmit the display pointer command to the virtual meeting service of the virtual meeting server 5.

If the display of the virtual whiteboard 18a changes with the movement of the pointer 209, the virtual meeting service transmits the display data of the virtual whiteboard 18a to the VR goggles 10. Further, if the user UD presses and holds the pointer display button 115 of the VR operation controller 11 to move the pointer 209 onto the shape icon 211 (see FIG. 6) of the menu bar 215 and presses the confirm button 116 of the VR operation controller 11, the VR operation controller 11 transmits a confirm command to the VR goggles 10 in Bluetooth communication. The VR goggles 10 transmit the confirm command to the virtual meeting service of the virtual meeting server 5. The virtual meeting service receives the confirm command, and the virtual display control unit 26 of the virtual meeting server 5 determines that the shape icon 211 has been selected. The virtual display control unit 26 then displays the shape list 212.

If the user UD presses and holds the pointer display button 115 of the VR operation controller 11 to move the pointer 209 onto a square in the shape list 212 and presses the confirm button 116, the VR operation controller 11 transmits a confirm command to the virtual meeting service of the virtual meeting server 5 via the VR goggles 10. The virtual meeting service receives the confirm command, and the virtual display control unit 26 determines that the square has been selected. The virtual display control unit 26 then displays the square 205.

If the user UD then presses and holds the pointer display button 115 of the VR operation controller 11 to move the pointer 209 onto a star in the shape list 212 and presses the confirm button, the VR operation controller 11 transmits a confirm command to the virtual meeting service of the virtual meeting server 5 via the VR goggles 10. The virtual meeting service receives the confirm command, and the virtual display control unit 26 determines that the star has been selected. The virtual display control unit 26 then displays the star 204.

If the user UD presses and holds the pointer display button 115 of the VR operation controller 11 to move the pointer 209 onto the star 204 and pauses for a particular time (e.g., two seconds), the star 204 is captured. Thereby, the user UD is able to move the star 204 while continuing to press and hold the pointer display button 115.

Herein, the user UB in the meeting room MA wants to handwrite information related to the rendering data rendered by the user UD in an open space on the right of the rendering data. However, the open space to the right of the handwriting data items 203, the star 204, and the square 205 is not large enough. The user UB therefore scrolls the renderable area 217 leftward to expand the open space, and handwrites the information in the expanded open space.

In the interactive whiteboard 7, the contact position detection unit 70 detects the leftward scrolling performed by the user UB with the electronic pen 490, and the display control unit 71 moves the display area. If the user UB in the meeting room MA inputs handwriting or displays a graphic with the electronic pen 490, the contact position detection unit 70 detects the contact position of the electronic pen 490, and the display control unit 71 generates and displays the handwriting data or graphic. The rendering data transmission unit 41 of the interactive whiteboard 7 sequentially transmits the rendering data (i.e., the handwriting data or graphic) to the meeting server 4. The meeting server 4 writes the rendering data received from the interactive whiteboard 7 in the renderable area 217 of the memory.

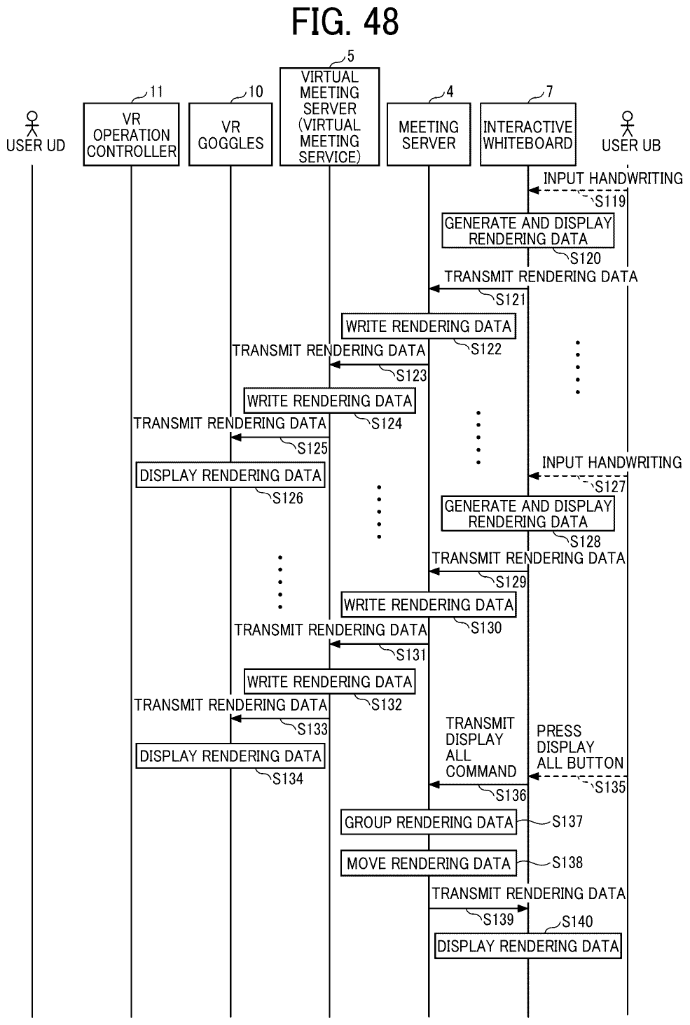

FIG. 45 illustrates the rendering data rendered on a whiteboard in the memory of the meeting server 4 when a user handwrites the handwriting data items 208 of the character “B” and renders the arrow 206 on the interactive whiteboard 7.

Specifically, FIG. 45 illustrates the rendering data in the renderable area 217 of the meeting server 4, including the rendering data rendered by the interactive whiteboard 7. FIG. 45 further illustrates a display area 251 of the interactive whiteboard 7. When the meeting server 4 receives the rendering data from the interactive whiteboard 7 in the meeting room MA, the writing unit 66 of the meeting server 4 writes the rendering data in the renderable area 217 of the whiteboard in the memory.

The virtual whiteboard synchronization control unit 64 of the meeting server 4 transmits the rendering data received from the interactive whiteboard 7 to the virtual meeting service of the virtual meeting server 5. The synchronization control unit 22 of the virtual meeting server 5 writes the received rendering data on the virtual whiteboard 18a. Thereby, the whiteboard of the meeting server 4 and the virtual whiteboard 18a of the virtual meeting server 5 are synchronized. The synchronization control unit 22 of the virtual meeting server 5 transmits the screen data of the virtual whiteboard 18a to the VR goggles 10 at the home of the user UD. The screen data transmitted to the VR goggles 10 may be limited to part of the screen data different from the display data of the VR goggles 10.

Then, to view all rendering data of the whiteboard on the interactive whiteboard 7, the user UB presses the display all button 210 of the menu bar 215, and the interactive whiteboard 7 transmits a display all command to the meeting server 4. The meeting server 4 receives the display all command, and the rendering data grouping unit 54 of the meeting server 4 groups the rendering data rendered on the interactive whiteboard 7 by the user UB and the rendering data rendered by the user UD with the VR operation controller 11.

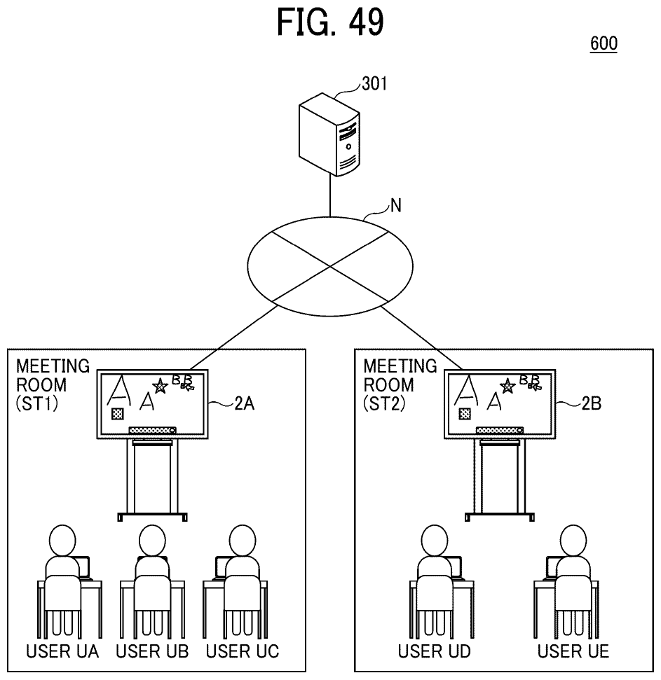

FIG. 46 illustrates the group G1 of the rendering data rendered with the VR operation controller 11 and the group G2 of the rendering data rendered on the interactive whiteboard 7.

The meeting server 4 then performs a process similar to that of the meeting server 1 of the first embodiment to move the rendering data of the group G1 and the rendering data of the group G2 on the whiteboard (i.e., move the respective positions thereof in the memory) such that the rendering data of the group G1 and the rendering data of the group G2 fit in the display area 251 of the interactive whiteboard 7.

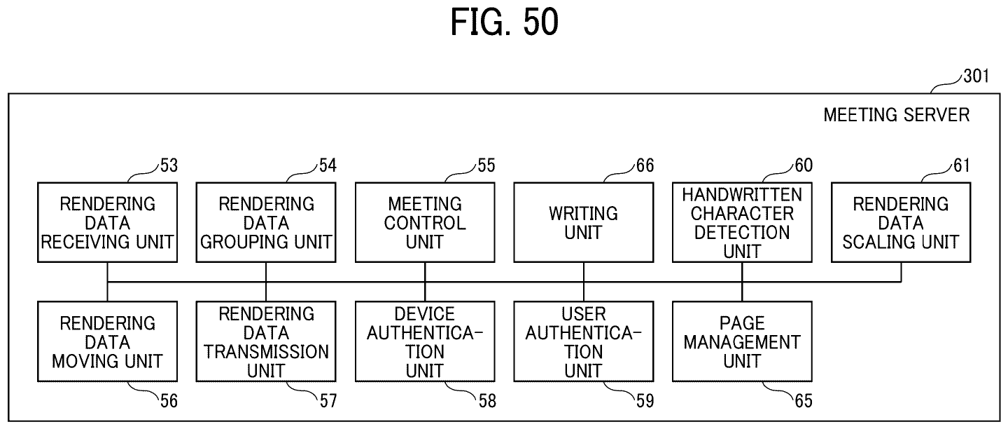

FIGS. 47 and 48 are sequence diagrams illustrating a process of rendering the rendering data with the VR operation controller 11 and rendering the rendering data on the interactive whiteboard 7. In the following description of FIG. 48, it is assumed that the interactive whiteboard 7 and the user UD have already been participating in the meeting.

At step S101, the user UD holds the VR operation controller 11 with the grip or handle thereof facing up, and moves the VR operation controller 11 in a horizontal plane to the ground by a particular distance in a distal direction away from the body of the user UD (i.e., pen-down). The user UD then makes a handwriting motion by moving the VR operation controller 11 in a vertical plane to the ground.

At step S102, the orientation and movement detection unit 122 of the VR operation controller 11 detects the orientation of the VR operation controller 11 (i.e., the attitude of the VR operation controller 11 in a three-dimensional space) and the movement of the VR operation controller 11 from the acceleration and angular velocity data obtained from the 6-axis acceleration and angular velocity sensor 113. The Bluetooth communication control unit 120 of the VR operation controller 11 then transmits the orientation and movement information to the VR goggles 10.

At step S103, the Bluetooth communication control unit 102 of the VR goggles 10 receives the orientation and movement information from the VR operation controller 11, and the wireless LAN communication control unit 101 of the VR goggles 10 transmits the orientation and movement information to the virtual meeting server 5.

At step S104, the communication control unit 23 of the virtual meeting server 5 receives the orientation and movement information, and the display data generation unit 25 of the virtual meeting server 5 generates handwriting data based on a locus of coordinates in the three-dimensional space based on the orientation and movement of the VR operation controller 11. The virtual display control unit 26 of the virtual meeting server 5 then writes the handwriting data on the virtual whiteboard 18a.

At step S105, the synchronization control unit 22 of the virtual meeting server 5 transmits the handwriting data to the meeting server 4.

At step S105-2, the communication control unit 23 of the virtual meeting server 5 transmits the handwriting data to the VR goggles 10.

At step S105-3, the wireless LAN communication control unit 101 of the VR goggles 10 receives the handwriting data, and the display control unit 100 of the VR goggles 10 displays the handwriting data.

At step S106, the rendering data receiving unit 53 of the meeting server 4 receives the handwriting data, and the writing unit 66 of the meeting server 4 writes the handwriting data in the renderable area 217 of the whiteboard.

At step S107, the rendering data transmission unit 57 of the meeting server 4 transmits the handwriting data to the interactive whiteboard 7.

At step S108, the rendering data receiving unit 42 of the interactive whiteboard 7 receives the handwriting data, and the display control unit 71 of the interactive whiteboard 7 displays the handwriting data on the display 480 of the interactive whiteboard 7.

At steps S109 to S116, processes similar to the above-described ones are repeated while the user UD inputs further handwriting with the VR operation controller 11.

At step S117, the user UB (or the user UA or UC) in the meeting room MA scrolls the renderable area 217 leftward to expands an open space.

At step S118, the contact position detection unit 70 of the interactive whiteboard 7 detects the leftward scrolling performed by the user UB with the electronic pen 490, and the display control unit 71 moves the display area.

At step S119, the user UB in the meeting room MA inputs handwriting or displays a graphic with the electronic pen 490.

At step S120, the contact position detection unit 70 detects the contact position of the electronic pen 490, and the display control unit 71 generates and displays handwriting data or a graphic.

At step S121, the rendering data transmission unit 41 of the interactive whiteboard 7 sequentially transmits the rendering data (i.e., the handwriting data or graphic) to the meeting server 4.

At step S122, the rendering data receiving unit 53 of the meeting server 4 receives the rendering data, and the writing unit 66 of the meeting server 4 writes the rendering data received from the interactive whiteboard 7 in the renderable area 217 of the whiteboard in the memory.

At step S123, the virtual whiteboard synchronization control unit 64 of the meeting server 4 transmits the rendering data received from the interactive whiteboard 7 to the virtual meeting service of the virtual meeting server 5.

At step S124, the communication control unit 23 of the virtual meeting server 5 receives the rendering data, and the synchronization control unit 22 of the virtual meeting server 5 writes the rendering data on the virtual whiteboard 18a.

At step S125, the synchronization control unit 22 transmits the display data of the virtual whiteboard 18a to the VR goggles 10 at the home of the user UD via the communication control unit 23. The display data transmitted to the VR goggles 10 may be limited to part of the display data different from the display data of the VR goggles 10.

At step S126, the wireless LAN communication control unit 101 of the VR goggles 10 receives the display data of the virtual whiteboard 18a, and the display control unit 100 of the VR goggles 10 displays the display data of the virtual whiteboard 18a.

At steps S127 to S134, processes similar to the above-described ones are repeated while the user UB (or the user UA or UC) inputs further handwriting to the interactive whiteboard 7.

At step S135, the user UB (or the user UA or UC) presses the display all button 210 of the menu bar 215 displayed on the interactive whiteboard 7.

At step S136, the contact position detection unit 70 of the interactive whiteboard 7 detects the pressing of the display all button 210 based on the contact position. The rendering data transmission unit 41 of the interactive whiteboard 7 transmits a display all command to the meeting server 4.

At step S137, the rendering data receiving unit 53 of the meeting server 4 receives the display all command, and the rendering data grouping unit 54 of the meeting server 4 groups the rendering data rendered on the interactive whiteboard 7 by the user UB and the rendering data rendered by the user UD with the VR operation controller 11.

At step S138, the rendering data moving unit 56 of the meeting server 4 moves the rendering data of the renderable area 217 to fill the gap between the rendering data of the group G1 and the rendering data of the group G2 (i.e., to fit the rendering data of the group G1 and the rendering data of the group G2 in the display area 251 of the interactive whiteboard 7) similarly as in the first embodiment.

At step S139, the rendering data transmission unit 57 of the meeting server 4 transmits the rendering data of the groups G1 and G2 moved in the renderable area 217 to the interactive whiteboard 7.

At step S140, the rendering data receiving unit 42 of the interactive whiteboard 7 receives the rendering data, and the display control unit 71 of the interactive whiteboard 7 displays the entire rendering data on the display 480 of the interactive whiteboard 7.

The processes following step S136 correspond to the processes following step S28 of the first embodiment. Alternatively, the meeting server 4 may perform the corresponding processes of the second, third, or fourth embodiment.

According to the fifth embodiment, the rendering data rendered at a plurality of sites is displayed in one screen in a virtual meeting.

In the fifth embodiment, the display area may be switched between pages, as in a sixth embodiment described below. In this case, a memory space with the size of the pages is allocated for the virtual whiteboard 18a. The rendering data written on the pages is displayed in one screen by a process of the sixth embodiment.

The sixth embodiment will be described.

In the first to fifth embodiments described above, the interactive whiteboard 2 or 7 has a display area that is moved by scrolling on the screen of the apparatus. In the sixth embodiment, an interactive whiteboard 2A or 2B has an immovable display area. In the interactive whiteboard 2A or 2B, the display area (a screen-size area) is handled as one page. The following description will be given of a meeting server that, when the rendering data is rendered over a plurality of pages, displays the rendering data of all pages to fit in the display area of the interactive whiteboard 2A or 2B.

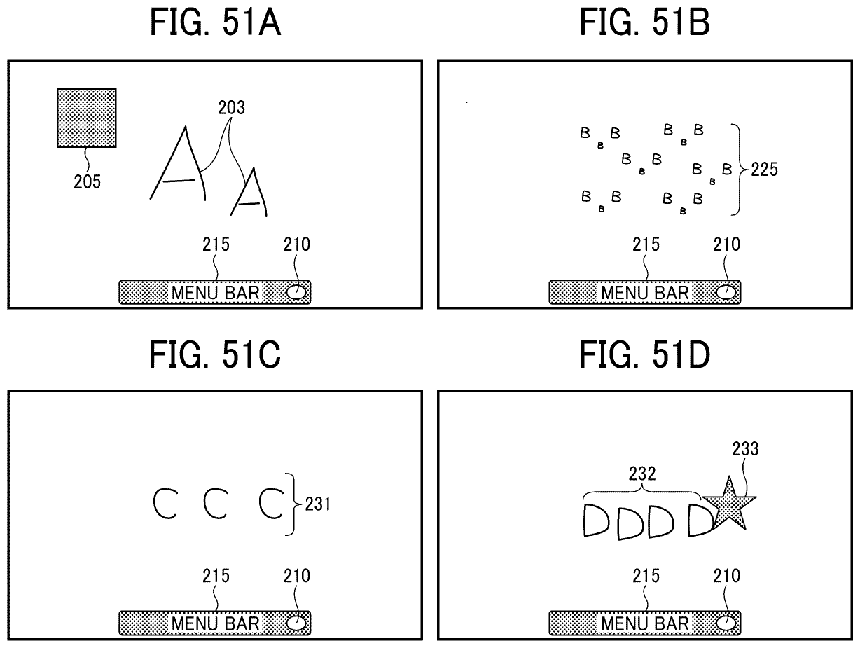

FIG. 49 is a diagram illustrating a system configuration of a remote meeting system 600 of the sixth embodiment. The following description of FIG. 49 will focus on differences from FIG. 2. In the remote meeting system 600 of FIG. 49, the sites ST1 and ST2 are both meeting rooms. The interactive whiteboard 2A is installed at the site ST1, and the interactive whiteboard 2B is installed at the site ST2. The interactive whiteboards 2A and 2B are connected to a meeting server 301.

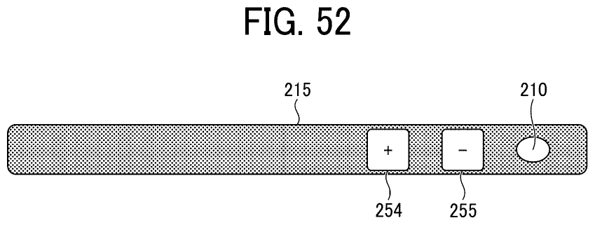

FIG. 50 is a functional block diagram of the meeting server 301 of the sixth embodiment. Since functional blocks of the interactive whiteboard 2A or 2B are similar to those of the interactive whiteboard 2 of the first embodiment, the functional blocks illustrated in FIG. 50 are limited to those of the meeting server 301. The following description of FIG. 50 will focus on differences from FIG. 13. The meeting server 301 of FIG. 50 additionally includes a page management unit 65. The page management unit 65 is means for creating a new page in response to a request from the interactive whiteboard 2A or 2B. Specifically, the page management unit 65 manages the rendering data such as handwriting data in pages.

The rendering data grouping unit 54 of the sixth embodiment is means for grouping the rendering data into groups corresponding to the pages. The handwritten character detection unit 60 of the sixth embodiment is means for detecting a character from the rendering data of each of the pages. The rendering data scaling unit 61 of the sixth embodiment is means for calculating the first mean and the second mean and increasing or reducing the size of the rendering data of each of the pages with the ratio of the second mean to the first mean. Herein, the first mean is the mean of the sizes of the characters in each of the groups, and the second mean is the mean of the sizes of the characters between the groups calculated based on the first mean. The rendering data moving unit 56 of the sixth embodiment arranges the groups of rendering data reduced or increased in size in the area corresponding to the display area of a particular apparatus such that the rendering data groups do not overlap with each other.

To participate in a meeting, the user UA, UB, or UC at the site ST1 operates the interactive whiteboard 2A to connect the interactive whiteboard 2A to the meeting, which is previously registered in the meeting server 301. The interactive whiteboard 2A transmits the device information thereof to the meeting server 301, and the meeting server 301 allows the interactive whiteboard 2A to participate in the meeting. Similarly, the user UD or a user UE at the site ST2 operates the interactive whiteboard 2B to connect the interactive whiteboard 2B to the meeting previously registered in the meeting server 301. The interactive whiteboard 2B transmits the device information thereof to the meeting server 301, and the meeting server 301 allows the interactive whiteboard 2B to participate in the meeting.

Then, the user UA, UB, or UC at the site ST1 starts the whiteboard application on the interactive whiteboard 2A. Thereby, the interactive whiteboard 2A displays, on the display 480 thereof, the display area in which the rendering data is rendered. The interactive whiteboard 2A further transmits to the meeting server 301 a start whiteboard command including the display pixel counts (i.e., the vertical pixel count and the horizontal pixel count) of the display area, and switches to share mode to share the whiteboard with the interactive whiteboard 2B at the other site ST2.

In response to receipt of the start whiteboard command, the meeting server 301 stores in a memory the display pixel counts included in the start whiteboard command in association with the device information of the interactive whiteboard 2A. The meeting server 301 further allocates a memory area for the whiteboard with a size corresponding to the display pixel counts, and manages the whiteboard area of the memory as the first page.

Similarly, the user UD or UE at the site ST2 starts the whiteboard application on the interactive whiteboard 2B, and the interactive whiteboard 2B displays the display area of the whiteboard on the display 480 of the interactive whiteboard 2B. The interactive whiteboard 2B further transmits to the meeting server 301 a start whiteboard command including the display pixel counts of the display area, and switches to share mode to share the whiteboard with the interactive whiteboard 2A at the other site ST1. In response to receipt of the start whiteboard command, the meeting server 301 stores in the memory the display pixel counts included in the start whiteboard command in association with the device information of the interactive whiteboard 2B. The meeting server 301 further compares the display pixel counts of the interactive whiteboard 2A with the display pixel counts of the interactive whiteboard 2B, and determines that the display pixel counts received from the interactive whiteboard 2B are the same as the display pixel counts received from the interactive whiteboard 2A (if the interactive whiteboards 2A and 2B are of the same model).

The rendering data is shared as follows.

If the user UA inputs handwriting to the interactive whiteboard 2A at the site ST1, for example, the contact position detection unit 45 of the interactive whiteboard 2A detects the contact position corresponding to the handwriting, and the display control unit 44 of the interactive whiteboard 2A generates and displays handwriting data at the contact position. If the user UA selects the square from the shape list 212, which is displayed when the shape icon 211 of the menu bar 215 is pressed, the interactive whiteboard 2A generates and displays the square. The rendering data transmission unit 41 of the interactive whiteboard 2A sequentially transmits the thus-generated rendering data to the meeting server 301.

In response to receipt of the rendering data from the site ST1, the meeting server 301 writes the rendering data on the page of the whiteboard currently shared in the memory, and transmits the rendering data to the interactive whiteboard 2B at the site ST2.

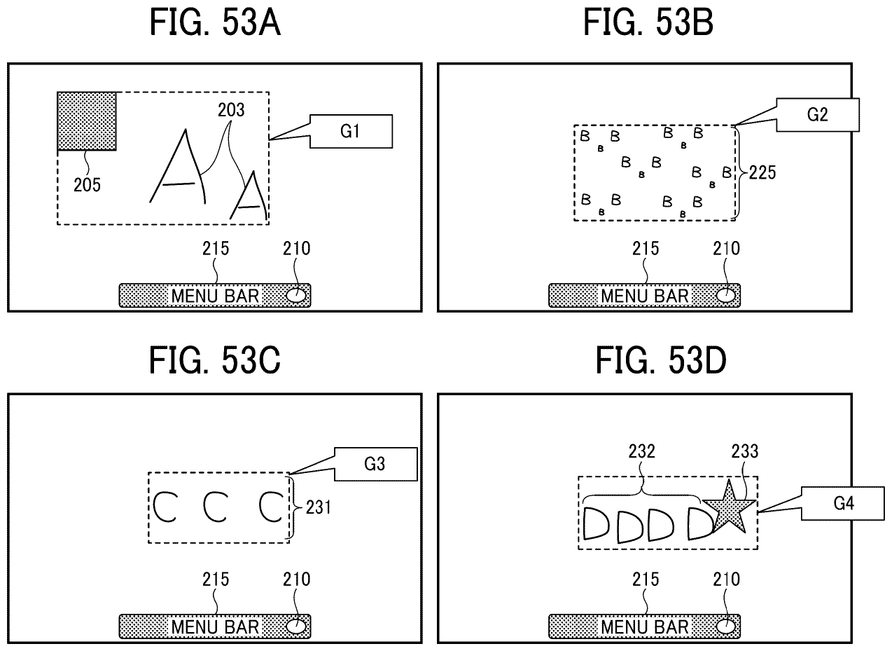

FIGS. 51A, 51B, 51C, and 51D illustrate the rendering data rendered on pages of the whiteboard. Specifically, FIG. 51A illustrates the rendering data of the first page, and FIG. 51B illustrates the rendering data of the second page. Further, FIG. 51C illustrates the rendering data of the third page, and FIG. 51D illustrates the rendering data of the fourth page. The rendering data of the first page includes the two handwriting data items 203 of the character “A” handwritten by the UA, UB, or UC at the site ST1 and the square 205 rendered by the user UD or UE at the site ST2.

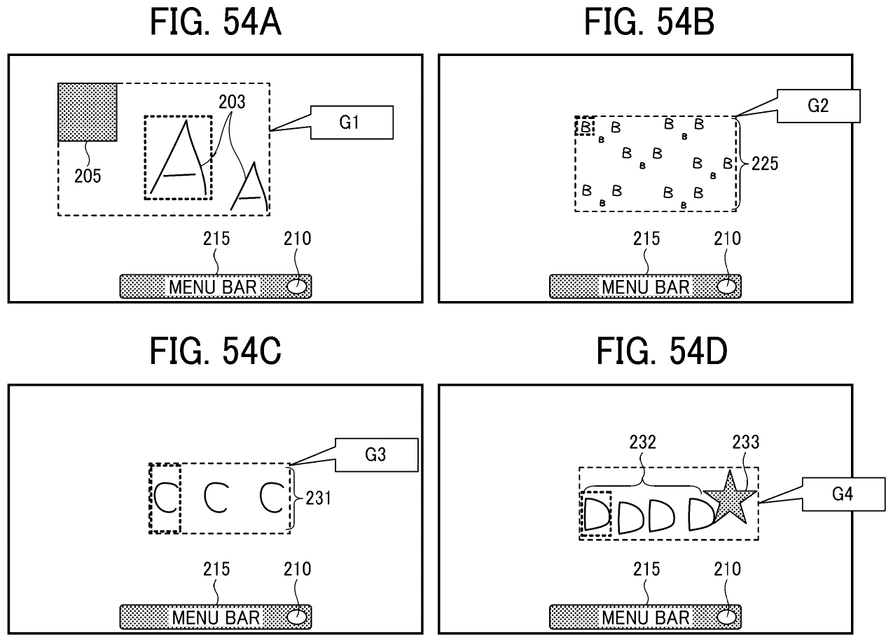

Herein, the user UD at the site ST2 wants to handwrite information related to the rendering data of the site ST1 in an open space to the right of the handwriting data items 203 of the character “A,” but the open space is not large enough. Therefore, the user UD presses a next page button 254 (see FIG. 52) of the menu bar 215.

FIG. 52 illustrates an example of the menu bar 215. The menu bar 215 includes the next page button 254 and a previous page button 255 in addition to the display all button 210. With the next page button 254, an operation of switching to the next page is received. With the previous page button 255, an operation of switching to the previous page is received. If the next page button 254 is pressed when the last page is displayed, a blank page with no rendering data is added.

In response to the pressing of the next page button 254, the interactive whiteboard 2B transmits a switch to next page command to the meeting server 301. The meeting server 301 receives the switch to next page command, and the page management unit 65 of the meeting server 301 allocates a whiteboard area for the second page in the memory, initializes the whiteboard area, and transmits to the interactive whiteboards 2A and 2B a command to create a new display area (i.e., new page). Each of the interactive whiteboards 2A and 2B displays the new display area (i.e., new page) on the display 480 thereof. The display area is therefore blank except for the menu bar 215.

If the user UD inputs handwriting to the interactive whiteboard 2B, the contact position detection unit 45 of the interactive whiteboard 2B detects the contact position corresponding to the handwriting, and the display control unit 44 of the interactive whiteboard 2B generates and displays handwriting data at the contact position. The rendering data transmission unit 41 of the interactive whiteboard 2B sequentially transmits the handwriting data to the meeting server 301.

In response to receipt of the handwriting data from the site ST2, the meeting server 301 writes the handwriting data in the whiteboard area for the second page in the memory. The meeting server 301 further transmits the handwriting data to the interactive whiteboard 2A at the site ST1. The interactive whiteboard 2A at the site ST1 receives and displays the handwriting data. FIG. 51B illustrates the rendering data of the second page, which includes the eighteen handwriting data items 225 of the character “B.”

To input further handwriting, the user UB at the site ST1 presses the next page button 254 of the menu bar 215. Thereby, the interactive whiteboard 2A transmits a switch to next page command to the meeting server 301. The meeting server 301 receives the switch to next page command, and the page management unit 65 of the meeting server 301 allocates a whiteboard area for the third page in the memory, initializes the whiteboard area, and transmits to the interactive whiteboards 2A and 2B a command to create a new display area (i.e., new page). Each of the interactive whiteboards 2A and 2B displays the new display area (i.e., new page) on the display 480 thereof. The display area is therefore blank except for the menu bar 215.

If the user UB inputs handwriting to the interactive whiteboard 2A, the contact position detection unit 45 of the interactive whiteboard 2A detects the contact position corresponding to the handwriting, and the display control unit 44 of the interactive whiteboard 2A generates and displays handwriting data at the contact position. The rendering data transmission unit 41 sequentially transmits the handwriting data to the meeting server 301. In response to receipt of the handwriting data from the site ST1, the meeting server 301 writes the handwriting data in the whiteboard area for the third page in the memory. The meeting server 301 further transmits the handwriting data to the interactive whiteboard 2B at the site ST2. The interactive whiteboard 2B at the site ST2 receives and displays the handwriting data. FIG. 51C illustrates the rendering data of the third page, which includes the three handwriting data items 231 of the character “C.”

To input further handwriting, the user UE at the site ST2 presses the next page button 254 of the menu bar 215. Thereby, the interactive whiteboard 2B transmits a switch to next page command to the meeting server 301. The meeting server 301 receives the switch to next page command, and the page management unit 65 of the meeting server 301 allocates a whiteboard area for the fourth page in the memory, initializes the whiteboard area, and transmits to the interactive whiteboards 2A and 2B a command to create a new display area (i.e., new page). Each of the interactive whiteboards 2A and 2B displays the new display area (i.e., new page) on the display 480 thereof. The display area is therefore blank except for the menu bar 215.

If the user UE inputs handwriting to the interactive whiteboard 2B, the contact position detection unit 45 of the interactive whiteboard 2B detects the contact position corresponding to the handwriting, and the display control unit 44 of the interactive whiteboard 2B generates and displays handwriting data at the contact position. If the user UE further selects the star from the shape list 212, which is displayed when the shape icon 211 of the menu bar 215 is pressed, the interactive whiteboard 2B generates and displays the star. The rendering data transmission unit 41 of the interactive whiteboard 2B sequentially transmits the rendering data including the handwriting data and the graphic to the meeting server 301. In response to receipt of the rendering data from the site ST2, the meeting server 301 writes the rendering data in the whiteboard area for the fourth page in the memory. The meeting server 301 further transmits the rendering data to the interactive whiteboard 2A at the site ST1. The interactive whiteboard 2A at the site ST1 receives and displays the rendering data. FIG. 51D illustrates the rendering data of the fourth page, which includes the four handwriting data items 232 of the character “D” and the star 233.

The rendering data of the fourth page is currently displayed on both the display 480 of the interactive whiteboard 2A and the display 480 of the interactive whiteboard 2B. If the user UA, UB, or UC at the site ST1 presses the display all button 210 to also display and check the rendering data of the first to third pages, the interactive whiteboard 2A detects the pressing of the display all button 210 and transmits a display all command to the meeting server 301. The meeting server 301 receives the display all command, and the rendering data grouping unit 54 of the meeting server 301 groups the rendering data of the pages.

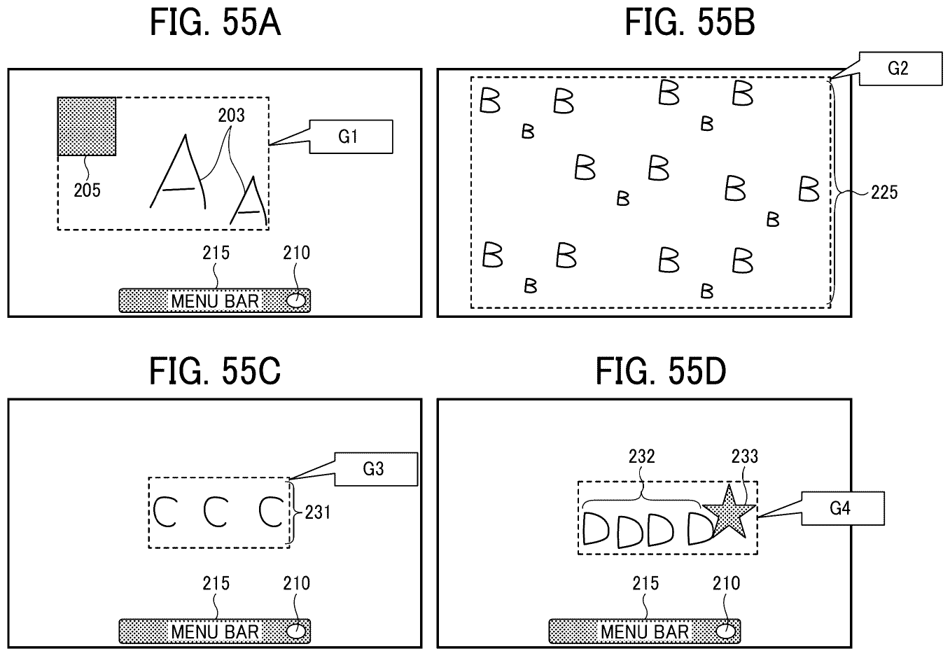

FIGS. 53A, 53B, 53C, and 53D illustrate the grouped rendering data of the pages. The rendering data grouping unit 54 creates a circumscribed rectangle of rendering data for each of the pages (not for each of the sites), with the rendering data enclosed by a rectangular area forming a group. FIG. 53A illustrates the group G1 including the rendering data of the first page, and FIG. 53B illustrates the group G2 including the rendering data of the second page. Further, FIG. 53C illustrates the group G3 including the rendering data of the third page, and FIG. 53D illustrates the group G4 including the rendering data of the fourth page.

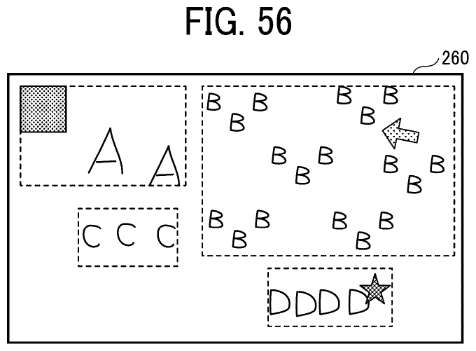

Then, the handwritten character detection unit 60 of the meeting server 301 clips the characters from the groups G1 to G4, as illustrated in FIGS. 54A, 54B, 54C, and 54D. FIGS. 54A to 54D are diagrams illustrating the characters clipped from the groups G1 to G4. In this example, the characters “A,” “B,” “C,” and “D” are detected from the groups G1, G2, G3, and G4, respectively. The handwritten character detection unit 60 calculates the mean size of the characters for each of the groups G1 to G4. The character size is represented by the point count corresponding to the size of the clipped character.

For each of the groups G1 to G4, the rendering data scaling unit 61 of the meeting server 301 calculates the mean of the sizes of the characters clipped from the rendering data of the corresponding one of the first to fourth pages. The rendering data scaling unit 61 clips the two characters from the first page, and calculates the mean of the point counts corresponding to the sizes of the characters. The mean of the sizes of the characters on the first page is represented as a1. The rendering data scaling unit 61 further clips the eighteen characters from the second page, and calculates the mean of the point counts corresponding to the sizes of the characters. The mean of the sizes of the characters on the second page is represented as a2. Similarly, the rendering data scaling unit 61 clips the three characters from the third page, and calculates the mean of the point counts corresponding to the sizes of the characters. The mean of the sizes of the characters on the third page is represented as a3. The rendering data sealing unit 61 further clips the four characters from the fourth page, and calculates the mean of the point counts corresponding to the sizes of the characters. The mean of the sizes of the characters on the fourth page is represented as a4. The mean W of the means a1 to a4 of the sizes of the characters on the first to fourth pages is expressed as W=(a1+a2+a3+a4)/4.

The rendering data scaling unit 61 of the meeting server 301 increases or reduces the size of the rendering data of each of the pages with the mean W. Since the mean a1 of the character sizes of the first page is greater than the mean W, the rendering data scaling unit 61 reduces the size of the rendering data of the first page including a graphic with W/a1 (i.e., reduces the size of the rendering data as one group). Since the mean a2 of the character sizes of the second page is less than the mean W, the rendering data scaling unit 61 increases the size of the rendering data of the second page with W/a2 (i.e., increases the size of the rendering data as one group). Since the mean a3 of the character sizes of the third page is greater than the mean W, the rendering data scaling unit 61 reduces the size of the rendering data of the third page with W/a3 (i.e., reduces the size of the rendering data as one group). Since the mean a4 of the character sizes of the fourth page is greater than the mean W, the rendering data scaling unit 61 reduces the size of the rendering data of the fourth page including a graphic with W/a4 (i.e., reduces the size of the rendering data as one group).

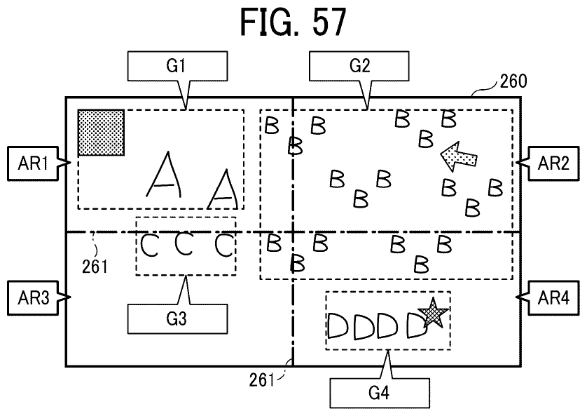

FIGS. 55A, 55B, 55C, and 55D illustrate the rendering data increased or reduced in size. It is observed here that the rendering data of the first, third, and fourth pages is reduced in size, and that the rendering data of the second page is increased in size.

After the increase or reduction in size of the rendering data, the rendering data moving unit 56 of the meeting server 301 arranges the rendering data groups of the first to fourth pages to be close to each other. The rendering data moving unit 56 allocates a memory area with a sufficient size for writing the rendering data groups of the first to fourth pages together (hereinafter referred to as the integrated area 260) separately from the respective memory areas for writing the rendering data groups of the first to fourth pages. The rendering data moving unit 56 then copies and arranges the rendering data groups of the first to fourth pages into the integrated area 260 such that the rendering data groups of the first to fourth pages do not overlap with each other. The integrated area 260 may have a maximum size for writing the rendering data groups of the first to fourth pages. After the rendering data groups of the first to fourth pages are written in the integrated area 260, the size of the integrated area 260 may be adjusted with a circumscribed rectangle enclosing the rendering data groups of the first to fourth pages. The process of arranging the rendering data groups without overlapping may use a machine learning model.

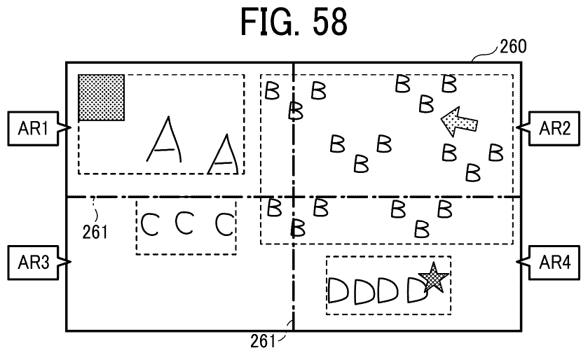

FIG. 56 illustrates the rendering data of the first to fourth pages written in the integrated area 260. The rendering data moving unit 56 moves the group G2 such that the upper-left corner of the group G2 substantially matches the upper-right corner of the group G1, for example. The rendering data moving unit 56 further moves the group G3 such that the upper-right corner of the group G3 substantially matches the lower-right corner of the group G1, for example. Alternatively, the rendering data moving unit 56 may simply move the group G3 such that the upper side of the group G3 substantially matches the lower side of the group G1. Further, the rendering data moving unit 56 moves the group G4 such that the upper side of the group G4 substantially matches the lower side of the group G2, for example.

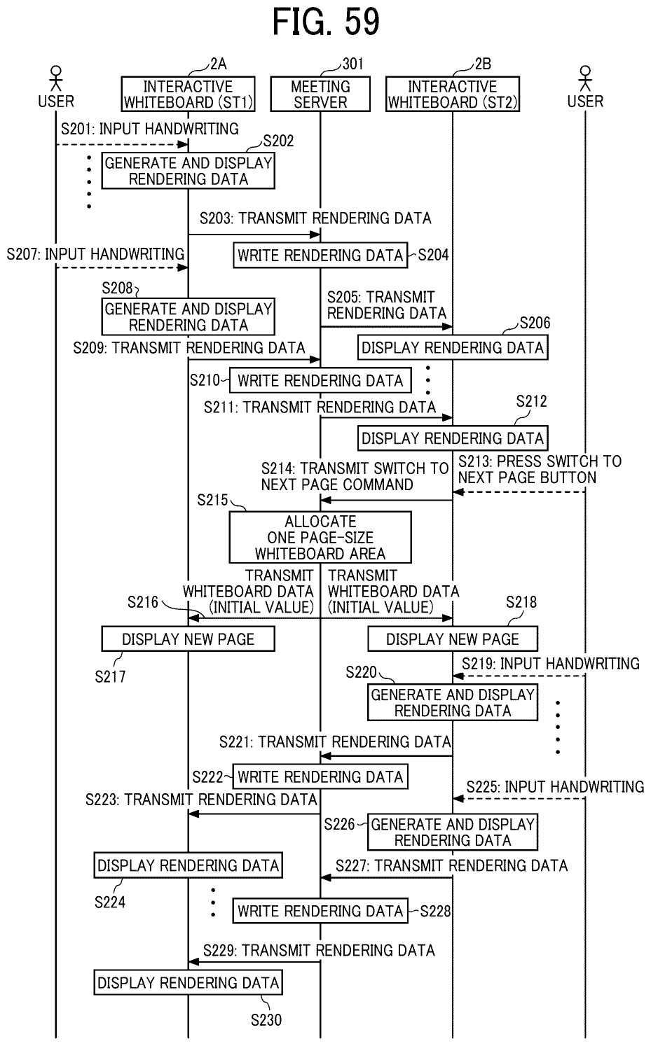

The rendering data moving unit 56 of the meeting server 301 then divides the integrated area 260 into four areas, as illustrated in FIG. 57. FIG. 57 illustrates the integrated area 260 divided into four areas AR1, AR2, AR3, and AR4. The rendering data moving unit 56 moves the rendering data of the groups G1 to G4 such that the rendering data of each of the groups G1 to G4 fits in one of the areas AR1 to AR4. That is, the rendering data moving unit 56 divides the integrated area 260 into the same number of areas as that of the pages. If the number of the pages is an odd number, the number of the pages may be incremented by one to be an even number to simplify the process of dividing the integrated area 260. In FIG. 57, the first page, the second page, the third page, and the fourth page correspond to the areas AR1, AR2, AR3, and AR4, respectively.

After dividing the integrated area 260, the rendering data moving unit 56 determines whether the rendering data of each of the pages fits in the corresponding one of the areas AR1 to AR4. Specifically, the rendering data moving unit 56 determines whether the group G1 fits in the area AR1. In the example of FIG. 57, the rendering data moving unit 56 determines that the group G1 fits in the area AR1. The rendering data moving unit 56 then determines whether the group G2 fits in the area AR2. In the example of FIG. 57, the rendering data moving unit 56 determines that the group G2 is larger than the area AR2 in both width and height. Then, the rendering data moving unit 56 determines whether the group G3 fits in the area AR3. In the example of FIG. 57, the rendering data moving unit 56 determines that the group G3 is smaller than the area AR3 in both width and height. The rendering data moving unit 56 similarly determines that the group G4 is smaller than the area AR4 in both width and height.

Then, the rendering data moving unit 56 determines whether any of dividing lines 261 for dividing the integrated area 260 into the four areas AR1 to AR4 overlaps with the group G3 or G4, which is determined to be smaller than the corresponding area in both width and height. The group G1 is smaller than the area AR1, and thus does not overlap with the dividing lines 261. In the example of FIG. 57, the rendering data moving unit 56 determines that the group G3 overlaps with the horizontal dividing line 261. The rendering data moving unit 56 then determines whether there is any rendering data group below the group G3 in the integrated area 260. If it is determined that there is no rendering data group below the group G3, the rendering data moving unit 56 moves the group G3 downward to a position at which the upper side of the group G3 is aligned with the horizontal dividing line 261.

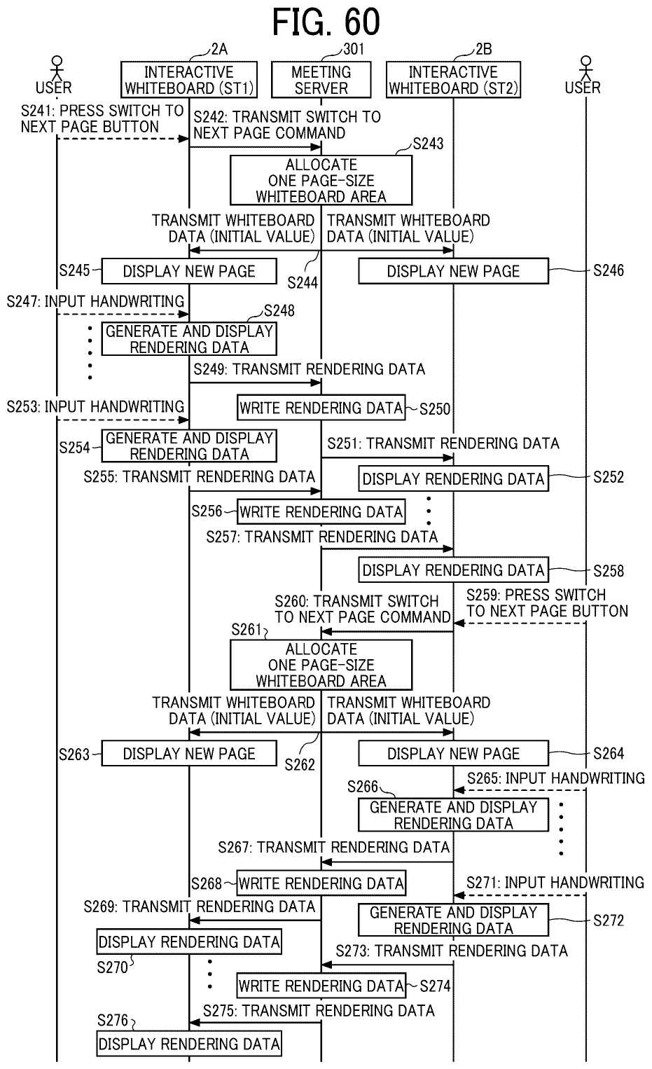

FIG. 58 illustrates the integrated area 260 with the group G3 moved downward. In FIG. 58, the upper side of the group G3 is aligned with the horizontal dividing line 261.

Instead of dividing the integrated area 260 into the areas AR1 to AR4 and then moving the rendering data of the groups G1 to G4, the rendering data moving unit 56 moves the rendering data of the groups G1 to G4 and then arranges the rendering data of the groups G1 to G4 in the areas AR1 to AR4, as described above. Thereby, the respective rendering data groups of the pages are arranged with little gaps therebetween, and each of the pages is readily arranged in the corresponding area.

The rendering data moving unit 56 then determines whether the integrated area 260 is equal to or smaller than the display area of the interactive whiteboard 2A, which has requested to display the rendering data in one screen. If the integrated area 260 is equal to or smaller than the display area of the interactive whiteboard 2A, the rendering data transmission unit 57 transmits the rendering data of the integrated area 260 illustrated in FIG. 58 to the interactive whiteboards 2A and 2B. Then, the interactive whiteboards 2A and 2B display the received rendering data. If the integrated area 260 is larger than the display area of the interactive whiteboard 2A, which has requested to display the rendering data in one screen, the rendering data scaling unit 61 reduces the size of the rendering data of each of the groups G1 to G4 arranged in the integrated area 260 such that the rendering data fits in the display area of the interactive whiteboard 2A having requested to display the rendering data in one screen. The rendering data transmission unit 57 transmits the rendering data reduced in size to the interactive whiteboards 2A and 2B. Then, the interactive whiteboards 2A and 2B display the received rendering data of the integrated area 260. If the integrated area 260 is larger than the display area of the interactive whiteboard 2A having requested to display the rendering data in one screen, the rendering data scaling unit 61 may reduce the size of the rendering data of the integrated area 260 as one image data set by performing an image reduction process (e.g., thinning pixel data) on the rendering data to fit the rendering data in the display area of the interactive whiteboard 2A having requested to display the rendering data in one screen.

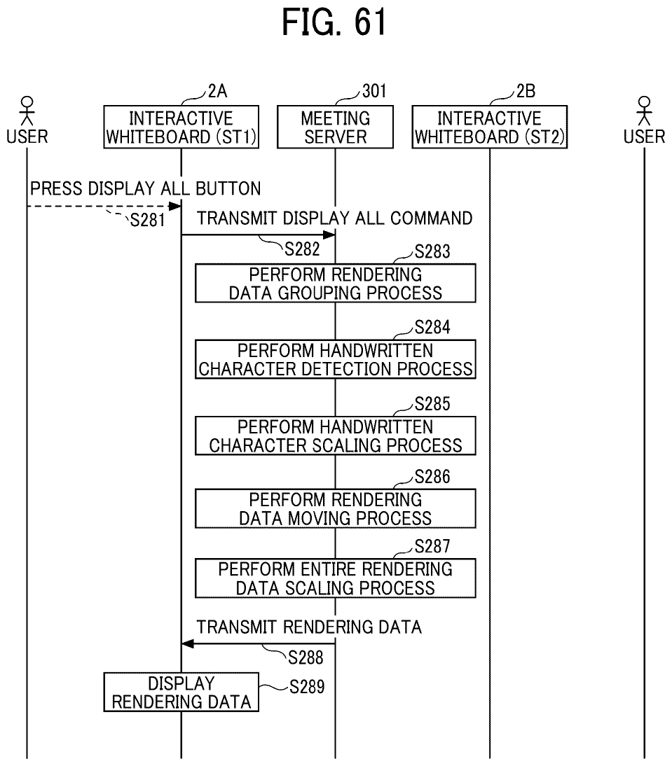

FIGS. 59, 60, and 61 are sequence diagrams each illustrating a process in which the meeting server 301 causes the interactive whiteboards 2A and 2B to display the rendering data of a plurality of pages in one screen. The following description of FIGS. 59 to 61 will focus on differences from FIG. 12. The processes of steps S201 to S212 may be similar to those of steps S1 to S12 in FIG. 12.

At step S213, to input further handwriting, the user UD at the site ST2 presses the next page button 254 of the menu bar 215.

At step S214, the contact position detection unit 45 of the interactive whiteboard 2B detects the pressing of the next page button 254, and the LAN communication control unit 96 of the interactive whiteboard 2B transmits a switch to next page command to the meeting server 301.

At step S215, the meeting control unit 55 of the meeting server 301 receives the switch to next page command, and the page management unit 65 of the meeting server 301 allocates, in the memory, a whiteboard area with the size of one page.

At step S216, the meeting control unit 55 of the meeting server 301 initializes the whiteboard area and transmits a command to create a new display area (i.e., new page) to the interactive whiteboards 2A and 2B.

At step S217, the LAN communication control unit 96 of the interactive whiteboard 2A receives the command to create a new display area (i.e., new page), and the display control unit 44 of the interactive whiteboard 2A displays a new page on the display 480 of the interactive whiteboard 2A.

At step S218, the LAN communication control unit 96 of the interactive whiteboard 2B receives the command to create a new display area (i.e., new page), and the display control unit 44 of the interactive whiteboard 2B displays a new page on the display 480 of the interactive whiteboard 2B.

The processes of subsequent steps S219 to S230 may be similar to those of steps S15 to S26 in FIG. 12.

At steps S241 to S246 in FIG. 60, the user UB at the site ST1 adds a new page, and processes similar to those of steps S213 to S218 take place.

The processes of subsequent steps S247 to S258 may be similar to those of steps S201 to S212.

At steps S259 to S264, the user UD at the site ST2 adds a new page, and processes similar to those of steps S213 to S218 take place.

The processes of subsequent steps S265 to S276 may be similar to those of steps S219 to S230 in FIG. 59.

At step S281 in FIG. 61, the fourth page is currently displayed on the display 480 of the interactive whiteboard 2A and the display 480 of the interactive whiteboard 2B. The user UB at the site ST1 presses the display all button 210 to also display and check the rendering data of the first to third pages.

At step S282, the contact position detection unit 45 of the interactive whiteboard 2A detects the pressing of the display all button 210, and the rendering data transmission unit 41 of the interactive whiteboard 2A transmits a display all command to the meeting server 301.

At step S283, the rendering data receiving unit 53 of the meeting server 301 receives the display all command, and the rendering data grouping unit 54 of the meeting server 301 groups the rendering data of the pages into rendering data groups.

At step S284, the handwritten character detection unit 60 of the meeting server 301 detects the characters from the rendering data groups, and calculates the mean of the sizes of the characters in each of the groups.

At step S285, the rendering data scaling unit 61 of the meeting server 301 calculates an enlargement or reduction ratio by comparing the mean of the character sizes in all groups with the mean of the character sizes in each of the groups, and increases or reduces the character size of each of the groups.

At step S286, the rendering data moving unit 56 of the meeting server 301 allocates a memory space for the integrated area 260, and arranges the groups increased or reduced in size in the integrated area 260 such that the groups do not overlap with each other.

At step S287, the rendering data scaling unit 61 compares the size of the display area of the interactive whiteboard 2A with the size of the integrated area 260. If the size of the integrated area 260 is equal to or less than the size of the display area of the interactive whiteboard 2A, the process proceeds to step S288. If the size of the integrated area 260 is greater than the size of the display area of the interactive whiteboard 2A, the rendering data scaling unit 61 reduces the size of the integrated area 260 to fit the integrated area 260 in the display area of the interactive whiteboard 2A both vertically and horizontally while maintaining the aspect ratio of the integrated area 260.

At step S288, the rendering data transmission unit 57 of the meeting server 301 transmits the rendering data of the integrated area 260 to the interactive whiteboard 2A.

At step S289, the rendering data receiving unit 42 of the interactive whiteboard 2A receives the rendering data, and the display control unit 44 of the interactive whiteboard 2A causes the display 480 of the interactive whiteboard 2A to display the received rendering data.

According to the sixth embodiment, in which an apparatus such as the interactive whiteboard 2A or 2B switches the display area between pages, the interactive whiteboard 2A or 2B displays the rendering data of the pages in one screen as desired.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above.

For example, a user inputs handwriting to an apparatus such as an interactive whiteboard in the above-described embodiments. Alternatively, a voice-activated operation may be used to input data.

In the embodiments, the user pressing the display all button 210 may select, from thumbnail images of the sites, the rendering data of particular sites to be displayed in one screen, for example. Further, the user pressing the display all button 210 may select, from thumbnail images of the pages, the rendering data of particular pages to be displayed in one screen, for example.

Further, the user pressing the display all button 210 may specify the enlargement or reduction ratio for each of the sites or pages, the rendering data of which is to be displayed in one screen by the user.

In the embodiments, the rendering data groups to be displayed in one screen are transmitted specifically to the interactive whiteboard 2, 7, 2A, or 2B, the display all button 210 of which has been pressed. Alternatively, the rendering data groups may be displayed in one screen on the apparatuses at the respective sites. In this case, an apparatus, the display all button 210 of which has not been pressed, displays a notification that the rendering data groups are ready to be displayed in one screen. Then, if a user performs an operation of displaying the rendering data groups in one screen, the apparatus displays the rendering data groups in one screen.

An interactive whiteboard may be alternatively called an electronic whiteboard or an electronic information board, for example. The embodiments are not limited to the interactive whiteboard, and are preferably applicable to any information processing apparatus with a touch panel. The information processing apparatus with a touch panel may be a PC, tablet terminal, or smartphone with a touch panel, for example. The information processing apparatus normally functions as a general-purpose information processing apparatus. By executing an application for making the information processing apparatus function as a display device, the user is able to operate the information processing apparatus as a display device.

In the configuration examples illustrated in FIG. 5 and other drawings, the processing units of the meeting server 1, 4, or 301 are divided in accordance with major functions of the meeting server 1, 4, or 301 to facilitate the understanding of the processing of the meeting server 1, 4, or 301. It should be noted that the present disclosure is not limited by how the processing units are divided or the names thereof. The processing of the meeting server 1, 4, or 301 may be divided into more processing units in accordance with the processing of the meeting server 1, 4, or 301. Further, any of the processing units of the meeting server 1, 4, or 301 may be subdivided to include more processes.

The functionality of the elements disclosed herein may be implemented using circuitry or processing circuitry which includes general purpose processors, special purpose processors, integrated circuits, application-specific integrated circuits (ASICs), field-programmable gate arrays (FPGAs), and/or combinations thereof which are configured or programmed, using one or more programs stored in one or more memories, to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited functionality.

There is a memory that stores a computer program which includes computer instructions. These computer instructions provide the logic and routines that enable the hardware (e.g., processing circuitry or circuitry) to perform the method disclosed herein. This computer program can be implemented in known formats as a computer-readable storage medium, a computer program product, a memory device, a record medium such as a CD-ROM or DVD, and/or the memory of an FPGA or ASIC.

The present disclosure provides significant improvements in computer capabilities and functionalities. These improvements allow a user to utilize a computer which provides for more efficient and robust interaction with a table which is a way to store and present information in an information processing apparatus. Moreover, the present disclosure provides for a better user experience through the use of a more efficient, powerful and robust user interface. Such a user interface provides for a better interaction between a human and a machine.

1. An information processing apparatus comprising circuitry configured to
receive a plurality of rendering data items rendered in respective display areas displayed on a plurality of apparatuses,
write the received plurality of rendering data items in a renderable area, the renderable area including the display areas of the plurality of apparatuses,
move at least part of the plurality of rendering data items written in the renderable area into an area corresponding to the display area of a particular apparatus of the plurality of apparatuses to arrange the plurality of rendering data items of the plurality of apparatuses in the area, and
transmit, to the particular apparatus, the plurality of rendering data items of the plurality of apparatuses arranged in the area.

2. The information processing apparatus of claim 1, wherein the circuitry
groups the plurality of rendering data items written in the renderable area to create a plurality of groups corresponding to the plurality of apparatuses, the plurality of groups including a first group and a second group, and
when an open space exists between the first group and the second group, moves the first group or the second group to fill the open space.

3. The information processing apparatus of claim 2, wherein the circuitry
detects one or more characters from rendering data of each group of the plurality of groups corresponding to the plurality of apparatuses,
calculates a ratio between a mean of sizes of the characters detected from the first group and a mean of sizes of the characters detected from the second group, and
when the ratio exceeds a threshold value, adjusts a size of rendering data of the first group and a size of rendering data of the second group to make the ratio equal to the threshold value.

4. The information processing apparatus of claim 2, wherein the plurality of apparatuses include a first apparatus and a second apparatus, the first apparatus being the particular apparatus and transmitting a request to display the plurality of rendering data items in one screen,
wherein the first group includes rendering data rendered on the first apparatus and the second group includes rendering data rendered on the second apparatus, and
wherein the circuitry moves the second group horizontally next to the first group when the display area of the first apparatus is horizontally long, the rendering data of the second apparatus is written below the rendering data of the display area of the first apparatus in the renderable area, and the rendering data of the first apparatus and the rendering data of the second apparatus fail to fit in the display area of the first apparatus.

5. The information processing apparatus of claim 4, wherein when entire rendering data combining the rendering data of the first group and the rendering data of the moved second group fails to fit in the display area of the first apparatus, the circuitry reduces a size of the entire rendering data to make the entire rendering data fit in the display area of the first apparatus.

6. The information processing apparatus of claim 1, wherein a number of the plurality of apparatuses is N, and
wherein the circuitry
groups the plurality of rendering data items of the N apparatuses written in the renderable area to create a plurality of groups corresponding to the N apparatuses,
detects one or more characters from rendering data of each group of the plurality of groups,
calculates a first mean for the each group, the first mean being a mean of sizes of the characters detected from the each group,
calculates a second mean based on the first mean, the second mean being a mean of sizes of the characters between the plurality of groups,
increases or reduces a size of rendering data of the each group with a ratio of the second mean to the first mean,
divides the display area of a particular apparatus of the N apparatuses into N equal areas, the particular apparatus transmitting a request to display the plurality of rendering data items in one screen, and
arranges the rendering data of the each group increased or reduced in size in one area of the N equal areas.

7. The information processing apparatus of claim 6, wherein the circuitry arranges the rendering data of the each group increased or reduced in size in the one area of the N equal areas with an upper-left corner of the each group matching an upper-left corner of the one area, and
wherein when first rendering data extends outside a particular area of the N equal areas into another area of the N equal areas, the particular area being allocated to a particular group of the plurality of groups, the circuitry moves second rendering data of the another area in an extending direction of the first rendering data by a distance of extension of the first rendering data.

8. The information processing apparatus of claim 7, wherein when one group of the plurality of groups is arranged in a right area of the N equal areas and fails to horizontally fit in the display area of the particular apparatus transmitting the request to display the plurality of rendering data items in one screen, and when an open space exists between the one group of the right area and another group of the plurality of groups that is arranged in a left area of the N equal areas and level with the one group of the right area, the circuitry moves the one group of the right area leftward to fill the open space.

9. The information processing apparatus of claim 1, wherein the circuitry is communicable with a virtual meeting service that causes each of the plurality of apparatuses to display rendering data displayed in a virtual space, and
wherein in response to receipt of the rendering data from the virtual meeting service and a request from a particular apparatus of the plurality of apparatuses to display the plurality of rendering data items in one screen, the circuitry transmits to the particular apparatus the plurality of rendering data items of the plurality of apparatuses arranged in the area.

10. An information processing apparatus comprising circuitry configured to
receive a plurality of rendering data items rendered in respective display areas displayed on a plurality of apparatuses, each of the display areas of the plurality of apparatuses being switchable between a plurality of pages,
write the received plurality of rendering data items in the plurality of pages, each page of the plurality of pages corresponding to one of the display areas of the plurality of apparatuses,
arrange the plurality of rendering data items of the plurality of pages in an area corresponding to the display area of a particular apparatus of the plurality of apparatuses, and
transmit, to the particular apparatus, the plurality of rendering data items of the plurality of apparatuses arranged in the area.

11. The information processing apparatus of claim 10, wherein the circuitry
creates a new page in response to a request from one apparatus of the plurality of apparatuses,
groups the plurality of rendering data items to create a plurality of groups corresponding to the plurality of pages,
detects one or more characters from rendering data of each group of the plurality of groups corresponding to the plurality of pages,
calculates a first mean for the each group, the first means being a mean of sizes of the characters detected from the each group,
calculates a second mean based on the first mean, the second mean being a mean of sizes of the characters between the plurality of groups,
increases or reduces a size of rendering data of the each group with a ratio of the second mean to the first mean, and
arranges the rendering data of the each group increased or reduced in size in an allocated integrated area without overlapping the plurality of groups.

12. The information processing apparatus of claim 11, wherein when the particular apparatus transmits a request to display the plurality of rendering data items in one screen and the integrated area is larger than the display area of the particular apparatus, the circuitry reduces the size of the rendering data of the each group arranged in the integrated area to make the rendering data of the each group in the integrated area fit in the display area of the particular apparatus.

13. The information processing apparatus of claim 10, wherein the circuitry is communicable with a virtual meeting service that causes each of the plurality of apparatuses to display rendering data displayed in a virtual space, and
wherein in response to receipt of the rendering data from the virtual meeting service and a request from the particular apparatus to display the plurality of rendering data items in one screen, the circuitry transmits to the particular apparatus the plurality of rendering data items of the plurality of apparatuses arranged in the area.

14. An information display method comprising:
receiving a plurality of rendering data items rendered in respective display areas displayed on a plurality of apparatuses;
writing the received plurality of rendering data items in a renderable area, the renderable area including the display areas of the plurality of apparatuses;
moving at least part of the plurality of rendering data items written in the renderable area into an area corresponding to the display area of a particular apparatus of the plurality of apparatuses to arrange the plurality of rendering data items of the plurality of apparatuses in the area; and
transmitting, to the particular apparatus, the plurality of rendering data items of the plurality of apparatuses arranged in the area.
